(19) United States
(12) Patent Application Publication
(10) Pub. No.: US 2010/0280930 A1
(43) Pub. Date: Nov. 4, 2010

(54) HOLISTIC ACADEMIC SYSTEM FOR INDEPENDENT TEACHERS AND STUDENTS

(75) Inventor: Haitham Barazanji, Largo, FL (US)

Correspondence Address: PERKINS COIE LLP;PATENT-SEA, P.O. BOX 1247, SEATTLE, WA, 98111-1247, US

(73) Assignee: Wild Bright Technologies, Inc., Largo, FL (US)

(21) Appl. No.: 12/770,634

(22) Filed: Apr. 29, 2010

Related U.S. Application Data
(60) Provisional application No. 61/174,414, filed on Apr. 30, 2009.

(51) Int. Cl. G06Q 50/00; G09B 7/00; G06Q 30/00; G06Q 99/00

(52) U.S. Cl. 705/34; 434/322; 705/317; 705/327

(57) ABSTRACT

A holistic academic system that provides a network-based service to which any number of teachers and students may subscribe independent of any school. An independent student refers to a person who desires to take a class that is not necessarily under the control or direction of a school. An independent teacher refers to a person who desires to teach a class that is not necessarily under the control or direction of a school. When a person subscribes to the holistic academic system as an independent teacher, the holistic academic system may verify that the person is qualified before allowing the person to offer and/or teach a class. The holistic academic system may verify the person's qualifications each time the person offers to teach a new class or a class on a subject that is outside of their verified area of expertise. A teacher's qualifications may be manually verified by a representative of the holistic academic system and/or automatically verified by the holistic academic system against one or more public or private data sources.

### CROSS-REFERENCE TO RELATED APPLICATION

This application claims the benefit of U.S. Provisional Application No. 61/174,414 entitled “HOLISTIC ACADEMIC SYSTEM,” filed Apr. 30, 2009.

### BACKGROUND

As the use of personal computers became progressively mainstream, many thought that technology advancements would revolutionize the education sector. However, beyond functioning as a glorified typewriter or as a research tool to those fortunate enough to have internet access, technology advancements have had little impact on the education sector as a whole. This is not to say that companies have failed to invest their resources to develop computer or internet-based educational tools. In fact, many companies have made significant investments in an attempt to solve specific problems faced by educators. For example, some companies developed content management tools that allow teachers to create their own websites. As another example, some companies have developed record management tools that provide school administrators easy access to student records.

However, the development of specialized tools by multiple independent companies has resulted in a lack of interoperability between such tools. Non-interoperability impedes the sharing of data and, consequently, schools that have adopted such proprietary tools spend a great deal of their time and resources on data conversion and data synchronization between such tools. For example, a teacher may opt to post students' grades on a class website that the teacher created using a content management tool. However, to report the same grades to the school administration, the teacher must copy the posted grade information and convert it into a format used by the school's proprietary record management tool. This lack of interoperability has proved many of these tools to be without any long-term merit or real value to schools, their administrators, teachers, parents, or students. As another example, a parent may want to print a copy of their child's upcoming assignments. Assuming that each teacher has a website on which he or she posts information about upcoming assignments (and that such information is kept up to date), the parent must first remember the name or website of each teacher and then separately locate and navigate through each teacher's website. More often than not, the parent spends a great deal of time just trying to find the teacher's website. Even more time is spent then navigating through each website because the design and content of the websites vary from teacher to teacher. Assuming that the parent is actually able to find the information, he or she must then copy or print the information separately from each website. This lack of usability has lead many parents and students to abandon the Internet as a communication channel with the teachers and school administrators. As a result, teachers have less incentive to develop and maintain their websites.

### BRIEF DESCRIPTION OF THE DRAWINGS

One or more embodiments of a virtual academic environment are illustrated by way of example and not limitation in the figures of the accompanying drawings, in which like references indicate similar elements and in which:

FIG. 1 is a data flow diagram of various computer systems that are part of, or interact with, a holistic academic system, in one or more embodiments.

FIG. 2 is a block diagram showing an example architecture of a holistic academic server on which a comprehensive collection of academic services execute, in one or more embodiments.

FIG. 3A is a block diagram showing an example architecture of an operating system of a holistic academic server, in one or more embodiments.

FIG. 3B is a block diagram showing an example architecture of components of the holistic academic server used to provide different perspectives of shared data, in one or more embodiments.

FIG. 4 is a block diagram showing perspectives provided by a organization subscription service, in one or more embodiments.

FIG. 5A is a screenshot of a default display description that includes a number of controls available to an administrator to access various display descriptions, in one or more embodiments.

FIG. 5B is a screenshot of a display description displaying a menu that is presented to an administrator in response to the selection of a Manage Users tab, in one or more embodiments.

FIG. 6A is a screenshot of a display description to manage teacher profiles, in one or more embodiments.

FIG. 6B is a screenshot of a display description to manage a selected teacher profile, in one or more embodiments.

FIG. 6C is a screenshot of a display description presented to an administrator in response to the selection of the Select Departments control, in one or more embodiments.

FIG. 7A is a screenshot of a display description to manage parent profiles, in one or more embodiments.

FIG. 7B is a screenshot of a display description to manage the selected parent profile, in one or more embodiments.

FIG. 8A is a screenshot of a display description to manage student profiles, in one or more embodiments.

FIG. 8B is a screenshot of a display description 800b to manage a selected student profile, in one or more embodiments.

FIG. 9A is a screenshot of a display description to manage administrator profiles, in one or more embodiments.

FIG. 9B is a screenshot of a display description to manage a selected administrator profile, in one or more embodiments.

FIG. 9C is a screenshot of a display description that is presented to an administrator in response to the selection of a Admin Security tab, in one or more embodiments.

FIG. 9D is a screenshot of a display description that is presented to an administrator in response to the selection of an administrator listed in the display description of FIG. 9C, in one or more embodiments.

FIG. 10 is a screenshot of a display description that is presented to an administrator in response to the selection of a Semester Setup control, in one or more embodiments.

FIG. 11 is a screenshot of a display description that is presented to an administrator in response to the selection of a Classrooms control 550, in one or more embodiments.

FIG. 12 is a screenshot of a display description and that is presented to an administrator in response to the selection of a Grade Level Setup control, in one or more embodiments.

FIG. 13A is a screenshot of a display description that is presented to administrator in response to the selection of a Grade Level Selection Editor control, in one or more embodiments.

FIG. 13B is a screenshot of a display description that is presented to an administrator in response to the selection of a grade level, in one or more embodiments.

FIG. 14 is a screenshot of a display description that is presented to an administrator in response to the selection of a Departments Setup control, in one or more embodiments.

FIG. 15A is a screenshot of a display description that is presented to an administrator in response to the selection of a Subject Manager control, in one or more embodiments.

FIG. 15B is a screenshot of a display description that is presented to an administrator in response to the selection of a Add Subject control, in one or more embodiments.

FIG. 16 is a screenshot of a display description and that is presented to an administrator in response to the selection of a Grade Level Subject Manager control, in one or more embodiments.

FIG. 17A is a screenshot of a display description that is presented to an administrator in response to the selection of a Scheduling control, in one or more embodiments.

FIG. 17B is a screenshot of a display description that is presented to an administrator in response to the selection of a session from a displayed list, in one or more embodiments.

FIG. 17C is a screenshot of a display description that is presented to an administrator in response to the selection of a grade level section from a displayed list, in one or more embodiments.

FIG. 17D is a screenshot of a display description that is presented to an administrator in response to the selection of a teacher, in one or more embodiments.

FIG. 17E is a screenshot of the a display description displaying an example scheduling error message, in one or more embodiments.

FIG. 18A is a screenshot of a display description that is presented to an administrator in response to the selection of a Grading Manager tab, in one or more embodiments.

FIG. 18B is a screenshot of a display description that is presented to an administrator in response to the selection of a session from a displayed list, in one or more embodiments.

FIG. 18C is a screenshot of a display description that is presented to an administrator in response to the selection of a grade level section from a displayed list, in one or more embodiments.

FIG. 18D is a screenshot of a display description that is presented to an administrator in response to the selection of a subject from a displayed list, in one or more embodiments.

FIG. 18E is a screenshot of a display description that is presented to an administrator in response to the selection of a Commit Grades control, in one or more embodiments.

FIG. 18F is a screenshot of a display description displaying an example grading error message, in one or more embodiments.

FIG. 18G is a screenshot of a display description presented in response to the selection of a “Print Reports” control, in one or more embodiments.

FIG. 19A is a screenshot of a display description that is presented to an administrator in response to the selection of a User Alerts tab, in one or more embodiments.

FIG. 19B is a screenshot of a display description that is presented to an administrator operating a client computer in response to the selection of a Create Alert control corresponding to a selected user group, in one or more embodiments.

FIG. 19C is a screenshot of a display description that is presented to an administrator operating a client computer in response to a selection of a Alert Reports control, in one or more embodiments.

FIG. 20A is a screenshot of a default display description that includes a number of controls available to a teacher to access course management display descriptions, in one or more embodiments.

FIG. 20B is a screenshot of a display description that is presented to a teacher in response to the selection of a Course Material control, in one or more embodiments.

FIG. 20C is a screenshot of a display description that is presented to a teacher in response to the selection of a Announcement Manager control, in one or more embodiments.

FIG. 21A is a screenshot of a display description that is presented to a teacher in response to the selection of an Assignment Manager control, in one or more embodiments.

FIG. 21B is a screenshot of a display description that is presented to a teacher in response to the selection of an Assignment Types control, in one or more embodiments.

FIG. 21C is a screenshot of a display description that is presented to a teacher in response to the selection of a Build/Modify Assignments control, in one or more embodiments.

FIG. 21D is a screenshot of a display description that is presented to a teacher in response to the selection of an Edit control, in one or more embodiments.

FIG. 21E is a display description that is presented to a teacher in response to the selection of an Edit control, in one or more embodiments.

FIG. 22A is a screenshot of a display description that is presented to a teacher in response to these selection of a View/Grade Assignments control, in one or more embodiments.

FIG. 22B is a screenshot of a display description displaying an error message that is presented, in one or more embodiments.

FIG. 22C is a screenshot of a display description that is presented to a teacher in response to the selection of a Grading Sheet control, in one or more embodiments.

FIG. 22D is a screenshot of a display description that is presented to a teacher in response to the selection of a Grading Sheet control, in one or more embodiments.

FIG. 22E is a screenshot of a display description that indicates a student has completed an assignment, in one or more embodiments.

FIG. 22F is a screenshot of a display description that is presented to a teacher in response to a request to view and/or grade a assignment completed by a student, in one or more embodiments.

FIG. 22G is a screenshot of a display description displaying an error message indicating that the teacher entered a value that exceeded the possible points, in one or more embodiments.

FIG. 22H is a screenshot of a display description that is presented to a teacher in response to a valid request to adjust a student's score for a completed assignment, in one or more embodiments.

FIG. 23A is a screenshot of a display description that includes the common interface perspective, in one or more embodiments.

FIG. 23B is a screenshot of a display description that is presented to a teacher in response to the selection on of a Syllabus control, in one or more embodiments.

FIG. 23C is a screenshot of a display description that is presented to a teacher in response to the selection of an Assignments control, in one or more embodiments.

FIG. 23D is a screenshot of a display description that is presented to a teacher in response to the selection of an Attendance control, in one or more embodiments.

FIG. 23E is a screenshot of a display description that is presented to a teacher in response to the selection of a Grades control, in one or more embodiments.

FIG. 24A is a screenshot of a display description that includes a number of controls available to a parent to manage shared data, in one or more embodiments.

FIG. 24B is a screenshot of a display description presented in response to the selection of a controlled corresponding to a child of that parent, in one or more embodiments.

FIG. 24C is a screenshot of a display description that is presented in response to the selection of an Attendance Report control, in one or more embodiments.

FIG. 24D is a screenshot of a display description that is presented in response to the selection of a Class Schedule control, in one or more embodiments.

FIG. 25 is a screenshot of a display description that may be presented to a younger student, in one or more embodiments.

FIG. 26A is a screenshot of a display description that includes a number of controls available to a student to manage shared data, in one or more embodiments.

FIG. 26B is a screenshot of a display description that is presented in response to the selection of a Profile control, in one or more embodiments.

FIG. 26C is a screenshot of a display description that is presented to a student in response to selection on of an Instructor Claims control, in one or more embodiments.

FIG. 26D is a screenshot of a display description that is presented in response to the selection of a My Courses control, in one or more embodiments.

FIG. 27A is a screenshot of a display description that is presented to a student in response to the selection of an Assignments control, in one or more embodiments.

FIG. 27B is a screenshot of a display description that is presented to a student in response to a selection of an assignment from a display description, in one or more embodiments.

FIG. 27C is a screenshot of a display description that is presented in response to the selection of a control, in one or more embodiments.

FIG. 27D is a screenshot of a display description that is presented in response to completion of a selected assignment, in one or more embodiments.

FIG. 27E is a screenshot of a display description displaying the student's score for the completed assignment, in one or more embodiments.

FIG. 28 is a block diagram showing perspectives provided by an independent subscription service, in one or more embodiments.

FIG. 29A is a screenshot of a display description that includes an controls that enable users to subscribe to the independent subscription service as independent teachers and/or independent student, in one or more embodiments.

FIG. 29B is a screenshot of a display description is presented to a subscribing user in response to the selection of a control, in one or more embodiments.

FIG. 29C is a screenshot of a display description that is presented in response to a request from an independent teacher to create a new course, in one or more embodiments.

FIG. 29D is a screenshot of a display description that provides a number of controls to enable independent students to register classes provided by independent teachers through the independent subscription service, in one or more embodiments.

### DETAILED DESCRIPTION

The limited benefits, if any, of conventional specialized tools not only impacts the productivity of school administrators and teachers, but it also affects students and their parents' ability to monitor their performance and participate in their education. Accordingly, a holistic academic system has been developed. The holistic academic system provides a comprehensive, network-based collection of academic services. The holistic academic system improves communication and interactions between users, such as administrators, teachers, parents, and/or students, by providing different perspectives—an administrator perspective, a teacher perspective, a parent perspective, and a student perspective—of a single representation of shared data without requiring users to learn how to use multiple tools or requiring that the data be converted or synchronized between multiple tools. That is, the holistic academic system mobilizes information electronically across administrators, teachers, parents, and/or students, seamlessly producing a concise collection of shared information. Additionally, by providing different perspectives of the same information (e.g., a schedule, a grade sheet, etc.), the holistic academic system reduces user input errors and eliminates data conversion and synchronization errors. Additional advantages of be holistic academic system will become apparent as further features of the system are described herein.

In some embodiments, the holistic academic system is implemented for use by a single school. While in other embodiments, the holistic academic system provides a network-based service to which any number of schools may subscribe (referred to as “member schools”). As used herein, the term “school” refers to any public or private educational institution, including nursery schools, preschools, Montessori schools, elementary schools, middle schools, high schools, vocational schools, junior colleges, community colleges, colleges, universities, graduate schools, and so on.

In some embodiments, the holistic academic system provides a network-based service to which any number of teachers and students may subscribe independently from a school. As used herein, the term “independent teacher” refers to a person who desires to teach a class that is not necessarily under the control or direction of a school. For example, a person may subscribe to the holistic academic system as an independent teacher and offer a scuba diving certification class. In some embodiments, when a person subscribes to the holistic academic system as an independent teacher, the holistic academic system verifies that the person is qualified before allowing the person to offer and/or teach a class. The holistic academic system may verify the person's qualifications each time the person offers to teach a new class or a class on a subject that is outside of their verified area of expertise. For example, if an independent teacher offers to teach an astronomy class and the holistic academic system has verified that the independent teacher is qualified to teach scuba diving certification classes and marine biology classes, then the holistic academic system may also verify that the independent teacher is qualified to teach astronomy before allowing independent teacher to offer and/or teach an astronomy class. A teacher's qualifications may be manually and/or automatically verified by the holistic academic system. For example, a teacher may be presented with an online form that, when completed, is used to perform a background check. The background check may include verifying that the teacher received a particular degree and/or attended a particular school indicated by the teacher on the online form. The background check may include a credit history report, criminal record, calling references provided by the teacher, and so on. As used herein, the term “independent student” refers to a person who desires to take a class that is not necessarily under the control or direction of a school, such as a Spanish class, an astronomy class, a yoga class, a Microsoft certification class (e.g., classes for Microsoft Certified Technology Specialist (MCTS), Microsoft Certified Professional Developer (MCPD), Microsoft Certified IT Professional (MCITP), the Microsoft Certified Architect (MCA), Microsoft Certified Systems Administrator (MCSA) and Microsoft Certified Systems Engineer (MCSE), etc), and so on.

When a school subscribes to the holistic academic system, a user profile is created for each administrator, teacher, parent, and student (collectively referred to as users) associated with the subscribing member school. When a person subscribes to the holistic academic system as an independent teacher or an independent student, a user profile is also created for that person; however, the user profile is typically not associated with a school. User profiles are used by the holistic academic system to authenticate users and/or to determine the perspective to be presented to an authenticated user. Details regarding authentication are well known and well documented, and thus need not be described in detail in order to gain an understanding of the concepts and operation of the holistic academic system.

In some embodiments, the holistic academic system provides an administrator perspective, a teacher perspective, a student perspective, and/or a parent perspective of a single representation of shared data. As used herein, the term “shared data” refers to one or more portions of information associated with a member school or one or more independently organized classes. As used herein, the term “perspective” refers to a user's view of shared data, including the level or type of information viewable by the user, the layout of the information, and/or the interfaces available to the user. The granularity of the user's perspective of shared data is typically dependent on the user's role within the member school. In some embodiments, the granularity of a users perspective is modifiable. For example, in the context of a school schedule, an administrator may modify his or her perspective to narrow or expand the level of information presented. Typically, the administrator perspective of a school schedule includes the time and location of each subject assigned to each grade level section and identifies the teacher assigned to teach the subject. However, an administrator may change his or her perspective of the school schedule to view, for example, only the subjects and/or teachers assigned to a particular grade level or grade level section. As another example, an administrator may change his or her perspective of the school schedule to view the schedule of a particular teacher or student.

The administrator perspective includes a number of user interfaces to manage shared data of a member school. For example, the administrator perspective may include a user interface to create, update, and/or archive user profiles associated with the school. As another example, the administrator perspective may include a user interface to manage a profile of the member school. The profile of a member school may include information describing the grade levels (e.g., K-12) of the member school, the maximum number of sections per grade level, the resources of the member school (e.g., the number of classrooms, the size of each classroom, movable or immovable equipment within a classroom, such as computers, ceramic kilns, pianos, chemistry benches, etc.), the departments within the member school (e.g., Art, etc.), the subjects within each department (e.g., Ceramics, Photography, Painting, etc.), the beginning and ending dates for past, present, and/or future school years and/or school sessions (e.g., semesters, trimesters, quarters, etc.), the grade submission date for past, present, and/or future sessions, holidays, and so on. As yet another example, the administrator perspective may include a user interface to assign students within a grade level to grade level sections, to assign subjects to grade levels and/or grade level sections, and/or to generate a school schedule by selecting a time, a classroom, and a teacher for each subject assigned to a grade level section. By freeing administrators from the burden of assigning students and/or subjects to grade levels and scheduling academic resources, the holistic academic system simplifies the process of managing a school. As another example, the administrator perspective may include a user interface to view, adjust, and/or finalize students' grades provided by a teacher to the holistic academic system. That is, the holistic academic system simplifies the process of managing a school by safeguarding the grading process, thereby substantially reducing user input errors and eliminating data conversion and synchronization errors. In some embodiments, the administrator perspective includes a user interface to create and/or send general or private messages to other users of the member school. Moreover, those skilled in the art will appreciate that the administrator perspective may include other user interfaces not mentioned herein.

In some embodiments, each administrator of a member school has access to, and an administrator view of, all of the shared data maintained by the holistic academic system for the member school. While in other embodiments, the holistic academic system includes a user interface to assign and/or modify administrative privileges of an administrator. For example, in some embodiments, all administrators have an administrative view of a school schedule, but only one administrator has administrative privileges to modify the school schedule.

The teacher perspective includes a number of user interfaces to manage shared data associated with a teacher's classes, a teacher's profile, and so on. In some embodiments, the user interfaces vary based on whether the teacher is associated with a member school. For example, when a teacher is associated with a member school, the teacher perspective includes a user interface that allows the teacher to view the schedule of the member school from that teacher's viewpoint. That is, the user interface identifies the time and location of each class that the teacher has been assigned to teach. As another example, when a teacher it is not associated with a member school, the teacher perspective includes a user interface to add classes offered by that teacher. Typically, regardless of whether a teacher is associated with a member school, the teacher perspective includes a user interface to post or build assignments and/or a user interface to grade assignments. By providing a teacher perspective, the holistic academic system enables teachers to efficiently and easily share class data and interact with administrators, students, and/or their parents. Moreover, those skilled in the art will appreciate that the teacher perspective may include other user interfaces not mentioned here.

The student perspective includes the number of user interfaces to manage shared data associated with a student's classes, a student's profile, and so on. In some embodiments, the user interfaces vary based on whether the student is associated with a member school. For example, when a student is associated with a member school, the student perspective includes a user interface that allows the student to view the schedule of the member school from that student's perspective. That is, the user interface identifies the time and location of each class that the student has been assigned to take. Typically, regardless of whether a student is associated with a member school, the student perspective includes a user interface to review and/or complete assignments. By providing a student perspective, the holistic academic system enables students to easily interact with their teachers and administrators, and to efficiently access shared data associated with their classes. Moreover, those skilled in the art will appreciate that the student perspective may include other user interfaces not mentioned here.

The parent perspective includes a number of user interfaces to manage shared data associated with a parent's profile, a child's classes, and so on. For example, the parent perspective may include a user interface that includes, for each child that is a student of the member school, the time and location of each class that the student has been assigned to take. As another example, the parent perspective may include a user interface to communicate and interact with teachers and/or administrators of the member school. In some embodiments, the parent perspective includes a user interface to access class information and/or to monitor the child's attendance, assignments, grades, and so on. By providing a parent perspective, the holistic academic system enables parents to monitor their children's performance and to participate in their education. Moreover, those skilled in the art will appreciate that the parent perspective may include other user interfaces not mentioned here.

In some embodiments, the holistic academic system charges each member school, independent teacher, and/or independent student a subscription fee. For example, the holistic academic system may charge a one-time subscription fee. As another example, the holistic academic system may charge subscribers on a monthly basis, a yearly basis, a usage basis, and/or other fee structures. In some embodiments, the holistic academic system charges each member school based on the number of users associated with a member school. In some embodiments, various charges may be imposed by the holistic academic system as academic services are provided to users of a member school. For example, the holistic academic system may charge a member school to automatically generate a schedule or to produce grade reports. In some embodiments, the holistic academic system charges each independent teacher a subscription fee based on the number of classes offered by the independent teacher and/or the number of independent students registered to take their classes. While in other embodiments, the holistic academic system offers subscriptions free of charge to independent teachers and charges independent students that register to take a class. For example, the subscription fee may be based on the number of classes registered for by an independent student. In some embodiments, the holistic academic system enables independent teachers to charge independent students tuition to register for their classes. The holistic academic system may retain a percentage of the tuition charged and/or withdraw the independent teacher's subscription fee from the tuition charged. In some embodiments, the holistic academic system pays independent teachers. For example, the holistic academic system may pay an independent teacher based on the number of classes taught by the independent teacher and/or the number of students registered for a class taught by the independent teacher. In some embodiments, independent students may request to have a particular class offered. When a threshold number of requests for a particular class have been received, the holistic academic system may advertise for an independent teacher to teach the requested class.

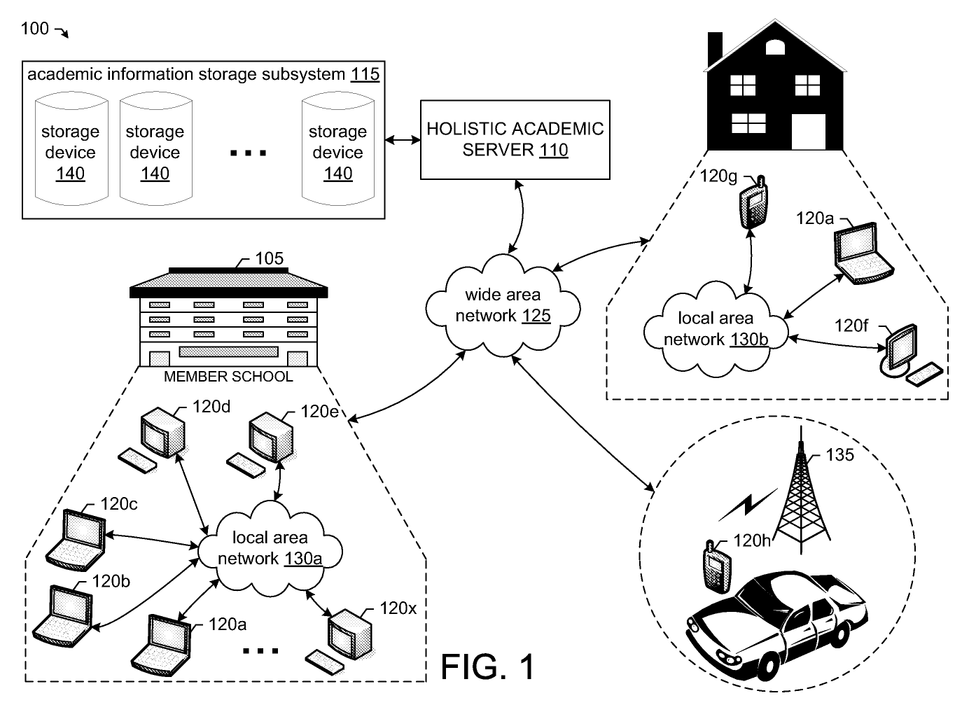

Before describing the holistic academic system in greater detail, it is useful to consider an environment in which the system can be implemented. FIG. 1 is a data flow diagram of various computer systems that are part of, or interact with, a holistic academic system 100. In the illustrated embodiment, the holistic academic system 100 is a network of computer systems across which a comprehensive collection of academic services are offered through one or more perspectives to administrators, teachers, parents, and/or students of a member school 105. In some embodiments, for example, the academic services include a grade service that is accessible by administrators, teachers, parents, and students of a member school. When accessing the grade service the perspective of the user defines the level and/or type of information, the layout, and/or the interfaces available to the user. For example, a student may view his or her grades, whereas a teacher may view and/or edit grades for each student assigned to the teacher's class. In some embodiments, the academic services offered to a user typically vary based on the perspective of the user. For example, certain services and/or perspectives may be available to some users (e.g., parents) and not available to others (e.g., students).

In the illustrated embodiment, a holistic academic server 110 is connected to an academic information storage subsystem 115 and to a number of clients computers 120 through a network, such as a wide area network (WAN) 125 (e.g., a private or public network like the Internet), a local area network (LAN) 130a, 130b, and/or a cellular network 135 (e.g., a GSM network, a GPRS network, a CDMA network, EDGE network, etc.). The academic information storage subsystem 115 stores shared information associated with the member school 105. To facilitate description of the illustrated embodiment, a single member school 105 is shown. However, those skilled in the art will appreciate that the holistic academic server 110 may provide academic services to one or more member schools and/or to any number of independent teachers and independent students. As such, the description of a single member school should not be taken as restrictive.

Client computers 120 may include, for example, personal computers (PCs), workstations, handheld computers, cellular phones, and so on. Typically, each client computer 120 includes a browser and/or another client software application that enables a user to access one or more of the academic services provided by the holistic academic server 110. In operation, a client computer 120 operated by a user requests access to an academic service through an interface displayed at the client computer 120 by exchanging packets of information with the holistic academic server 110 over a network. In some embodiments, client computers 120 issue requests using the Hypertext Transfer Protocol (HTTP), secure HTTP (HTTPS), Secure Sockets Layer (SSL) protocol, a file-based access protocol (e.g., Common Internet File System (CIFS) protocol, Network File System (NFS) protocol, etc.), a block-based access protocol (e.g., Small Computer Systems Interface (SCSI) protocol, etc.), and/or the like, over TCP/IP and/or the like. Details regarding client computers are known and well documented, and thus need not be described in detail in order to gain an understanding of the concepts and operation of the holistic academic system.

The academic information storage subsystem 115 is managed by the holistic academic server 110. The holistic academic server 110 receives and responds to various requests from client computers 120, some of which are directed to data stored, or to be stored, in the academic information storage subsystem 115. The academic information storage subsystem 115 includes multiple storage devices 140. The storage devices 140 may be, for example, magnetic disks, optical disks such as CD-ROM or DVD based storage, magneto-optical (MO) storage, or any other type of non-volatile storage devices suitable for storing large quantities of data. Such data stored in the academic information storage subsystem 115 may be implemented as one or more storage volumes that comprise a collection of physical storage devices (e.g., disks) cooperating to define an overall logical arrangement of space on the volumes. Each logical volume is generally, although not necessarily, associated with a single member school. The storage devices 140 within academic information storage subsystem 115 may be organized as one or more groups, and each group can be organized as a Redundant Array of Inexpensive Disks (RAID), in which case the holistic academic server 110 accesses the academic information storage subsystem 115 using one or more well-known RAID protocols. However, other implementations and/or protocols may be used to organize the storage devices 130 of the academic information storage subsystem 115.

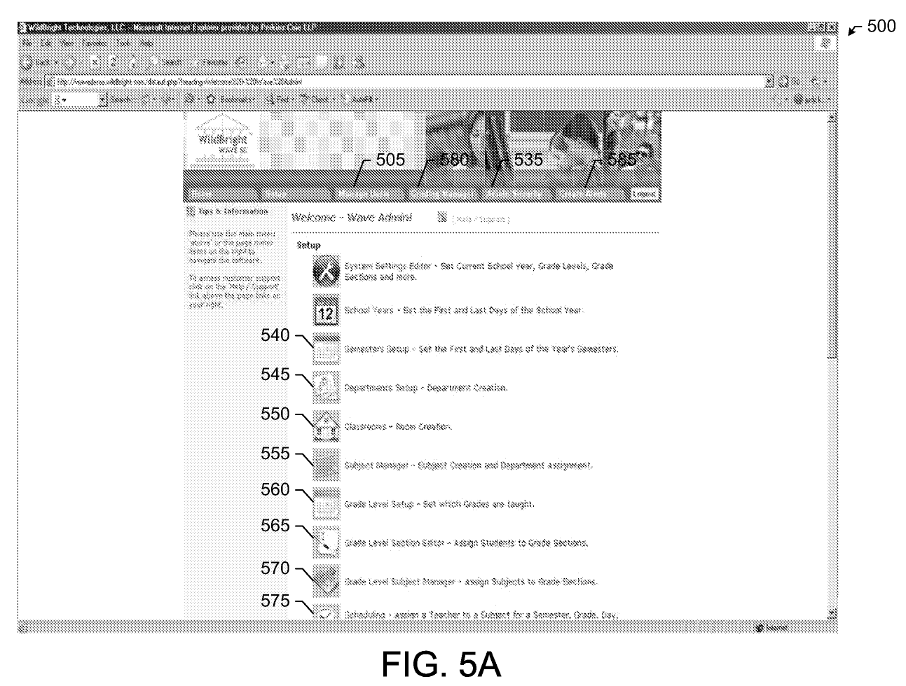

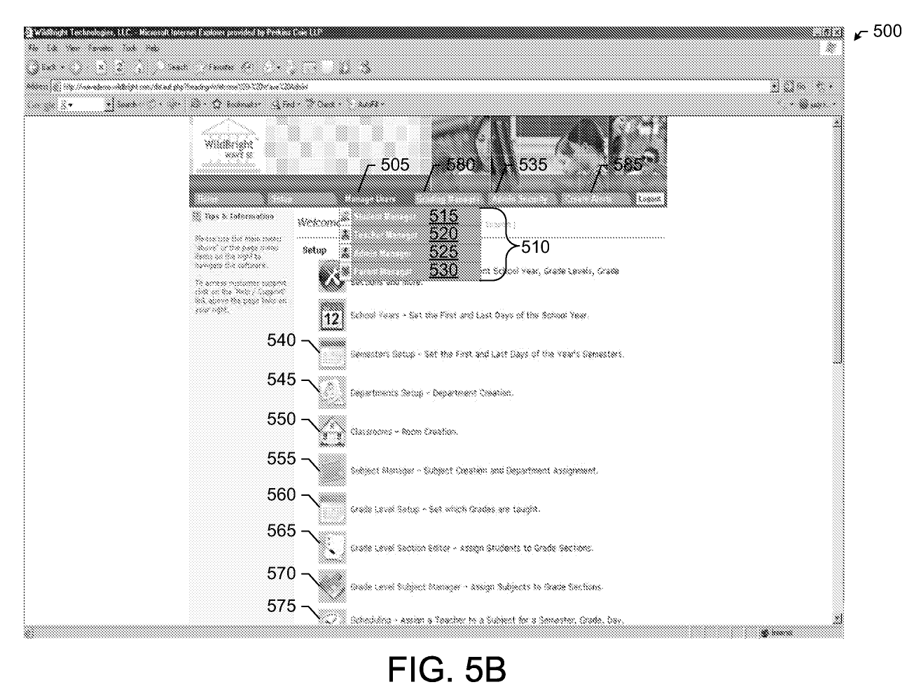

The academic information storage subsystem 115 stores one or more portions of shared data associated with the member school 105. In some embodiments, the academic information storage subsystem 115 stores one or more display descriptions each viewable from one or more perspectives. As used herein, the term “display description” refers to the content and/or program instructions that result in a display of information on a computer, such as a client computer 120. In some embodiments, a display description is implemented as a webpage that is composed from one or more files of potentially different data types (e.g., text, images, movies, etc.). For example, FIGS. 5A-27E and 29A-29D are screenshots of a browser application (e.g., Internet Explorer, Firefox, etc.) displaying various display descriptions from various user perspectives. Typically, a display description provides a user interface that includes one or more controls (e.g., links, buttons, forms, etc.) that when “clicked on” or otherwise selected or activated by a user generate a request to access another display description, file, academic service, etc. available to the user. Typically, the profile of the user determines the perspective of the user and the display descriptions available to the user, and the determined perspective controls how the display descriptions are viewed by the user (e.g., the level and/or a type of information presented, the layout, the interfaces available to the user, etc.).

In some embodiments, display descriptions vary based on the perspective of the user operating the client computer 120. That is, the layout and/or information presented via a display description are selectively displayed based on the identity of the user. For example, in the context of a schedule display description, the academic information storage subsystem 115 may store a single display description that may be viewed from multiple perspectives, such as an administrator perspective, a teacher perspective, a parent perspective, and/or a student perspective.

When the schedule display description is viewed from the administrator perspective it typically includes the time and location of each subject assigned to each grade level section and identifies the teacher assigned to teach the subject. However, when the schedule display description is viewed from the student perspective, it includes the time, location, and teacher of each class that the student has been assigned to take. That is, together with the academic information storage subsystem 115, the holistic academic server 110 maintains one or more portions of information associated with the member school 105 that may each be viewed from different perspectives via a single corresponding display description. It is noted, however, that certain display descriptions may be viewed from one perspective (e.g., an administrator perspective) and not from another perspective (e.g., a student perspective).

It is noted that the number of holistic academic servers 110, academic information storage subsystems 115, networks, and/or client computers 120 in a holistic academic system 100 is not limited to the number of computers or ratio of computers illustrated in FIG. 1. The holistic academic system is designed to scale to include thousands or millions of computers. Moreover, while various embodiments are described in terms of the environment described above, those skilled in the art will appreciate that the holistic academic system may be implemented in a variety of other environments including a single, monolithic computer system, as well as various other combinations of computer systems or similar devices connected in various ways. For example, in some embodiments, the holistic academic server 110 has a distributed architecture, even though it is not illustrated as such in FIG. 1. Those skilled in the art will further appreciate that the holistic academic system may include other types of computers and/or devices not specifically illustrated. For example, the holistic academic system 100 may include proxy server (not shown) that acts as (or facilitates the use of) a firewall to prevent unauthorized access to client computers 120 within a member school's local area network (LAN) by computers outside the LAN.

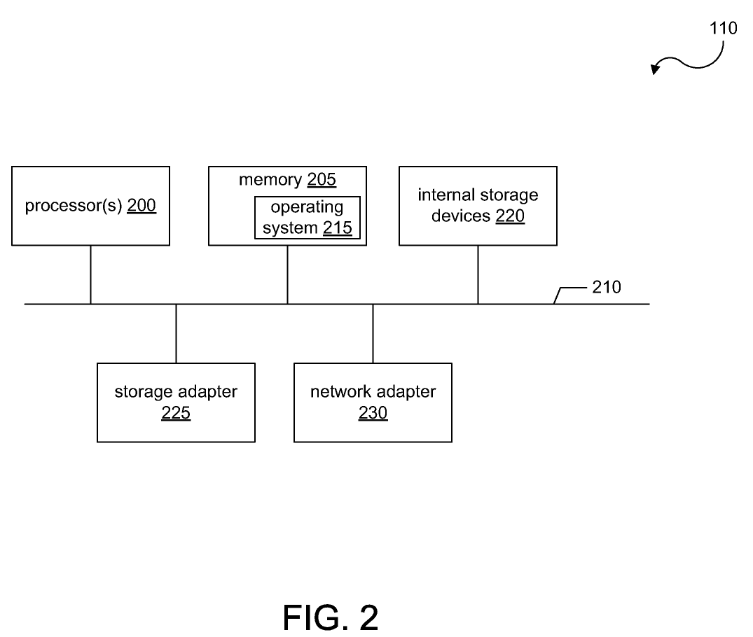

FIG. 2 is a block diagram showing an example architecture of a holistic academic server 110 on which a comprehensive collection of academic services execute, in one or more embodiments. It is noted that certain well-known structures and functions have not been shown or described in detail to avoid obscuring the description. The holistic academic server 110 includes one or more processors 200 and memory 205 coupled to an interconnect system 210. The interconnect system 210 shown in FIG. 2 is an abstraction that represents any one or more separate physical buses and/or point-to-point connections, connected by appropriate bridges, adapters and/or controllers. The interconnect system 210 may include, for example, a system bus, a form of Peripheral Component Interconnect (PCI) bus, a HyperTransport or industry standard architecture (ISA) bus, a small computer system interface (SCSI) bus, a universal serial bus (USB), or an Institute of Electrical and Electronics Engineers (IEEE) standard 1394 bus (sometimes referred to as “Firewire”).

The processors 200 are the central processing units (“CPUs”) of the holistic academic server 110 and, thus, control its overall operation. In some embodiments, the processors 200 accomplish this by executing software stored in memory 205. In some embodiments, the holistic academic server 110 includes a processor 200 having two or more independent cores in a package composed of a single integrated circuit (referred to as a “die”), one or more dies packaged together, multiple packages, and so on. In some embodiments, the holistic academic server 110 includes a hyper-threaded processor 200 that, despite having only a single core, is capable of performing as a multi-core processor. A processor 200 may be, or may include, one or more programmable general-purpose or special-purpose microprocessors, digital signal processors (“DSPs”) programmable controllers, application specific integrated circuits (“ASICs”), programmable logic devices (“PLDs”), or the like, or a combination of such devices.

Memory 205 includes the main memory of the holistic academic server 110. Memory 205 includes any form of volatile, nonvolatile, removable, and non-removable computer-readable storage media, or any combination of such media devices that are capable of storing information such as computer-readable instructions, data structures, program modules, or other data of the holistic academic server 110. Memory 205 stores (among other things) an operating system 215. In some embodiments, the operating system 215 is a Microsoft Windows® operating system, while in other embodiments the operation system 215 is a Linux or Unix operating system. It is noted, however, that the technology introduced herein does not depend on the operating system implemented by the holistic academic server 110.

Also connected to the processors 200 through the interconnect system 210 are one or more internal storage devices 220, a storage adapter 225 and a network adapter 230. The internal storage devices 220 may be or include any computer-readable storage medium for storing data, such as one or more disks. As used herein, the term “disk” refers to any computer-readable storage medium including volatile (e.g., RAM), nonvolatile (e.g., ROM, Flash, etc.), removable, and non-removable media, or any combination of such media devices that are capable of storing information such as computer-readable instructions, data structures, program modules, or other data. It is further noted that the term “disk” may refer to physical or virtualized computer-readable storage media. The storage adapter 225 allows the holistic academic server 110 to access the academic information storage subsystem 115 and may be, for example, a Fibre Channel adapter, a SCSI adapter, or the like. The network adapter 230 provides the holistic academic server 110 with the ability to communicate with remote devices, such as the client computers 120, over a network and may be, for example, an Ethernet adapter, a Fibre Channel adapter, or the like.

While computer systems configured as described above are typically used to support the operation of the holistic academic system 100, those skilled in the art will appreciate that a holistic academic server may be implemented using devices of various types and configurations, and having various components. For example, even though it is not illustrated as such in FIG. 2, the holistic academic server 110 may include one or more input/output (I/O) devices (e.g., keyboard, microphone, display, printer, etc.) that allow a user to access programs and/or data stored in memory 205 or a storage device 220 of the holistic academic server 110.

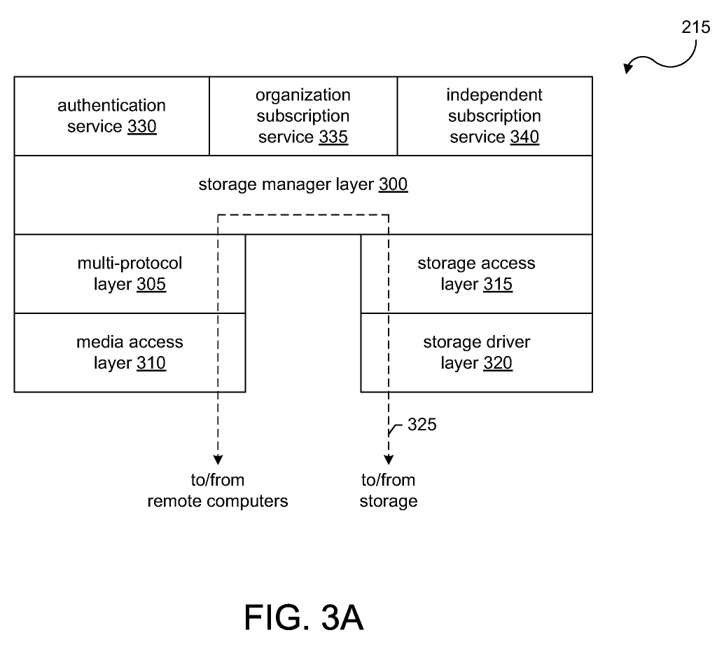

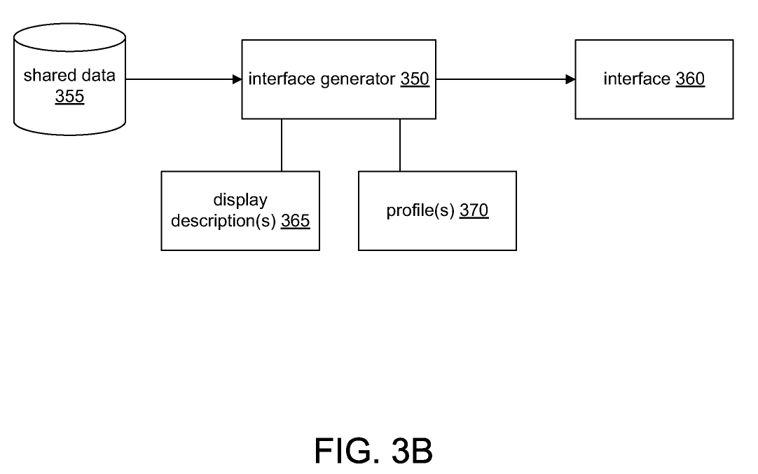

FIG. 3A is a block diagram showing an example architecture of an operating system 215 of a holistic academic server 110, in one or more embodiments. As shown, the operating system 215 includes several components or “layers.” These layers include a storage manager layer 300. The storage manager layer 300 is application-layer software that services requests from client computers 120 and imposes a hierarchical structure on the data stored in the academic information storage subsystem 115 and storage devices 220. Details regarding file system algorithms are known and well documented, and thus need not be described in detail in order to gain an understanding of the concepts and operation of the technology introduced herein.

Logically “under” the storage manager layer 300, the operating system 215 also includes a multi-protocol layer 305 and an associated media access layer 310, to allow the holistic academic server 110 to communicate over a network (e.g., with client computers 120). The multi-protocol layer 305 implements various higher-level network protocols, such as Network File System (NFS), Common Internet File System (CIFS), Direct Access File System (DAFS), Hypertext Transfer Protocol (HTTP) and/or Transmission Control Protocol/Internet Protocol (TCP/IP). The media access layer 310 includes one or more drivers which implement one or more lower-level protocols to communicate over a network, such as Ethernet, Fibre Channel, Internet small computer system interface (iSCSI), or the like.

Also logically “under” the storage manager layer 300, the operating system 215 includes a storage access layer 315 and an associated storage driver layer 320, to allow the holistic academic server 110 to communicate with the academic information storage subsystem 115. The storage access layer 315 implements a higher-level disk storage protocol, such as RAID, while the storage driver layer 320 implements a lower-level storage device access protocol, such as Fibre Channel Protocol (FCP) or small computer system interface (SCSI). Also shown in FIG. 3A is a path 325 of data flow, through the operating system 215, associated with a request.

In some embodiments, the operating system 215 includes various services logically “above” the storage manager layer 300. For example, operating system 215 may include an authentication service 330, an organization subscription service 335, and/or an independent subscription service 340. The authentication service 330 enables a user operating a client computer to establish the user's identity. Details regarding authentication are well known and well documented, and thus need not be described in detail in order to gain an understanding of the concepts and operation of the holistic academic system. The organization subscription service 335 enables one or more schools to subscribe to the holistic academic system. For example, in some embodiments, the organization subscription service 335 enables a subscribing member school to select and/or define one or more perspectives of the member school. Such perspectives may include, for example, an administrator perspective, a teacher perspective, a student perspective, and/or a parent perspective. Those skilled in the art will appreciate that the organization subscription service 335 may include other perspectives not mentioned herein. The independent subscription service 340 enables a user operating a client computer to subscribe to the holistic academic system as an independent teacher and/or as an independent student. In some embodiments, the independent subscription service 340 defines one or more perspectives to which a person may subscribe, such as a teacher perspective, a student perspective, and so on. Those skilled in the art will appreciate that the operating system 215 may include other services not mentioned herein. It is noted, however, that some or all of the services 330-340 may be implemented by a computer system other than the holistic academic server 110. For example, in some embodiments, the authentication service 330 is implemented by a separate computer system. As another example, in some embodiments, the organization subscription service 335 and/or the authentication service 330 are implemented in a computer system owned and operated by a school.

FIG. 3B is a block diagram showing an example architecture of components of the holistic academic server used to provide different perspectives of shared data, in one or more embodiments. In the illustrated embodiment, the holistic academic server includes an interface generator 350. The interface generator 350 responds to requests from users for access to shared data 355 by generating an interface 360 having the perspective of the user from which the request was received. The interface generator 350 determines the perspective of the user based on the profile 370 associated with the user from which the request was received. The interface generator 350 selects a page layout or template (e.g., a display description 365) that is populated with the shared data 355 based on the determined perspective of the user.

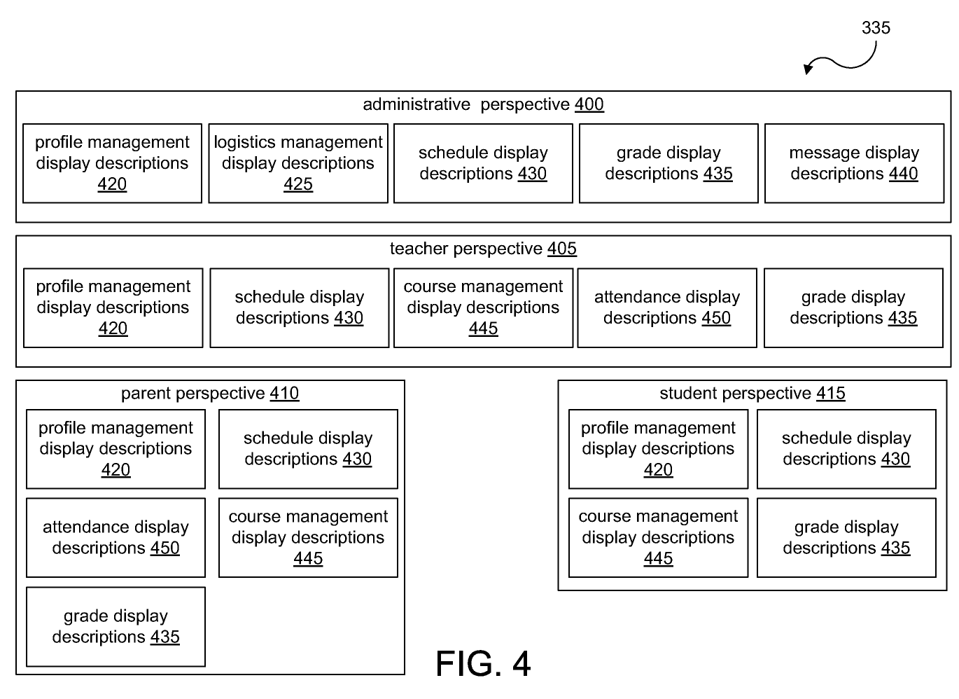

FIG. 4 is a block diagram showing perspectives provided by a organization subscription service 335, in one or more embodiments. In the embodiment illustrated in FIG. 4, the organization subscription service 335 includes an administrative perspective 400, a teacher perspective 405, a parent perspective 410, and a student perspective 415. Typically, the profile of a user determines the perspective of the user and the display descriptions available to the user, and the determined perspective controls how the display descriptions are reviewed by the user (e.g., the level and/or a type of information, the layout, the interfaces available to the user, etc.).

In the embodiment illustrated in FIG. 4, the administrative perspective 400 includes a number of display descriptions to enable an administrator to manage a member school. For example, the administrative perspective 400 includes profile management display descriptions 420, logistics management display descriptions 425, schedule display descriptions 430, grade display descriptions 435, and message display descriptions 440. Typically, if a user operating a client computer 120 is authenticated as an administrator, the holistic academic server 110 sends a default administrative display description or a user-specified display description to the client computer 120 for display to the user. The default display description may include a number of interfaces to access display descriptions 420-440 from the perspective of an administrator. For example, FIG. 5A is a screenshot of a default display description 500 that includes a number of controls (e.g., links, buttons, tabs, etc.) available to an administrator to access various display descriptions available to the administrator of a member school, such as display descriptions 420-440.

In the embodiment illustrated in FIG. 5A, an administrator operating a client computer 120 manages user profiles of a member school by selecting, for example, the “Manage Users” tab 505 to access one or more corresponding profile management display descriptions 420. FIG. 5B is a screenshot of the display description 500 displaying a menu 510 that is presented to an administrator in response to the selection of the Manage Users tab 505, in one or more embodiments. Typically, when a member school first implements or subscribes to the holistic academic system, an administrator establishes a profile for each user associated with the member school. Users' profile information may be manually entered by an administrator operating a client computer 120 or automatically populated by the holistic academic server 110 with information from a database, a tagged document, a table, a text document, a Comma-Separated-Value (CSV) file, or other file or object used to import data. It is noted that an administrator typically can create new profiles and/or view, edit, archive, or delete existing profiles regardless of whether they were manually entered by an administrator or automatically generated by the holistic academic server 110.

In the embodiment illustrated in FIG. 5B, the menu 510 provides access to display descriptions to create, view, edit, archive, and/or delete user profiles associated with the member school 105. For example, the menu 510 includes an option 515 to manage student profiles, an option 520 to manage teacher profiles, an option 525 to manage administrator profiles, and an option 530 to manage parent profiles. In some embodiments, the options available for selection in the menu 510 are limited to the types of user profiles defined for a member school. While the types of user profiles described above are typically representative of the types of users associated with a member school, those skilled in the art will appreciate that some member schools may include different types of user profiles and/or a greater or lesser number of user profiles.

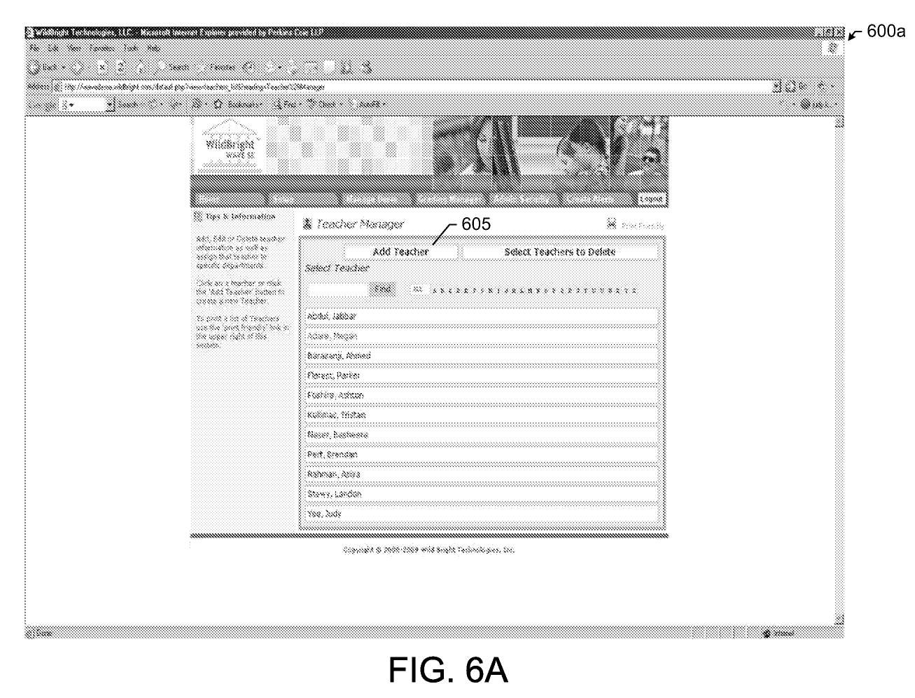

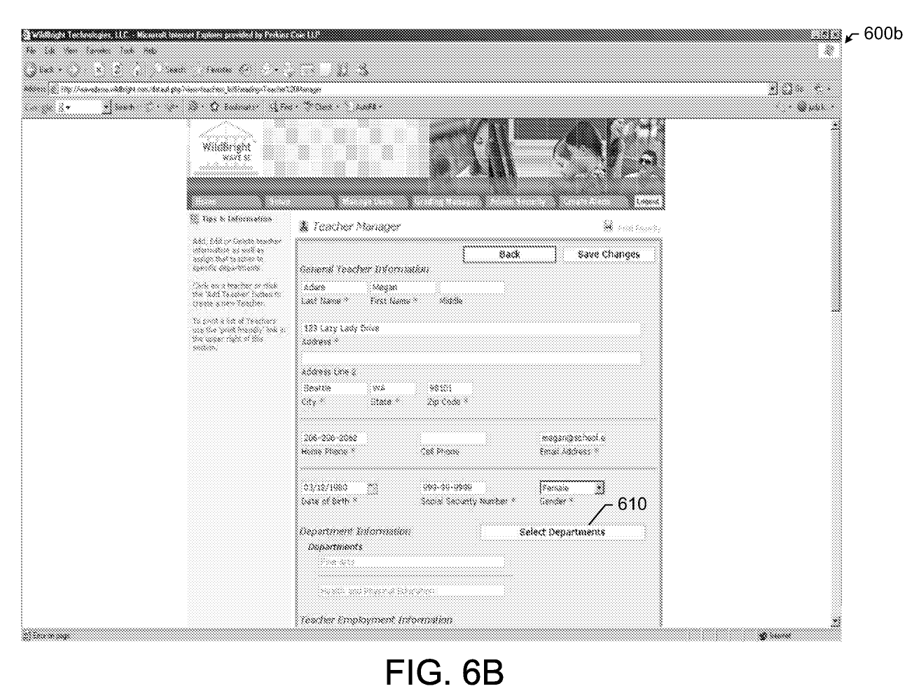

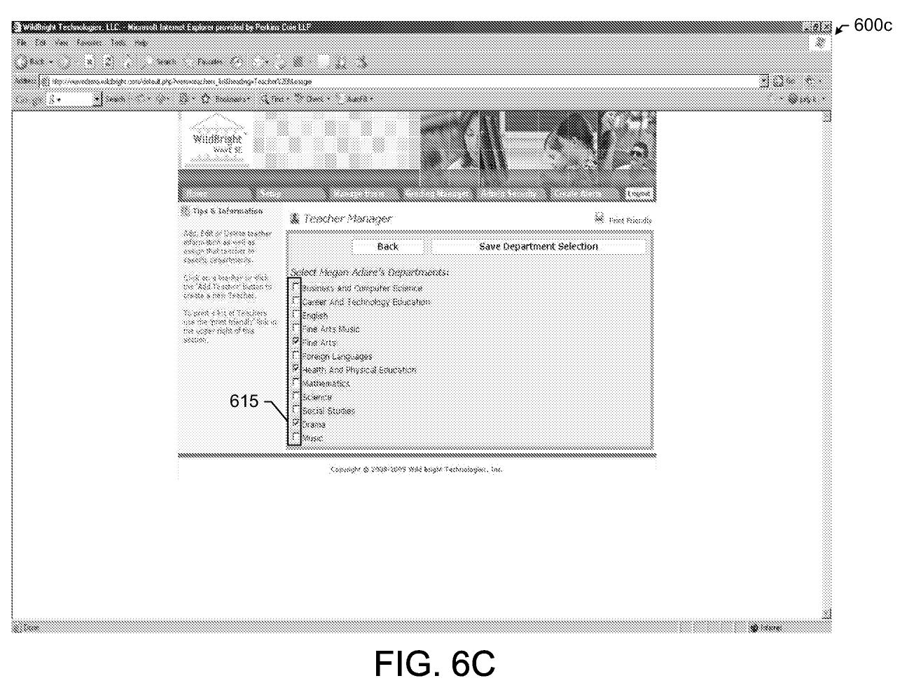

In the embodiment illustrated in FIG. 5B, an administrator operating a client computer 120 selects option 520 to manage teacher profiles. FIG. 6A is a screenshot of a display description 600a to manage teacher profiles, in one or more embodiments. The display description 600a includes a number of controls to enable an administrator operating a client computer 120 to create, view, edit, archive, and/or delete profiles corresponding to teachers associated with the member school 105. For example, in the embodiment illustrated in FIG. 6A, an administrator may create a new profile by selecting the “Add Teacher” control 605. As another example, an administrator may view or edit an existing teacher profile by selecting the name of the teacher. FIG. 6B is a screenshot of a display description 600b to manage a selected teacher profile (e.g., “Megan Adare”). In some embodiments, teacher profile information includes general information and/or teacher-specific information. General information may include, for example, a teacher's full name, date of birth, Social Security number, gender, and so on. Teacher-specific information may include, for example, information identifying one or more departments to which a teacher has been assigned. As another example, teacher-specific information may include a teacher's date of hire, education, degree/certification, base salary, employment type (e.g., part-time), and so on. In the embodiment illustrated in FIG. 6B, the display description 600b includes a number of controls to enable administrator operating a client computer 120 to edit the selected teacher profile. For example, in the embodiment illustrated in FIG. 6B, an administrator operating a client computer 120 may edit the departments to which a teacher is assigned by selecting the “Select Departments” control 610. FIG. 6C is a screenshot of a display description 600c presented to an administrator in response to the selection of the Select Departments control 610. In the embodiment illustrated in FIG. 6C, the display description 600 includes a number of controls 615 (e.g., checkboxes) to enable an administrator operating a client computer 120 to assign the selected teacher to one or more departments. Typically, after a teacher has been assigned to a department, the teacher may be selected to teach subjects within that department.

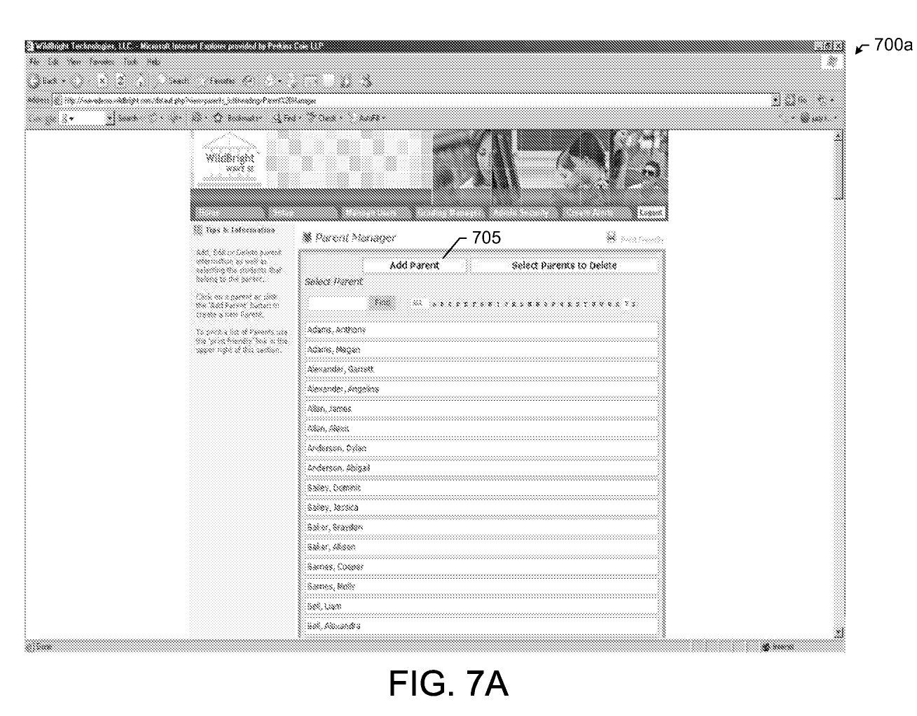

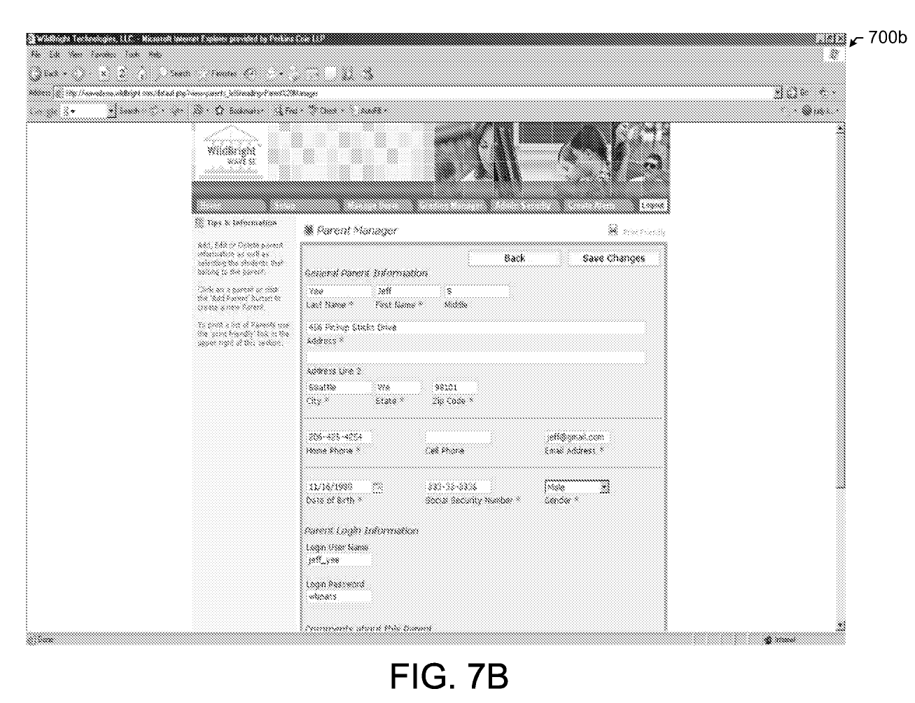

Returning to FIG. 5B, an administrator operating a client computer 120 selects option 530 to manage parent profiles. FIG. 7A is a screenshot of a display description 700a to manage parent profiles, in one or more embodiments. The display description 700a includes a number of controls to enable an administrator operating a client computer 120 to create, view, edit, archive, and/or delete profiles corresponding to parents of one or more students associated with the member school 105. For example, in the embodiment illustrated in FIG. 7A, an administrator may create a new parent profile by selecting the “Add Parent” control 705. As another example, an administrator may view or edit an existing parent profile by selecting the name of the parent. FIG. 7B is a screenshot of a display description 700b to manage the selected parent profile (e.g., “Jeff Yee”). The display description 700b includes a number of controls to enable an administrator operating a client computer 120 to edit the selected parent's profile. In some embodiments, parent profile information may include general information and/or parent-specific information. General Information may include, for example, a parent's full name, date of birth, Social Security number, gender, and so on. Parent-specific information may include, for example, a parent's preferred tuition payment method, and so on.

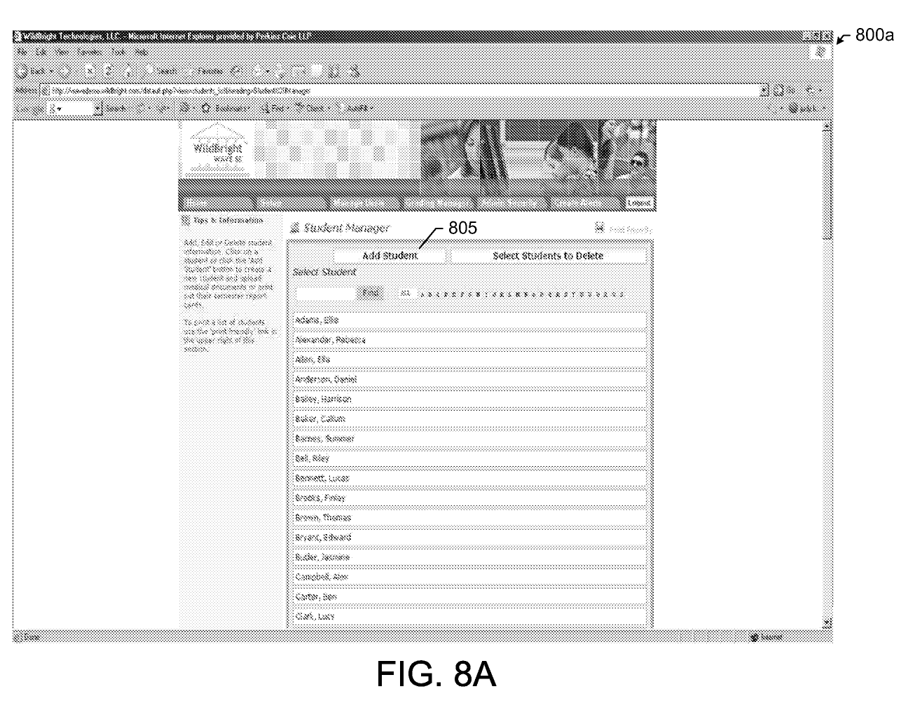

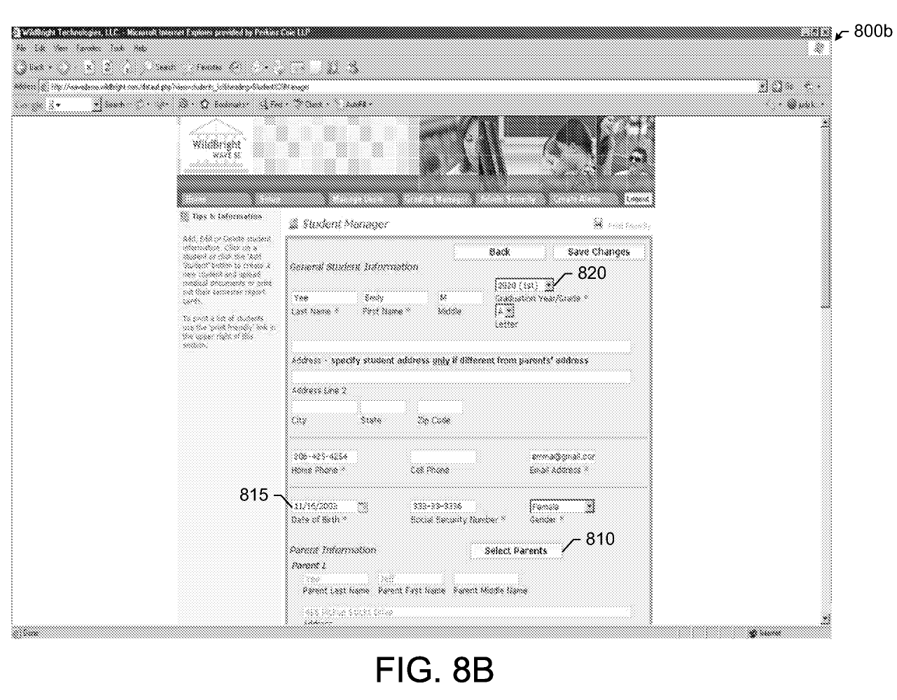

Returning to FIG. 5B, an administrator operating a client computer 120 selects option 515 to manage student profiles. FIG. 8A is a screenshot of a display description 800a to manage student profiles, in one or more embodiments. The display description 800a includes a number of controls to enable an administrator operating a client computer 120 to create, view, edit, archive, and/or delete profiles corresponding to students associated with the member school 105. For example, in the embodiment illustrated in FIG. 8A, an administrator may create a new student profile by selecting the “Add Student” control 805. As another example, an administrator may view or edit an existing student profile by selecting the name of the student. FIG. 8B is a screenshot of a display description 800b to manage a selected student profile (e.g., “Emily Yee”). Student profile information may include general information and/or student-specific information. General information may include, for example, a student's full name, date of birth, Social Security number, gender, and so on. Student-specific information may include, for example, information identifying a student's parents, a student's emergency contact information, medical information (e.g., insurance provider, allergies, etc.), and so on. In the embodiment illustrated in FIG. 8B, the display description 800b includes a number of controls to enable an administrator operating a client computer to edit the selected student profile. For example, in the embodiment illustrated in FIG. 8B, an administrator may link the selected student's profile to his or her parents' profiles by selecting the “Select Parents” control 810. By linking a selected student's profile to his or her parents' profiles, the display descriptions available to the parents are populated with the selected student's shared data, thereby enabling the parents to monitor the selected student's performance and participate in his or her education.

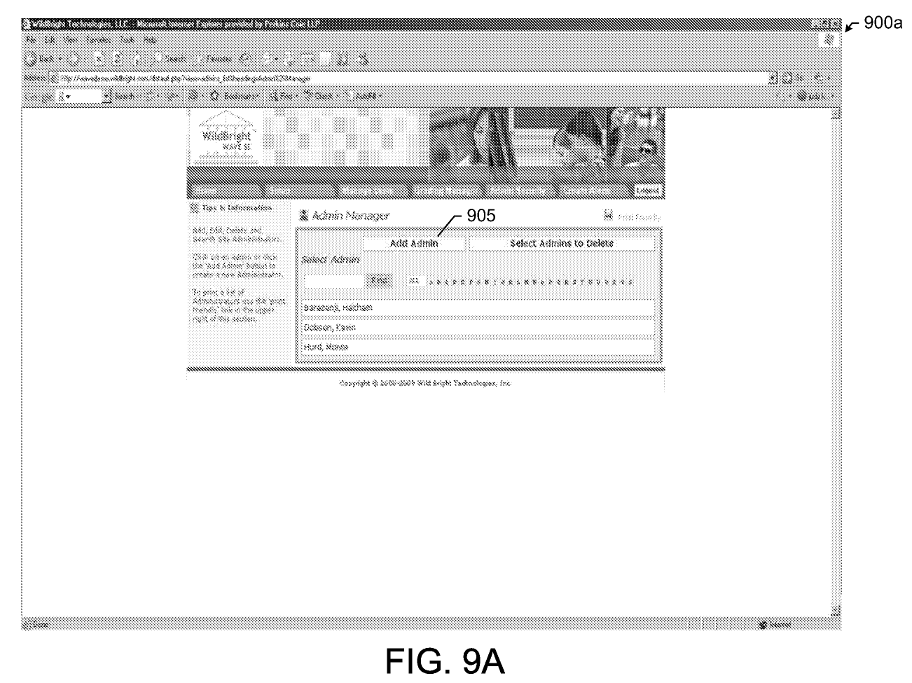

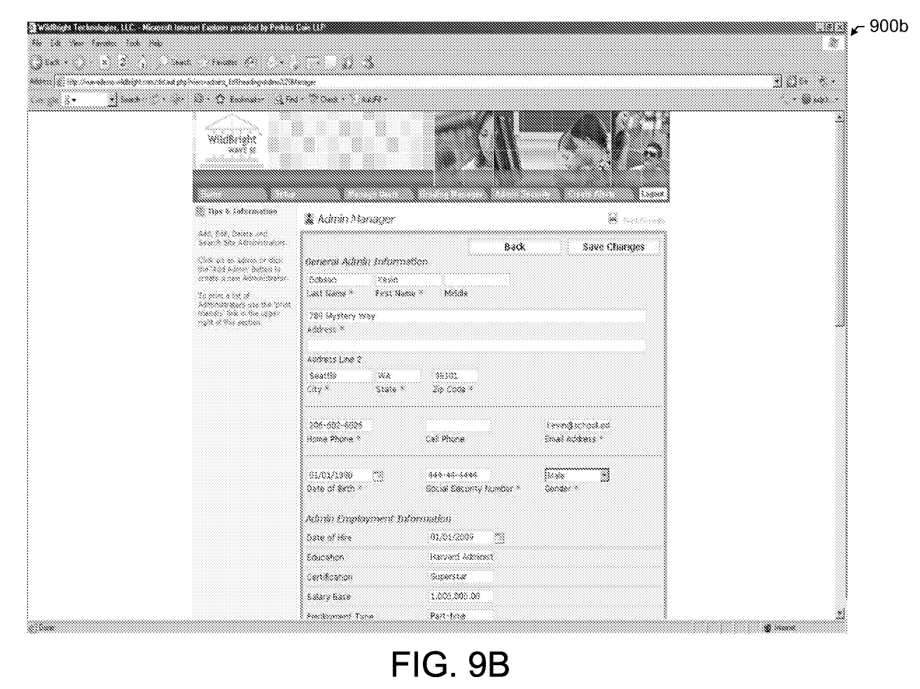

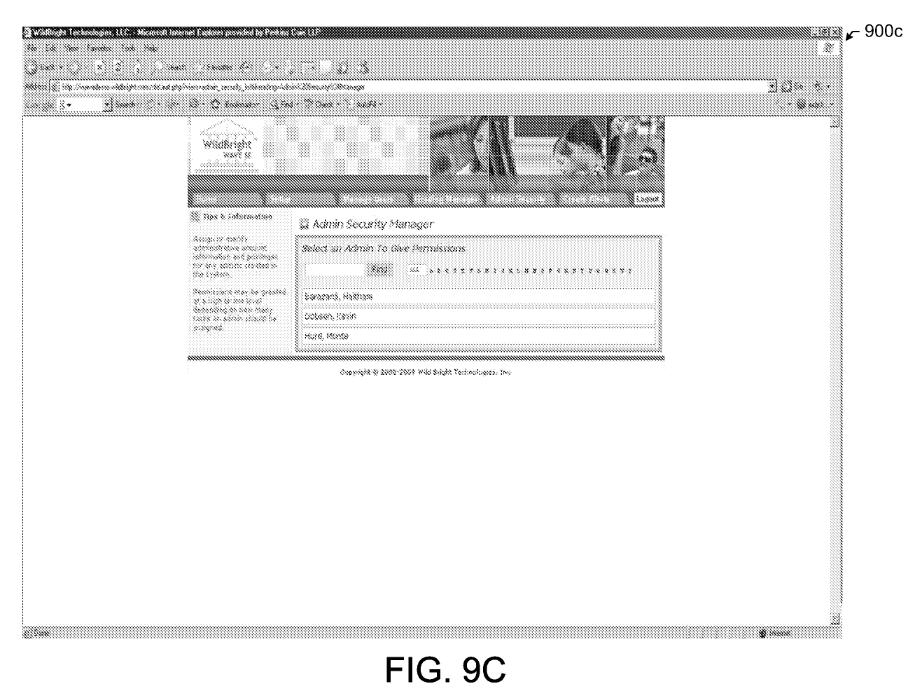

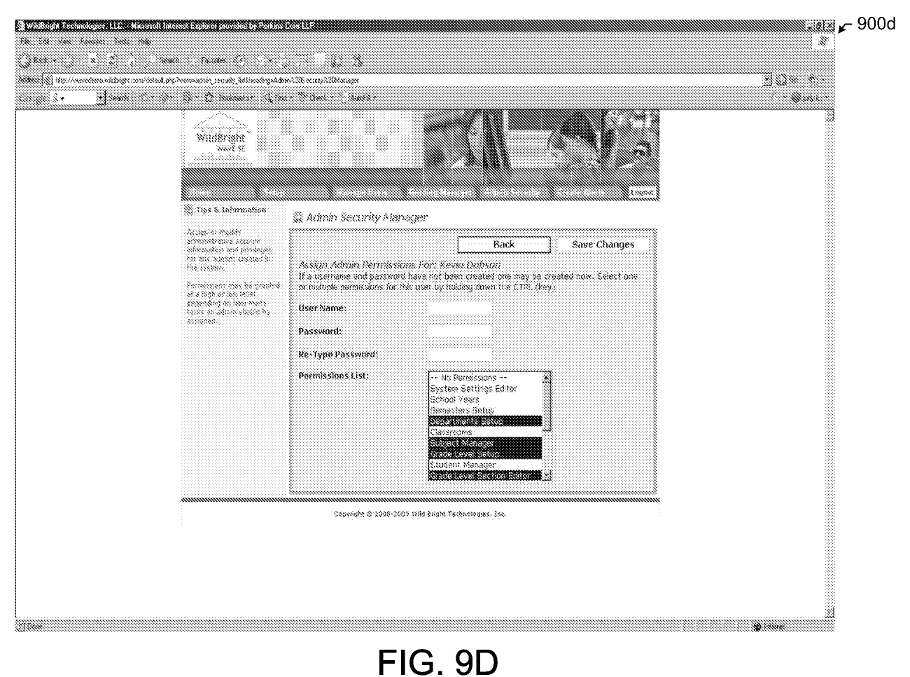

Returning to FIG. 5B, an administrator operating a client computer 120 selects option 525 to manage administrator profiles. FIG. 9A is a screenshot of a display description 900a to manage administrator profiles, in one or more embodiments. The display description 900a includes a number of controls to enable an administrator operating a client computer 120 to create, view, edit, archive, and/or delete profiles corresponding to administrators associated with the member school 105. For example, in the embodiment illustrated in FIG. 9A, an administrator may create a new administrator profile by selecting the “Add Admin” control 905. As another example, an administrator may view or edit an existing administrator profile by selecting the name of the administrator. FIG. 9B is a screenshot of a display description 900b to manage a selected administrator profile (e.g., “Kevin Dobson”). The display description 900b includes a number of controls to enable an administrator to edit the selected administrator profile. Administrator profile information may include general information and/or administrator-specific information. General information may include, for example, an administrator's full name, date of birth, Social Security number, gender, and so on. Administrator-specific information may include, for example, an administrator's date of hire, education, degree/certification, base salary, employment type (e.g., part-time), and so on.

In some embodiments, the display descriptions available to an administrator vary based on the privileges assigned to the administrator. For example, all administrators may have an administrative view of a school schedule, but only one administrator may have administrative privileges to modify the school schedule. As another example, all administrators may be able to view their own user profile information, but only certain administrators may be able to view and/or edit certain types of profile information, such as administrators' and/or teachers' salary information. In the embodiment illustrated in FIG. 5A, an administrator operating a client computer 120 may assign or modify administrative privileges of an administrator by selecting the “Admin Security” tab 535. FIG. 9C is a screenshot of a display description 900c that is presented to an administrator in response to the selection of the Admin Security tab 535, in one or more embodiments. The Admin Security tab 535 and/or the display description 900c are typically only available to administrators that have been granted all administrative privileges. In the embodiment illustrated in FIG. 9C, the display description 900c includes a number of controls to enable an administrator operating a client computer 120 to select an administrator to view, assign, and/or edit their administrative privileges. FIG. 9D is a screenshot of a display description 900d that is presented to an administrator in response to the selection of an administrator listed in the display description 900c (e.g., “Kevin Dobson”). The display description 900d includes a number of controls to enable an administrator operating a client computer 120 to assign and/or edit the administrative privileges of the selected administrator. In the embodiment illustrated in FIG. 9D, the selected administrator has been granted some privileges and not others. For example, the selected administrator has not been granted the privilege to manage student profiles. In some embodiments, when a selected administrator does not have privileges to manage certain shared data of the member school, one or more interfaces and/or display descriptions may not be available to the selected administrator. For example, when the selected administrator selects the Manage Users tab 505 of display description 500, the “Student Manager” option 515 may not be displayed in the Manage Users menu 510. As another example, the selected administrator may be able to view student profiles via display descriptions 800a and/or 800b, however, the selected administrator may not be able to create, edit, archive, and/or delete student profiles.

It is noted that profile management display descriptions 420 may include other display descriptions not specifically illustrated herein. Those skilled in the art will appreciate that profile management display descriptions 420 may be altered in a variety of ways. For example, certain display descriptions 420 may be merged together or divided; certain display descriptions 420 may be omitted; certain display descriptions 420 may be added; and so on. In some embodiments, at least one of profile management display descriptions 420 is available, and may be displayed via a corresponding perspective, to teachers, parents, and/or students of a member school.

Returning to FIG. 4, an administrator operating a client computer 120 manages a profile of the member school 105 by accessing, for example, one or more of the logistics management display descriptions 425. The profile of a member school may include information describing the grade levels (e.g., K-12) of the member school, the maximum number of sections per grade level, the resources of the member school (e.g., the number of classrooms, the size of each classroom, movable or immovable equipment within a classroom, such as computers, ceramic kilns, pianos, chemistry benches, etc.), the departments within the member school (e.g., Art, etc.), the subjects within each department (e.g., Ceramics, Photography, Painting, etc.), the beginning and ending dates for past, present, and/or future school years and/or school sessions (e.g., semesters, trimesters, quarters, etc.), the grade submission date for past, present, and/or future sessions, holidays, and so on. Those skilled in the art will appreciate that a member school's profile may include other information not specifically mentioned herein.

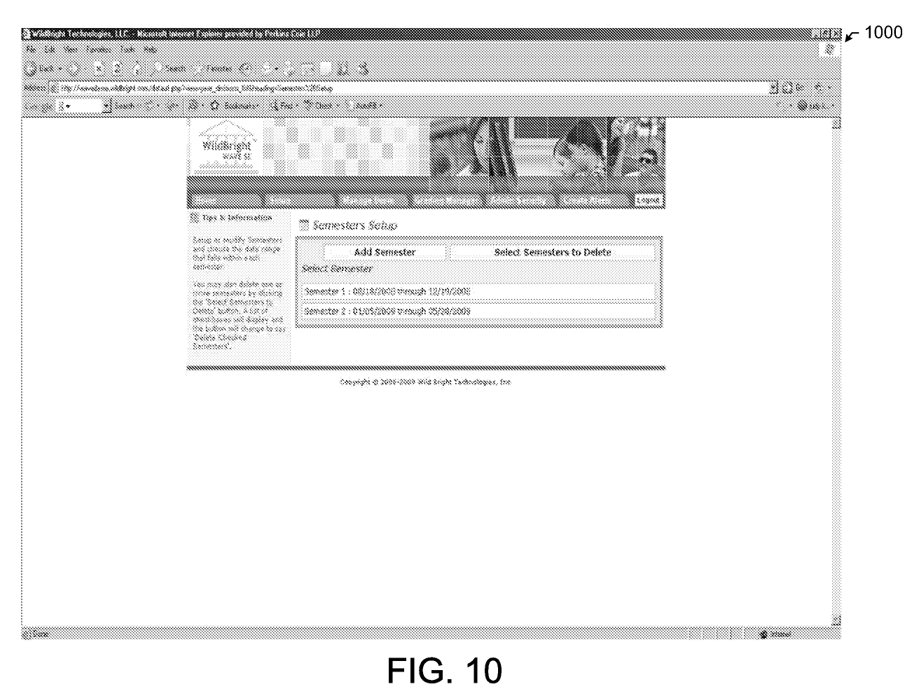

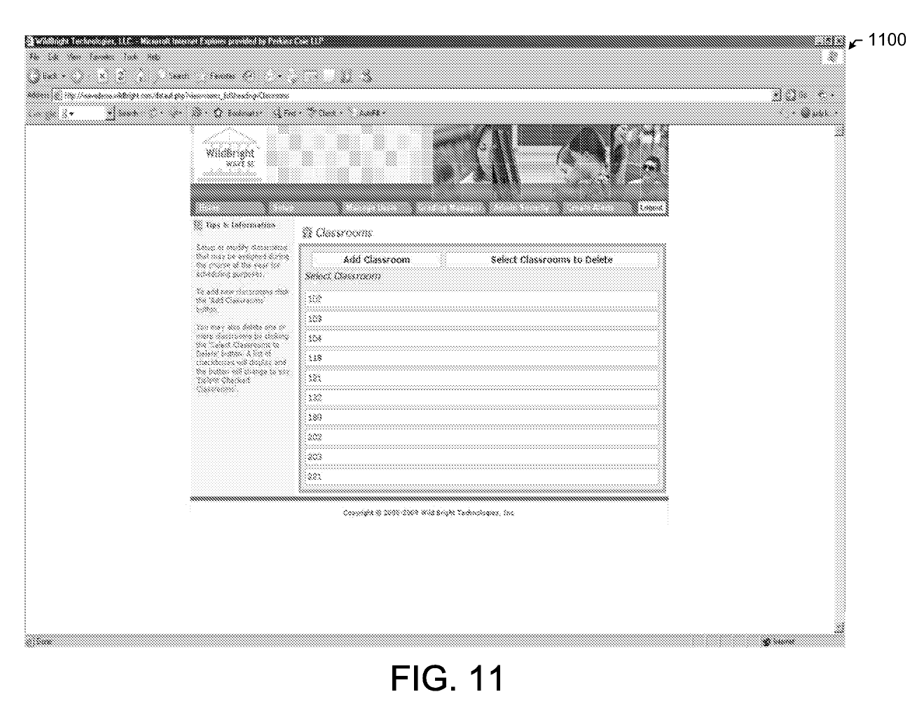

In the embodiment illustrated in FIG. 5A, an administrator operating a client computer 120 manages a profile of the member school 105 by selecting, for example, one or more of controls 540-570 to access corresponding logistics management display descriptions 425. For example, an administrator operating a client computer 120 may select the “Semester Setup” control 540 to manage the beginning and ending dates of a school session (e.g., a semester). FIG. 10 is a screenshot of a display description 1000 that is presented to an administrator in response to the selection of the Semester Setup control 540, in one or more embodiments. The display description 1000 includes a number of controls to enable an administrator to create, view, edit, archive, and/or delete a school session. As another example, in the embodiment illustrated in FIG. 5A, an administrator operating a client computer 120 may select the “Classrooms” control 550 to manage the resources of the member school 105. The resources of the member school 105 may include, for example, the number of classrooms, the size of each classroom, movable or immovable equipment within a classroom, such as computers, ceramic kilns, pianos, chemistry benches, and so on. FIG. 11 is a screenshot of a display description 1100 that is presented to an administrator in response to the selection of the Classrooms control 550, in one or more embodiments. The display description 1100 includes a number of controls to enable an administrator to create, view, edit, and/or delete resources of the member school 105.

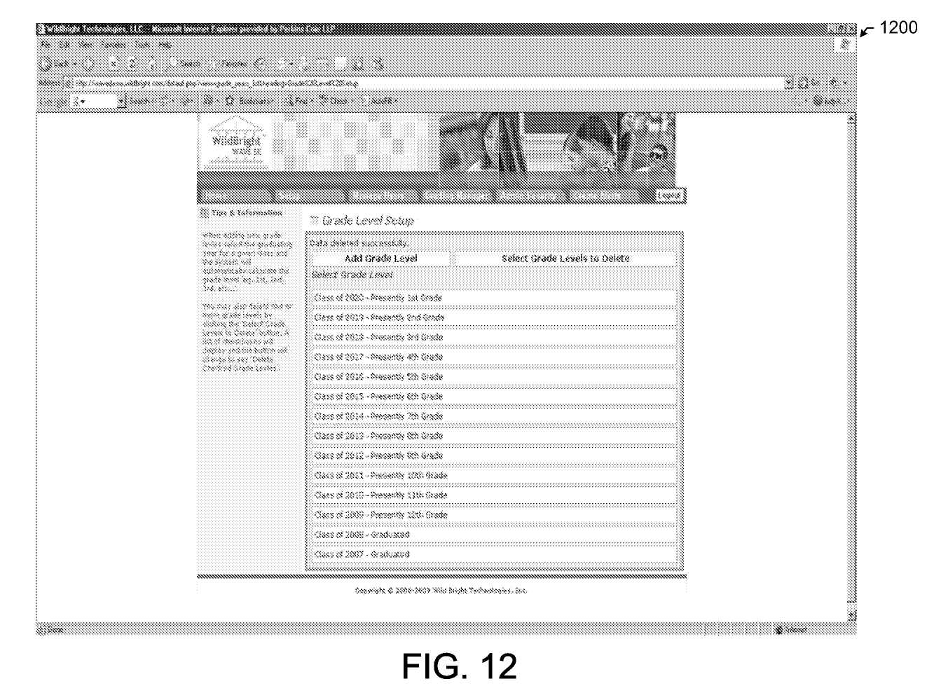

In the embodiment illustrated in FIG. 5A, an administrator operating a client computer 120 may select the “Grade Level Setup” control 560 to manage information describing the grade levels (e.g., K-12) of the member school 105. FIG. 12 is a screenshot of a display description 1200 and that is presented to an administrator in response to the selection of the Grade Level Setup control 560, in one or more embodiments. The display description 1200 includes a number of controls to enable an administrator to create, view, edit, and/or delete grade levels of the member school 105. Although the grade levels illustrated in FIG. 12 are representative of a K-12 member school, those skilled in the art will appreciated that the holistic academic system may include any number or type of grade levels. As such, the description of a K-12 member school should not be taken as restrictive.

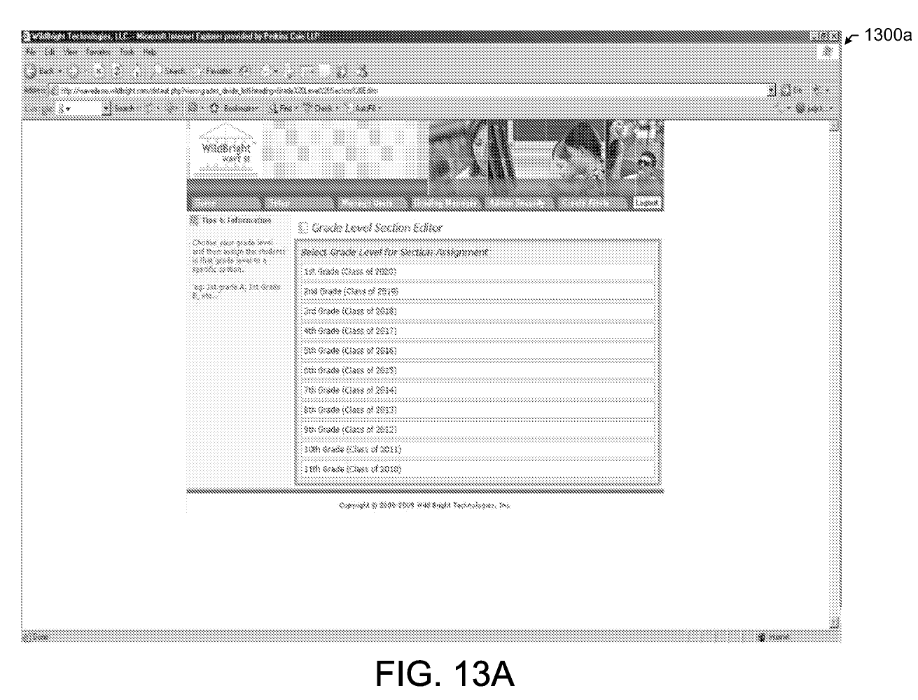

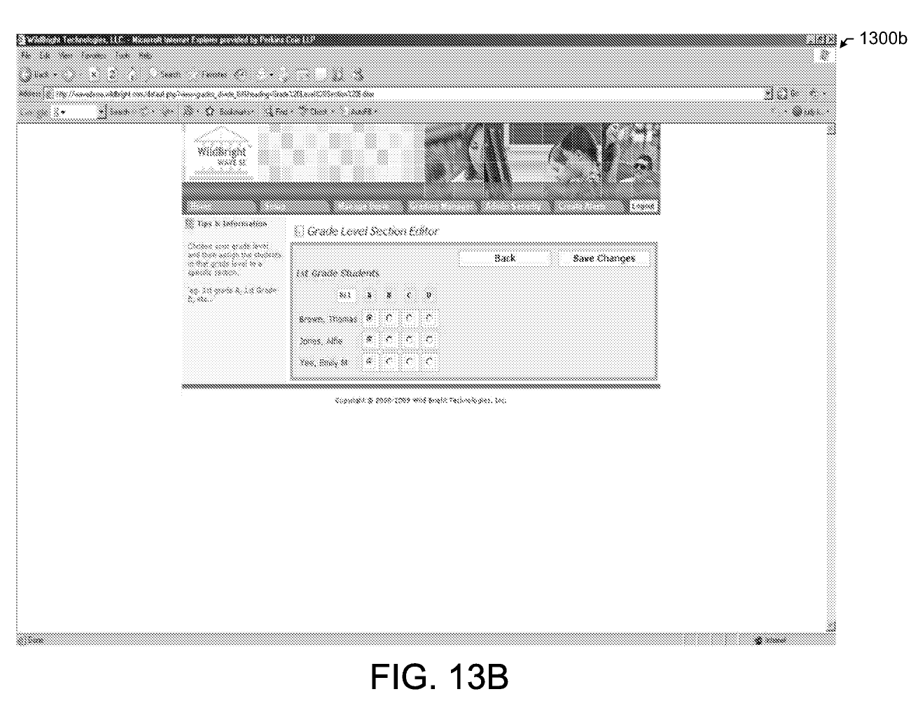

In some embodiments, the holistic academic server 110 automatically assigns each student to grade level and/or section. The holistic academic server 110 may assign each student to a grade level, for example, based on the student's profile information (e.g., based on the student's “Date of Birth” field 815 and/or the “Graduation Year/Grade” field 820 of the student's profile). The holistic academic server 110 may assign each student to a grade level section, for example, by randomly selecting each student for a grade level section, dividing the students evenly among the grade level sections, and/or ensuring that each section has a threshold number of students. In some embodiments, the holistic academic server 110 provides a user interface to enable an administrator operating a client computer 120 to assign students to a grade level and/or a grade level section. It is noted that an administrator can typically edit the grade level and/or grade level section assignments regardless of whether they are manually entered by an administrator or automatically generated by the holistic academic server 110. In the embodiment illustrated in FIG. 5A, an administrator operating a client computer 120 may select the “Grade Level Selection Editor” control 565 to manage grade level section assignments. FIG. 13A is a screenshot of a display description 1300a that is presented to an administrator in response to the selection of the Grade Level Selection Editor control 565, in one or more embodiments. The display description 1300a includes a number of controls to enable an administrator to view, edit, and/or assign students within a grade level to a grade level section. For example, in the embodiment illustrated in FIG. 13A, an administrator may view or edit the grade level section assignments for a particular grade level by selecting that grade level. FIG. 13B is a screenshot of a display description 1300b that is presented to an administrator in response to the selection of a grade level (e.g., “1^{st} Grade”), in one or more embodiments. The display description 1300b includes a list of the students within the selected grade level and one or more controls to edit and/or assign students within that grade level to one or more grade level sections. For example, in the embodiment illustrated in FIG. 13B, all 1^{st} Grade students are assigned to Section A. In some embodiments, the maximum number of grade level sections is defined by an administrator within the member school's profile. While in other embodiments, a default maximum number of grade level sections is provided by the holistic academic server 110. Typically, however, the maximum number of grade level sections may be edited by an administrator regardless of whether the number was established by an administrator or provided by the holistic academic server 110.

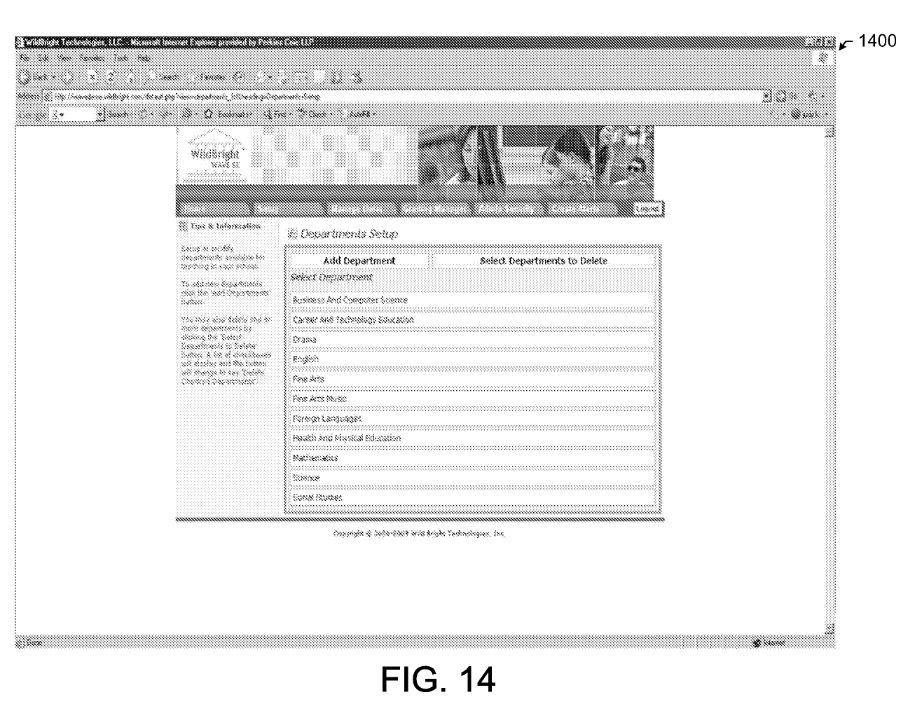

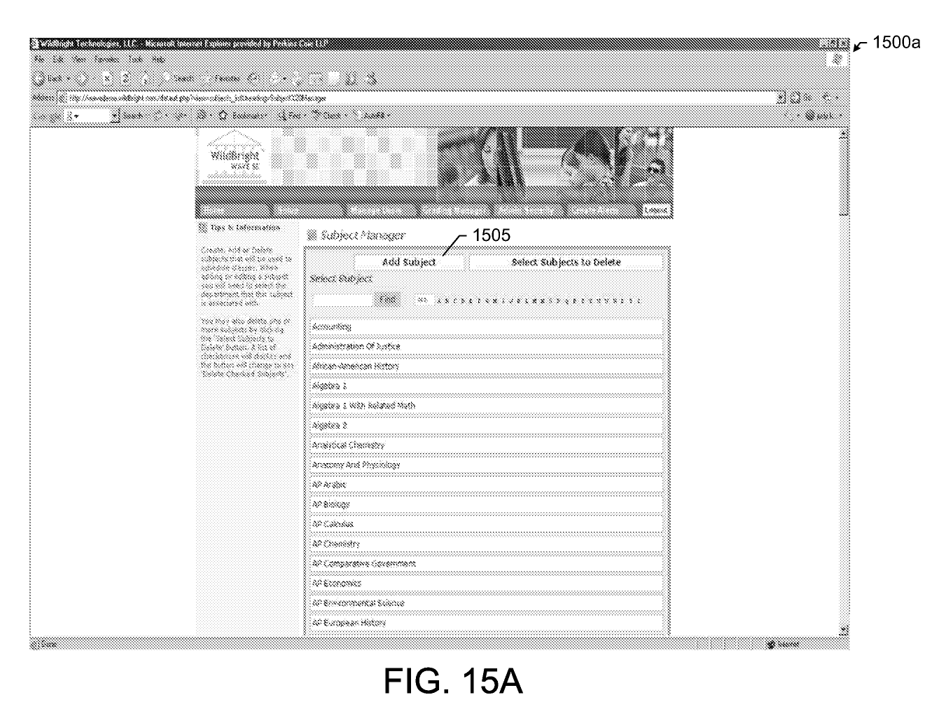

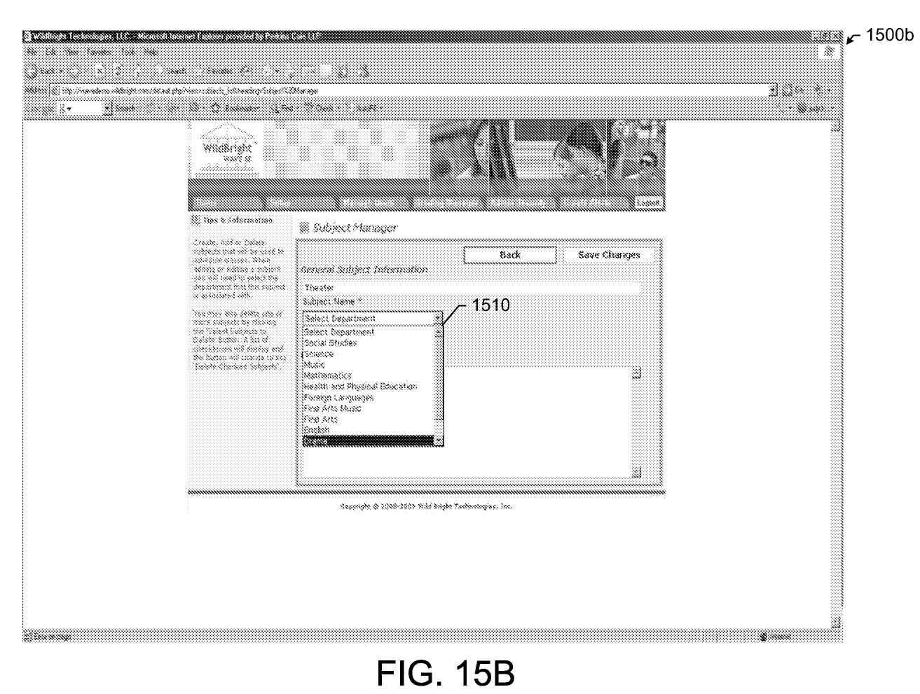

Returning to FIG. 5A, an administrator operating a client computer 120 may select the “Departments Setup” control 545 to manage the departments (e.g., Art, etc.) within the member school 105. FIG. 14 is a screenshot of a display description 1400 that is presented to an administrator in response to the selection of the Departments Setup control 545, in one or more embodiments. The display description 1400 includes a number of controls to enable an administrator to create, view, edit, and/or delete departments of the member school 105. To manage subjects taught within each department (e.g., Ceramics, Photography, Painting, etc.), an administrator operating a client computer 120 may select the “Subject Manager” control 555 illustrated in FIG. 5A. FIG. 15A is a screenshot of the display description 1500a that is presented to an administrator in response to the selection of the Subject Manager control 555, in one or more embodiments. The display description 1500a includes a number of controls to enable an administrator to create, view, edit, and/or delete subjects within each department. For example, in the embodiment illustrated in FIG. 15A, an administrator may create a new subject by selecting the “Add Subject” control 1505. FIG. 15B is a screenshot of a display description 1500b that is presented to an administrator in response to the selection of the Add Subject control 1505, in one or more embodiments. When an administrator creates a new subject, the administrator typically assigns the subject to a department of the member school 105 by selecting control 1510. For example, in the embodiment illustrated in FIG. 15B, an administrator assigns a new subject titled “Theater” to the Drama Department.

In some embodiments, the holistic academic server 110 automatically assigns subjects (e.g., algebra, chemistry, etc.) to each grade level and/or grade level section. For example, the holistic academic server 110 may automatically assign certain subjects to a grade level and/or grade level section based on explicit or implicit shared data associated with the member school 105. Explicit data may include, for example, schedules from past school session ends. Implicit data may include, for example, the title of a subject (e.g., “Math 1”, “1^{st} Grade Math”, etc.). In some embodiments, the holistic academic server 110 provides a logistics management display description 425 that is used by an administrator operating a client computer 120 to assign subjects to grade levels and/or a grade level sections. It is noted that an administrator typically can edit the subject assignments regardless of whether they are entered by an administrator or automatically generated by the holistic academic server 110. By freeing administrators from the burden of assigning students and/or subjects to grade levels or grade level sections, the holistic academic system significantly simplifies the process of managing a school.

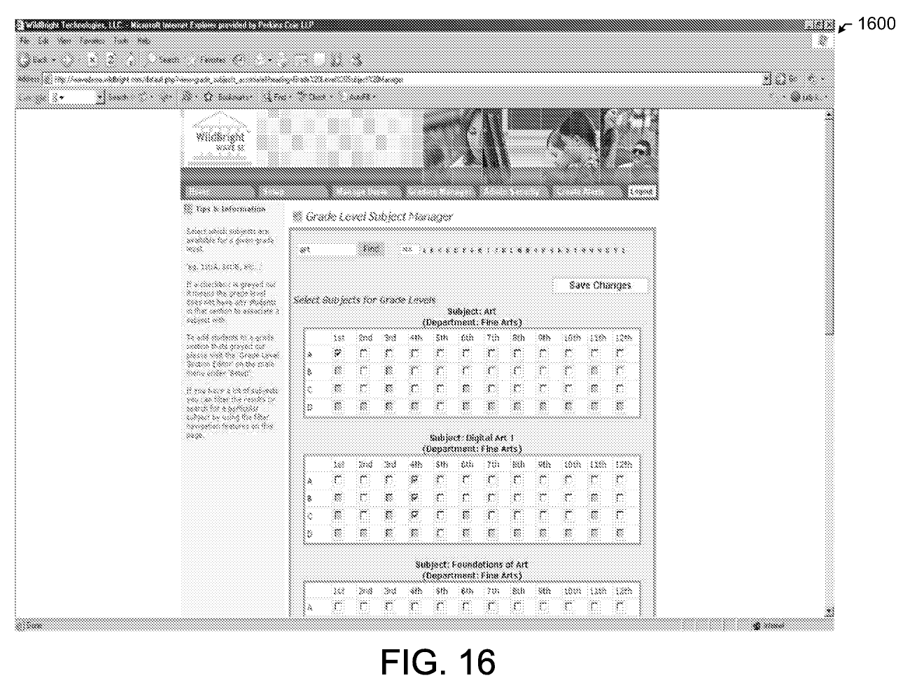

In the embodiment illustrated in FIG. 5A, an administrator operating a client computer 120 may select the “Grade Level Subject Manager” control 570 to manage the subjects assigned to each grade level and/or grade level section. FIG. 16 is a screenshot of a display description 1600 and that is presented to an administrator in response to the selection of the Grade Level Subject Manager control 570, in one or more embodiments. The display description 1600 includes a number of controls to enable an administrator operating client computer 120 to view, edit, and/or assign subjects to each grade level section. It is noted that each grade level may have the same or a different number of grade level sections. For example, in the embodiment illustrated in FIG. 16, the grade level sections to which subjects may be assigned correspond to the grade level sections to which students have been assigned. In the embodiment illustrated in FIG. 13B, all student assigned to be 1^{st} Grade were assigned to section A. As a result, in the embodiment illustrated in FIG. 16, the controls (e.g., checkboxes) corresponding to the grade level sections to which no students have been assigned (i.e., “1^{st} Grade B”, “1^{st} Grade C”, and “1^{st} Grade D”) are inoperable so that no subjects may be assigned to them. When a control is inoperable, in the embodiment illustrated in FIG. 16, a graphical image representing the control is “grayed out,” leaving a shadow over the control. Those skilled in the art will appreciate that there may be other ways in which a control may be displayed as inoperable. For example, in some embodiments, when a control is inoperable it is not displayed.

Returning to FIG. 5A, an administrator operating a client computer 120 manages one or more schedules of a member school by selecting, for example, the “Scheduling” control 575 to access one or more corresponding schedule display descriptions 430. In some embodiments, the holistic academic server 110 automatically generates a schedule for a selected school session based on the subjects assigned to each grade level section, the teacher profiles, and/or the resources required (e.g., classroom size, equipment, etc.). For example, a subject (e.g., “Photography 1”) may be scheduled in a particular classroom (e.g., “Room 203”) because of the resources (e.g., a dark room) associated with that classroom as defined in the profile data of the member school 105. In some embodiments, the holistic academic server 110 provides one or more display descriptions 430 to enable an administrator operating a client computer 120 to generate and/or edit a schedule. In some embodiments, the holistic academic system provides a display description with which an administrator may specify a heuristic to be used when generating a schedule for a specified school session. The heuristic may include one or more scheduling preferences, such as teacher seniority, resources, subject ordering (e.g., “no physical education classes after lunch”), and so on. In some embodiments, the scheduling preferences have an order of precedence. It is noted that an administrator operating a client computer 120 can typically edit a schedule regardless of whether it was generated by an administrator or automatically generated by the holistic academic server 110. By freeing administrators from the burden of scheduling academic resources, the holistic academic system further simplifies the process of managing a school.

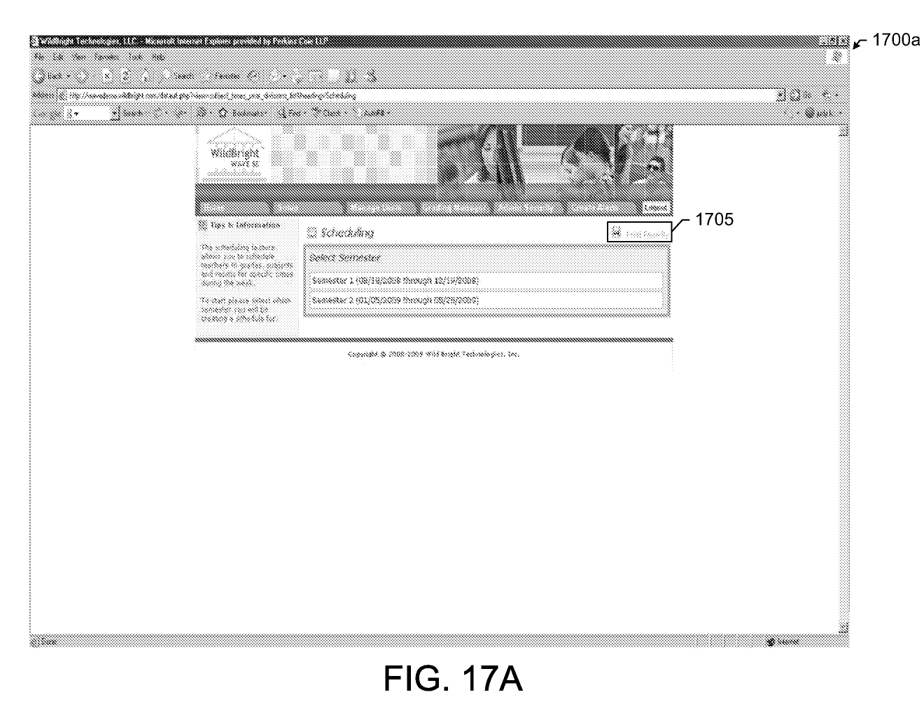

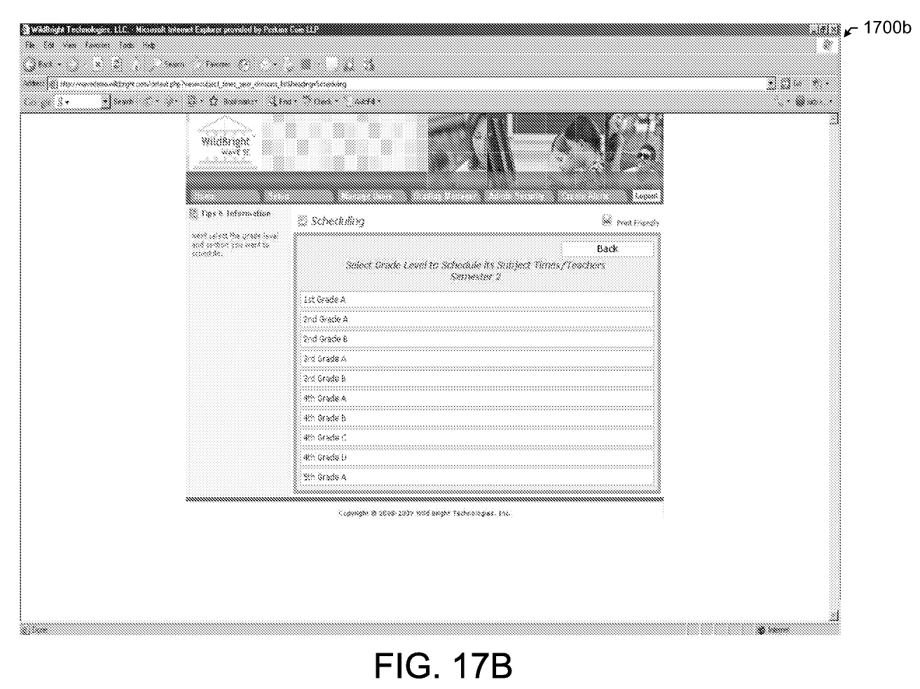

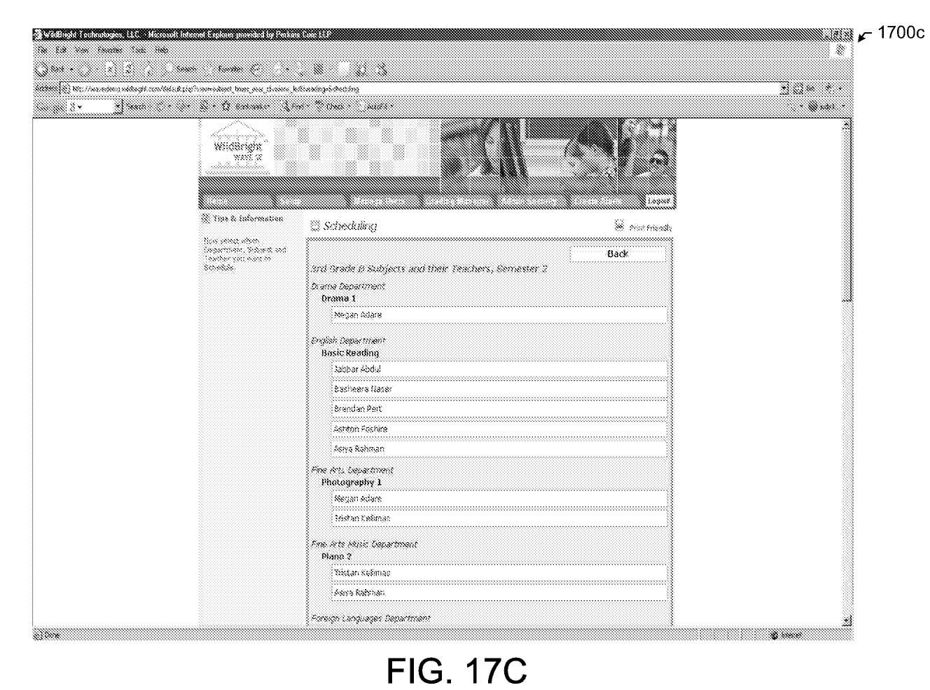

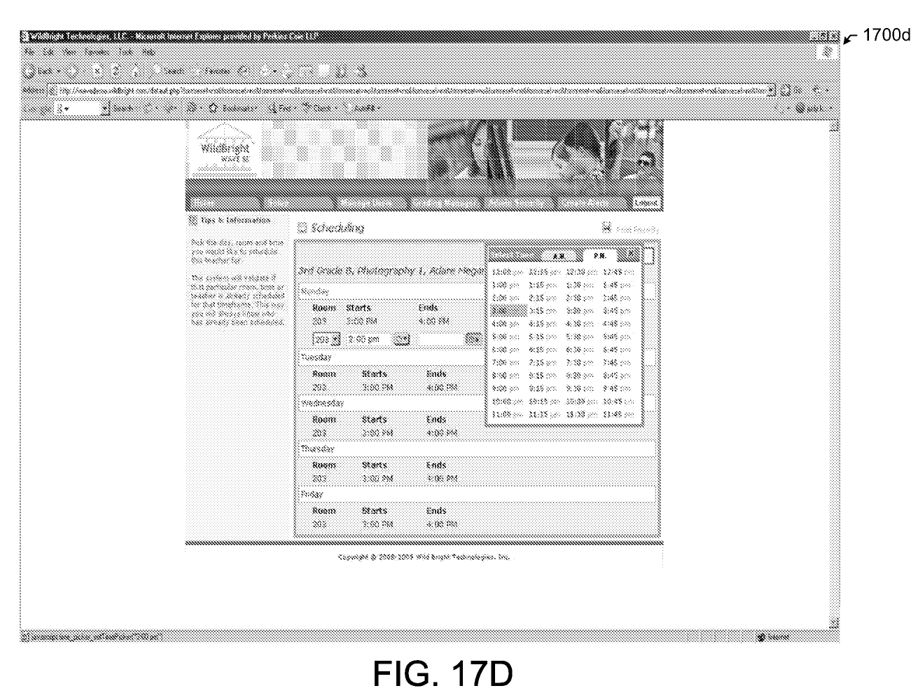

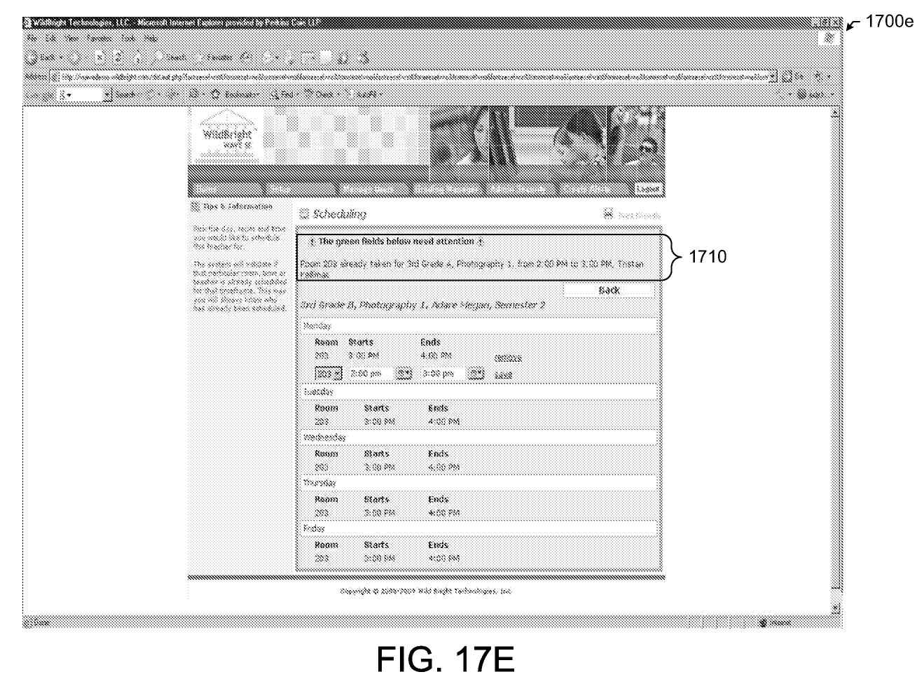

In the embodiment illustrated in FIG. 5A, an administrator operating a client computer 120 may create, view, edit, archive, and/or delete a schedule by selecting the “Scheduling” control 575. FIG. 17A is a screenshot of a display description 1700a that is presented to an administrator in response to the selection of the Scheduling control 575, in one or more embodiments. The display description 1700a includes a number of controls to generate, view, and/or edit a schedule for one or more sessions (e.g., semesters) of the member school 105. For example, in the embodiment illustrated in FIG. 17A, an administrator may generate a printable schedule for one or more defined school sessions by selecting a control 1705. As another example, an administrator may generate, view, and/or edit a schedule for a session by selecting the session from the displayed list of sessions defined for the member school 105. FIG. 17B is a screenshot of a display description 1700b that is presented to an administrator in response to the selection of a session from the displayed list (e.g., “Semester 2”), in one or more embodiments. The display description 1700b includes a number of controls to generate, view, and/or edit a schedule for one or more grade level sections of the member school 105. It is noted that each grade level may have the same or a different number of grade level sections. For example, in the embodiment illustrated in FIG. 17B, the grade level sections in the displayed list correspond to the grade level sections to which students have been assigned. In the embodiment illustrated in FIG. 13B, all students assigned to the 1^{st} Grade were assigned to Section A. As a result, in the embodiment illustrated in FIG. 17B, the displayed list includes one 1^{st} Grade section (i.e., “1^{st} Grade A”). An administrator may generate, view, and/or edit a schedule for a grade level section by selecting the grade level section from the displayed list of grade level sections. FIG. 17C is a screenshot of a display description 1700c that is presented to an administrator in response to the selection of a grade level section from the displayed list (e.g., “3^{rd} Grade B”), in one or more embodiments. The display description 1700c includes a number of controls to select a teacher, or edit a teacher selection, for each subject assigned to the selected grade level section. For example, in the embodiment illustrated in FIG. 17C, an administrator may select Megan Adare to teach Photography 1 to the selected grade level section (i.e., “3^{rd} Grade B”). FIG. 17D is a screenshot of a display description 1700d that is presented to an administrator in response to the selection of a teacher, in one or more embodiments. In some embodiments, when a teacher is selected, the holistic academic server 110 automatically assigns a time, location, and/or frequency at which the selected teacher is scheduled to teach the subject (e.g., based on a heuristic, resource requirement, and/or the like). In the embodiment illustrated in FIG. 17D, the display description 1700d includes a number of controls to select and/or edit a time and/or a location at which the selected teacher is scheduled to teach the assigned subject. It is noted that if the administrator selects a time at which the selected teacher is currently scheduled to teach another class and/or a location at which another class is currently scheduled, an error message is typically displayed to the administrator. For example, FIG. 17E is a screenshot of the a display description 1700e displaying an example scheduling error message 1710, in one or more embodiments.

Returning to FIG. 5A, an administrator operating a client computer 120 manages shared grade data of a member school by selecting, for example, the “Grading Manager” tab 580 to access one or more corresponding grade display descriptions 435. The grade display descriptions 435 simplifies the process of managing a member school by safeguarding the grading process. For example, the grade display descriptions 435 eliminate data conversion and synchronization errors because the display descriptions 435 access the same shared data, but from different perspectives. As another example, in some embodiments, the grade display descriptions 435 substantially reduce user input errors by validating grade data received from a user.

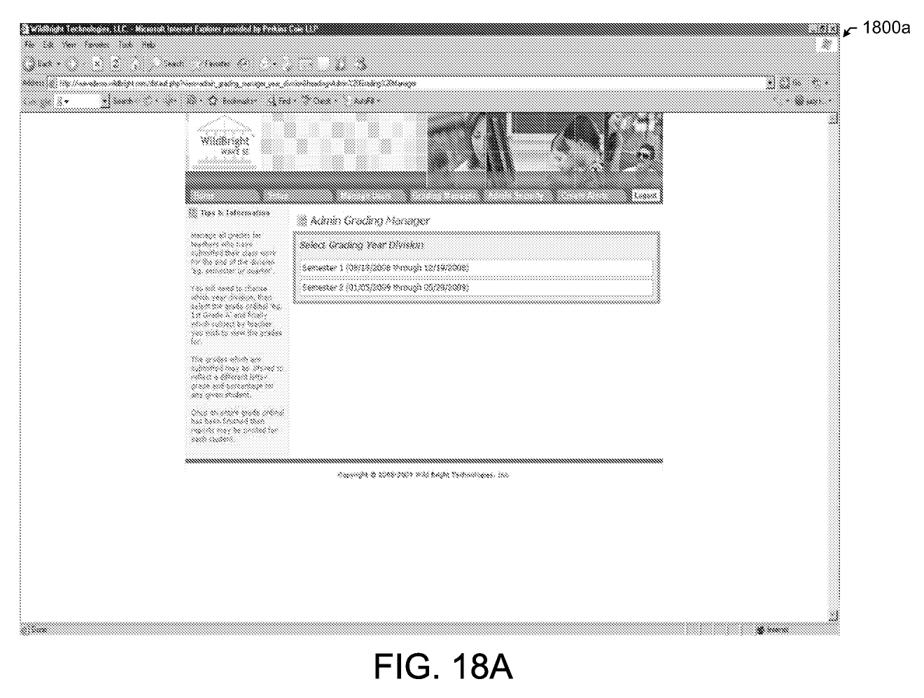

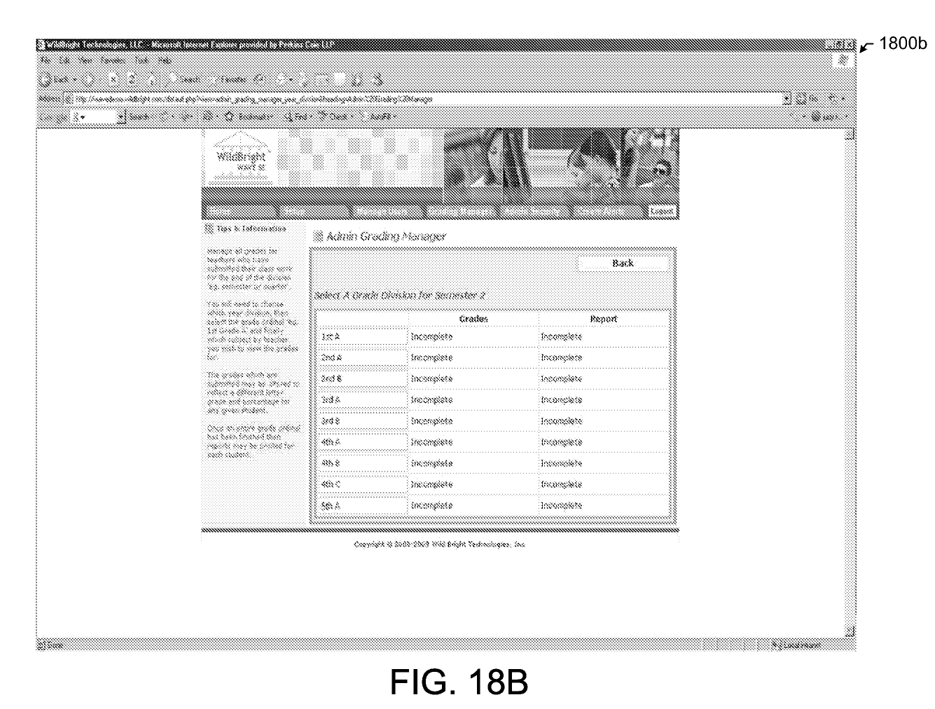

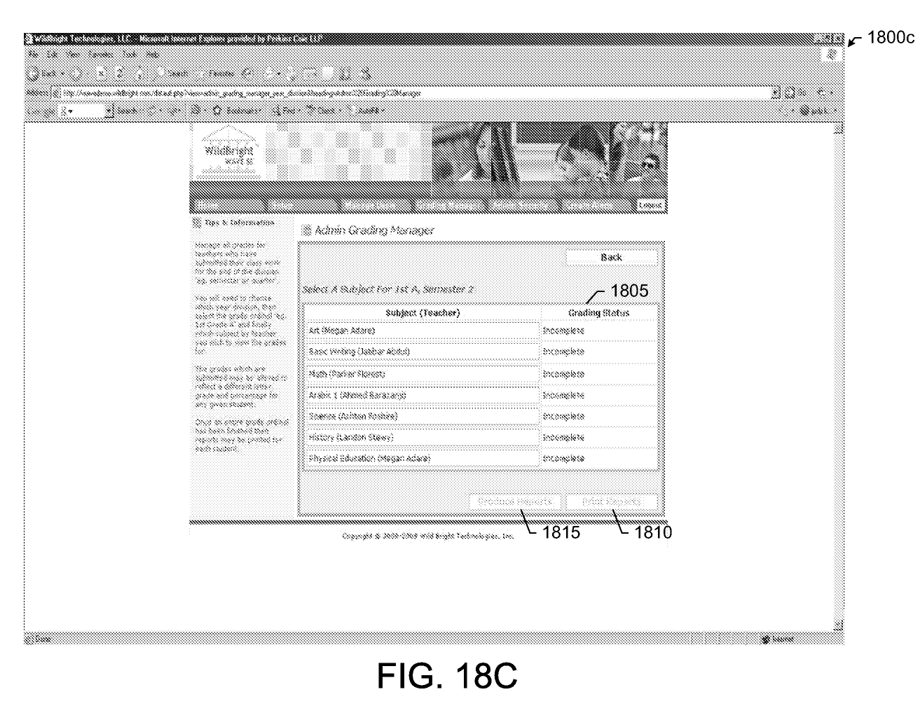

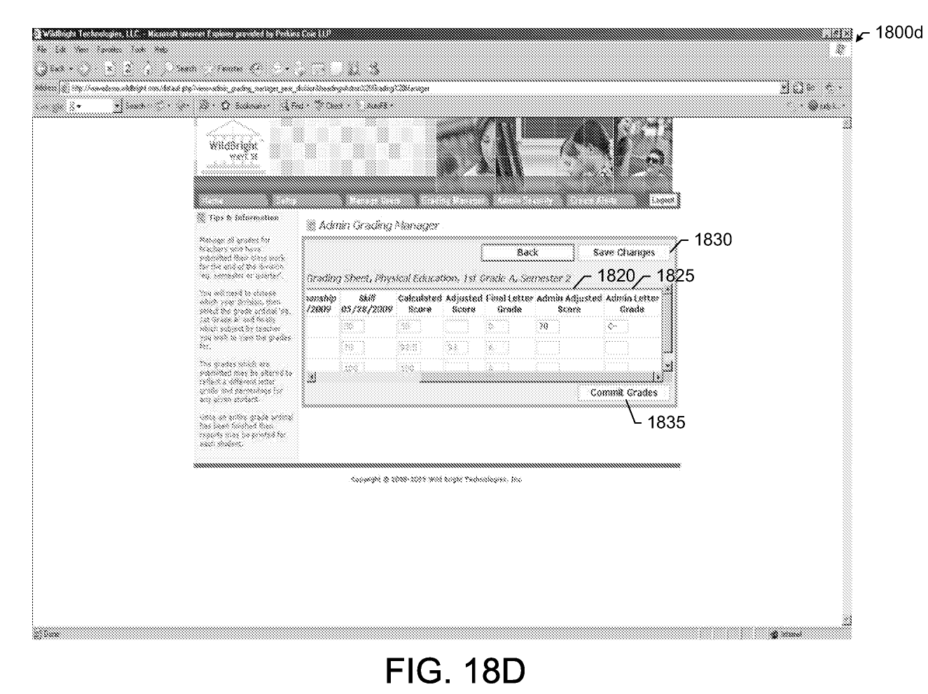

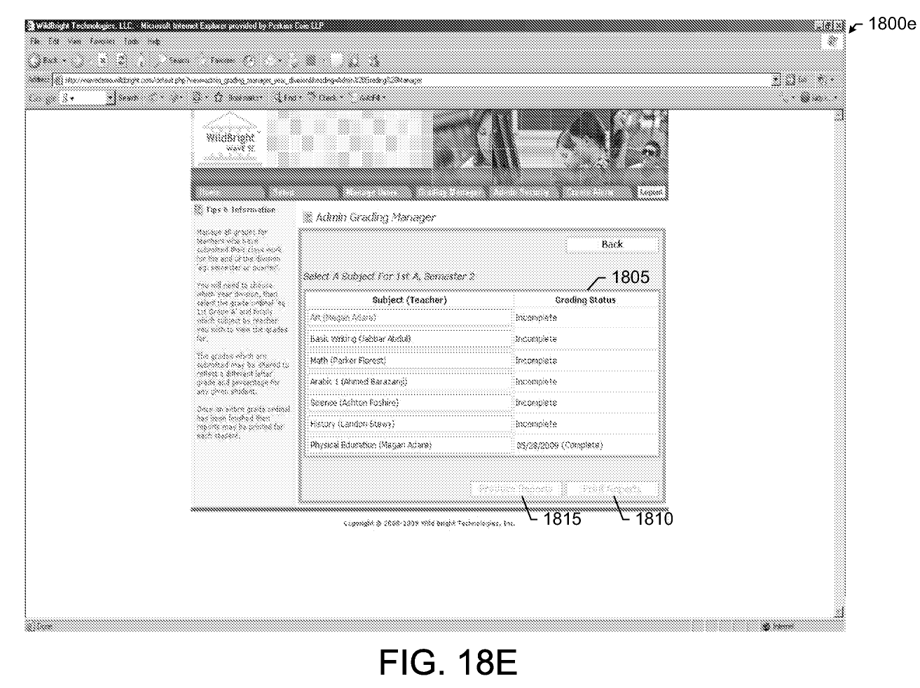

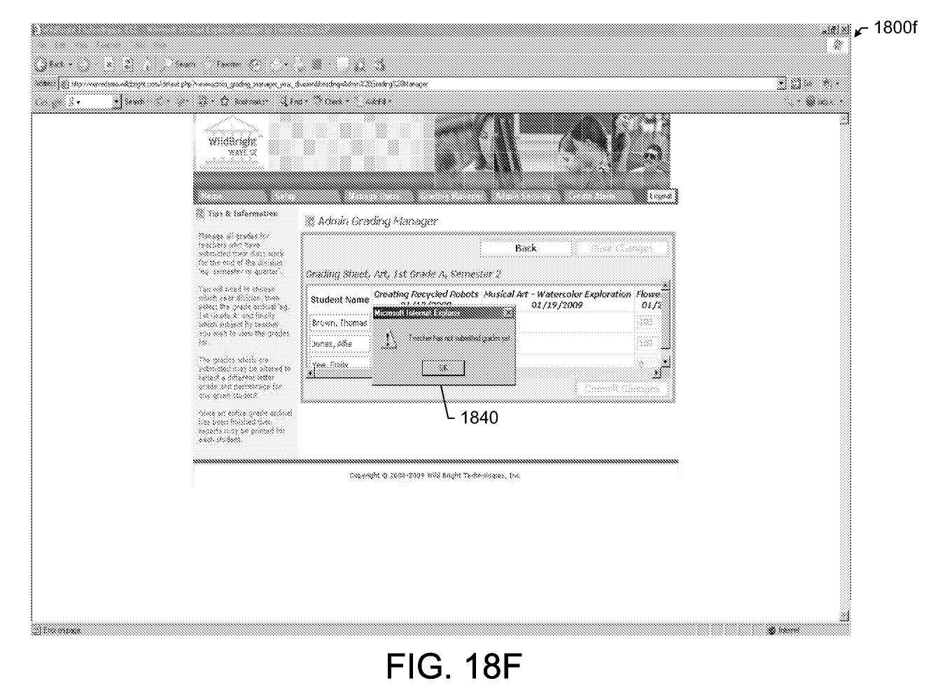

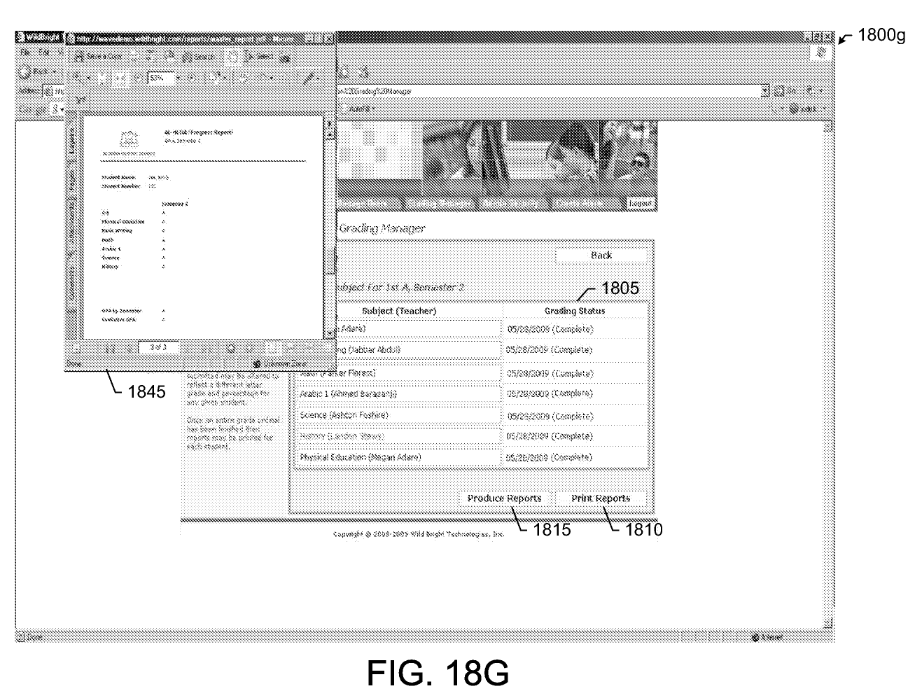

FIG. 18A is a screenshot of a display description 1800a that is presented to an administrator in response to the selection of the Grading Manager tab 580, in one or more embodiments. In the embodiment illustrated in FIG. 18A, the display description 1800a includes a number of controls to enable an administrator operating a client computer 120 to manage grades for a school session. For example, an administrator may view, adjust, and/or finalize students' grades for a session by selecting the session from the displayed list of sessions defined for the member school 105. FIG. 18B is a screenshot of a display description 1800b that is presented to an administrator in response to the selection of a session from the displayed list (e.g., “Semester 2”), in one or more embodiments. The display description 1800b includes a number of controls to manage grades associated with a grade level section for the selected session. In the embodiment illustrated in FIG. 18B, an administrator may view, adjust, and/or finalize students' grades for a grade level section by selecting the grade level section from the displayed list of grade level sections.

FIG. 18C is a screenshot of a display description 1800c that is presented to an administrator in response to the selection of a grade level section from the displayed list (e.g., “1^{st} Grade A”), in one or more embodiments. The display description in 1800c includes a “Grading Status” field 1805 that indicates, for each subject assigned to the selected grade level section, whether or not an administrator has finalized the students' grades. In the embodiment illustrated in FIG. 18, the Grading Status field 1805 indicates that the administrator has not yet finalized the students' grades for any of the subjects assigned to the selected grade level section. The display description 1800c also includes a number of controls to manage students' grades for each subject assigned to the selected grade level section. For example, in the embodiment illustrated in FIG. 18C, an administrator may view, adjust, and/or finalize students' grades for a subject by selecting the subject from the displayed list of subjects assigned to the selected grade level section.

FIG. 18D is a screenshot of a display description 1800d that is presented to an administrator in response to the selection of a subject from the displayed list (e.g., “Physical Education”), in one or more embodiments. The display description 1800d includes a number of controls to view, adjust, and/or finalize students' grades for the selected subject. For example, in the embodiment illustrated in FIG. 18D, the display description 1800d includes an “Admin Adjusted Score” field 1820 and an “Admin Letter Grade” field 1825 that enable an administrator operating a client computer 120 to adjust the score and/or the final grade assigned to a student by the teacher of the selected subject. In the embodiment illustrated in FIG. 18D, the administrator has raised the score and final grade assigned to a student from a 50% to a 70% and from a “D” to a “C-” letter grade, respectively. If an administrator adjusts one or more students' grades, the administrator may save the adjusted grades by selecting the “Save Changes” control 1830. As another example, in the embodiment illustrated in FIG. 18D, the display description 1800d includes a “Commit Grades” control 1835 that enables an administrator operating a client computer 120 to finalize the students' grades for the selected subject. FIG. 18E is a screenshot of a display description 1800e that is presented to an administrator in response to the selection of the Commit Grades control 1835 in display description 1800d. In the embodiment illustrated in FIG. 18E, the grading status field 1805 indicates that the administrator has finalized the students grades for the selected subject (“Physical Education”) illustrated in FIG. 18D.

In some embodiments, an administrator is prevented from committing students' grades for a selected subject. For example, if the shared grade data indicates that a teacher has not yet submitted the grades for administrative review, an administrator may be prevented from adjusting a student's score/grade and/or from finalizing the students' grades for the selected subject. FIG. 18F is a screenshot of a display description 1800f displaying an example grading error message 1840, in one or more embodiments. The grading error message 1840 states that the teacher has not yet submitted the grades for review. As another example, in some embodiments, if an administrator adjusts a student's score and/or final grade beyond a threshold amount, the administrator may be prevented from finalizing at least that student's grade without an additional level of review. Additional levels of review may include, for example, subsequent review and/or agreement by the teacher of that subject, by another teacher of that subject or within the department, by another administrator, and so on. It is noted that, in some embodiments, an administrator may be permitted to finalize students' grades that have not yet been submitted for administrative review. For example, in some embodiments, if the grade submission date for the selected session has elapsed and the teacher of the selected subject has failed to submit their grades, an administrator may adjust and/or finalize the grades. As another example, in some embodiments, an administrator may be permitted to finalize students' grades that have not yet been submitted by a teacher, if one or more students have submitted claims alleging misconduct by the teacher, and the claims have been substantiated and/or the administrator reasonably believes the claims to be true.

FIG. 18G is a screenshot of a display description 1800g presented in response to the selection of the “Print Reports” control 1835, in one or more embodiments. In the embodiment illustrated in FIG. 18G, the printed reports are provided in a Portable Document Format (PDF). In some embodiments, an administrator is prevented from producing and/or printing reports without finalizing the students' grades for each subject assigned to the selected grade level section. For example, in the embodiments illustrated in FIG. 18C and FIG. 18E, the Print Reports control 1810 and the “Produce Reports” control 1815 are grayed out as an indication to the administrator that the controls are inoperable. In some embodiments, an error message is displayed if the students' grades have not been finalized and the administrator selects the Print Reports control 1810 and/or the Produce Reports control 1815. While in other embodiments, an administrator is provided with the option to print and/or produce unofficial reports. For example, if the students' grades have not been finalized, the grade display description 435 presented to an administrator may include one or more controls in place of, or in addition to, controls 1810 and 1815 to print and/or produce unofficial reports.

It is noted that an administrator typically can view, adjust, and/or finalize students' grades and/or produce reports and/or print reports (collectively referred to as “managing” students' grades) at any level of granularity, even though it is not illustrated as such in FIGS. 18A-G. For example, in some embodiments, the holistic academic server 110 provides a grade display description 435 to enable an administrator to manage students' grades for all sections within a grade level (e.g., “2^{nd} Grade A” and “2^{nd} Grade B”) and/or for all grade levels (e.g., K-12). As another example, in some embodiments, the holistic academic server 110 provides a grade display description 435 to enable an administrator to manage students' grades for individual students or a selected group of students, individual subjects or a selected group of subjects (e.g., irrespective of the number of teachers assigned to teach a subject and/or irrespective of the grade levels or grade level sections of the students assigned to take a subject), individual teachers or a selected group of teachers (e.g., irrespective of the number of subjects and/or classes assigned to a teacher), and so on. As such, the description of managing students' grades for a single grade level section (e.g., “1^{st} Grade A”) in FIGS. 18A-G should not be taken as are restrictive.

Returning to FIG. 5A, an administrator operating a client computer 120 creates and/or sends messages to individual users and/or groups of users by selecting, for example, the “Create Alerts” tab 585 to access one or more corresponding message display descriptions 440. The message display descriptions 440 enable an administrator operating a client computer 120 to easily and rapidly communicate with one or more users and/or groups of users associated with the member school 105. In some embodiments, the message display descriptions 440 are used by an administrator to communicate general messages. General messages may include, for example, upcoming parent-teacher conferences, report card dates, fundraisers, and so on. In some embodiments, the message display descriptions 440 are used by an administrator to communicate critical messages. Critical member school messages may include, for example, weather hazards and/or member school closures, incidents of crime near or at a member school, and so on. Typically, message display descriptions 440 enable an administrator to communicate with users via one or more selected communication channels including, for example, e-mail, SMS text messages, instant messages (IM), voice messages, and so on. In some embodiments, the communication channels are preselected. For example, the communication channels for a user may be preselected based on the user's profile data provided by an administrator or user in the course of managing the user's profile, expressly specified by the user outside of the course of managing the user's profile, and so on.

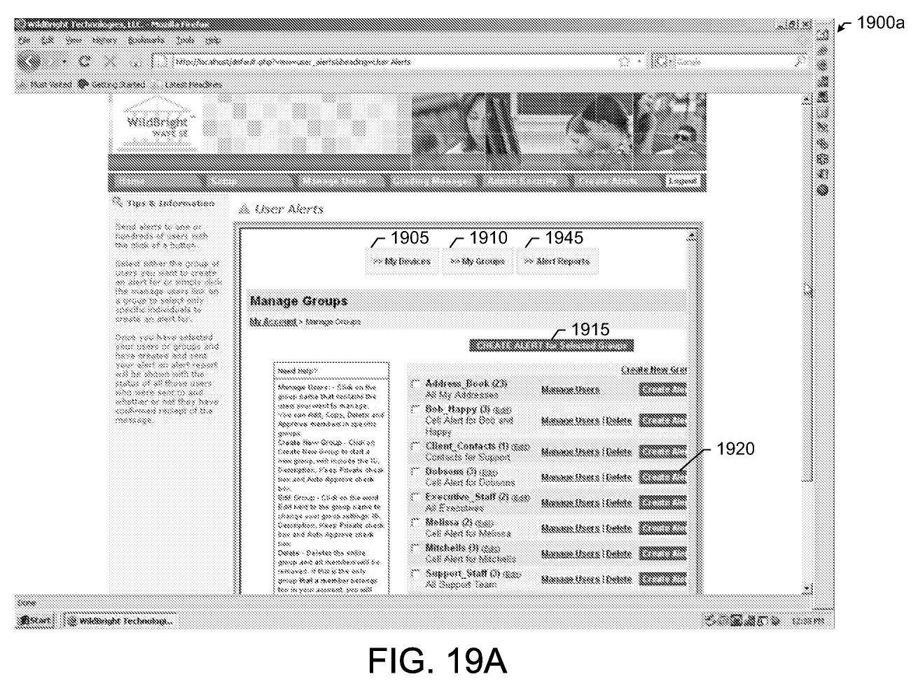

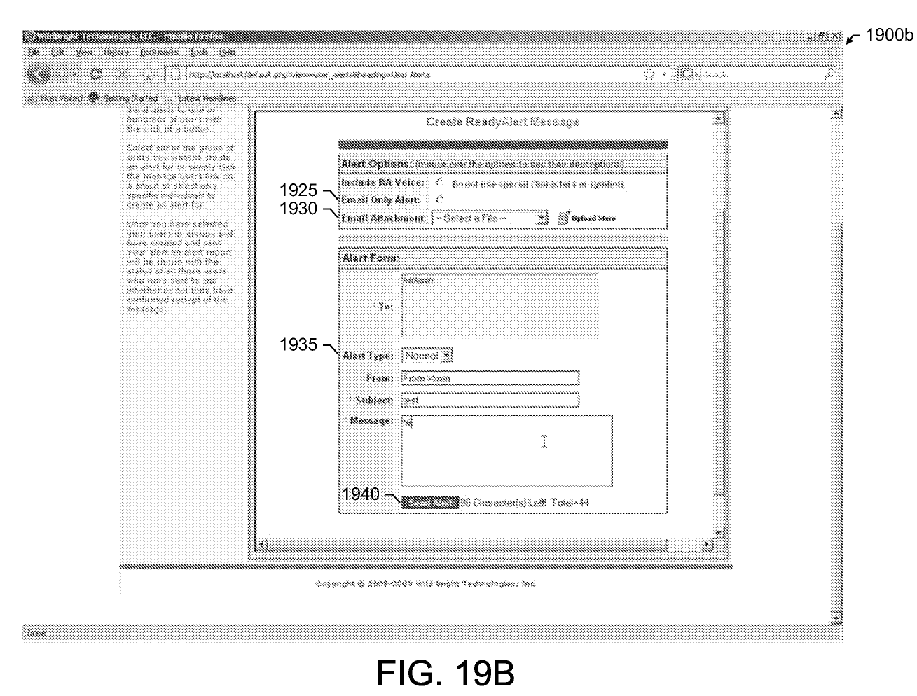

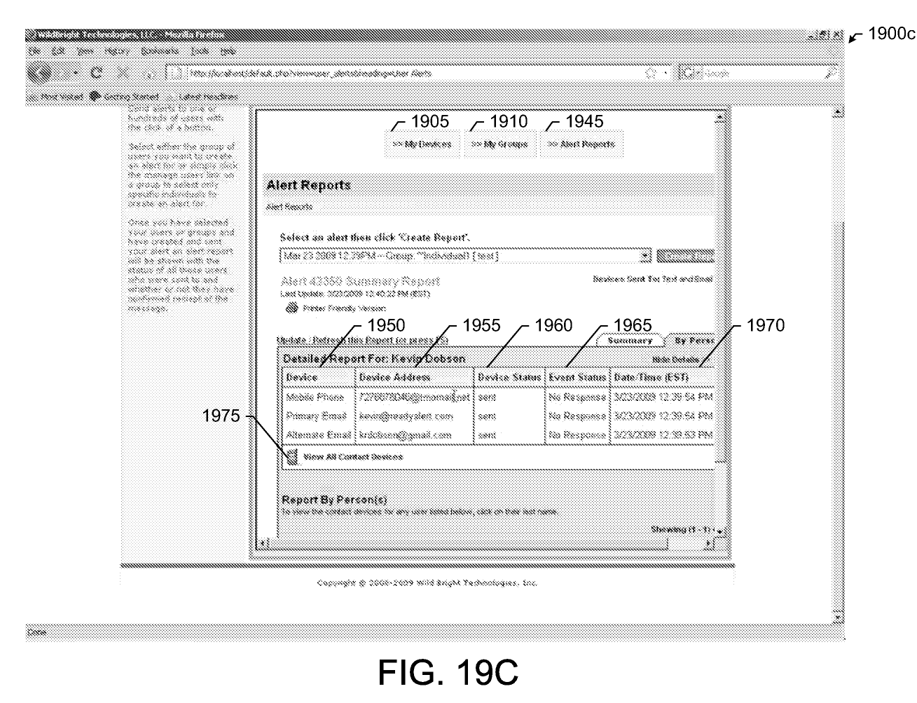

FIG. 19A is a screenshot of a display description 1900a that is presented to an administrator in response to the selection of the User Alerts tab 585, in one or more embodiments. The display description 1900a includes a number of controls to enable an administrator operating a client computer 120 to manage the ways in which the administrator receives messages from, for example, other administrators of a member school. For example, in the embodiment illustrated in FIG. 19A, the display description 1900a includes a “My Devices” control 1905 to manage the devices at which an administrator receives messages. As another example, in the embodiment illustrated in FIG. 19A, the display description in 1900a includes a “My Groups” control 1910 to manage the groups of users to which an administrator belongs. In some embodiments, the holistic academic server 110 automatically includes an administrator as a recipient of messages directed to particular groups based on the administrators role within a member school. For example, if the user profile of an administrator indicates that the administrator is responsible for fire safety training and prevention at the member school 105, then the holistic academic server 110 may automatically include the administrator in a “School Safety Group” to which messages are directed if a school safety issue arises near or at the member school.

In the embodiment illustrated in FIG. 19A, the display description 1900a also includes a number of controls to enable an administrator operating a client computer 120 to create and/or manage user alerts sent by the administrator to other users of a member school. In the embodiment illustrated in FIG. 19A, an administrator creates a message directed to one or more groups of users by selecting the “Create Alert” control corresponding to a group of users or by selecting the groups of users and then selecting the “Create Alerts for Selected Groups” control 1915. It is noted that a group of users may include a single user for which one or more communication channels are defined. For example the group of users corresponding to the Create Alert control 1920 includes a single user (i.e., “Kevin Dobson”) for which three channels of communication has been defined.

FIG. 19B is a screenshot of a display description 1900b that is presented to an administrator operating a client computer 120 in response to the selection of the Create Alert control 1920 corresponding to a selected user group, in one or more embodiments. The display description 1900b includes a number of controls to enable an administrator to create a message directed to the selected user group. For example, in the embodiment illustrated in FIG. 19B, the display description 1900b includes an “E-Mail Only Alert” control 1925 that enables an administrator to limit the communication channels on which the message is received. As another example, in the embodiment illustrated in FIG. 19B, the display description 1900b includes an “E-Mail Attachment” control 1930 that enables an administrator to attach a file to a message. As yet another example, in the embodiment illustrated in FIG. 19B, the display description 1900b includes an “Alert Type” control 1935 that enables an administrator to indicate the importance of the message (e.g., general, critical, etc.). After an administrator creates a message, the administrator sends the message by selecting the “Send Alert” control 1940.

Returning to FIG. 19A, an administrator may manage the messages sent by the administrator by selecting the “Alert Reports” control 1945. FIG. 19C is a screenshot of a display description 1900c that is presented to an administrator operating a client computer 120 in response to a selection of the Alert Reports control 1945. The display description 1900c includes a number of controls to enable an administrator to track a message. For example, in the embodiment illustrated in FIG. 19C, the display description 1900c includes a “Device” field 1950, a “Device Address” field 1955, a “Device Status” field 1960, an “Event Status” field 1965, and a “Date/Time” field 1970. The Device field 1950 and the Device Address field 1955 identify the format(s) of the message and communication channel(s) on which the message was sent. The Device Status field 1960 and the Date/Time field 1970 indicate whether the message has been sent and, if so, the date and time at which the message was sent. The Event Status field 1965 indicates whether the recipient of the message has responded. In some embodiments, an administrator selects the “View All Contact Devices” control 1975 to identify other devices and/or communication channels on which the administrator may reach the recipient of the message. For example, the View All Contact Devices control 1975 may identify other devices and/or communication channels based on the recipient user's profile associated with the member school. In some embodiments, the message display descriptions 440 are implemented by the holistic academic server 110. While in other embodiments, the display descriptions 440 are implemented by another computer system that is not operated or controlled by a member school and/or the operator of the holistic academic system 100.

Returning to FIG. 4, in some embodiments, one or more of the display descriptions 420-440 are available to users of a member school whose perspectives differs from that of an administrator. For example, in the embodiment illustrated in FIG. 4, the teacher perspective 405 includes profile management display descriptions 420, schedule display descriptions 430, and grade display descriptions 435. Typically, however, the teachers perspective 405 of certain display descriptions 420-435 has an increased level of granularity than that of the administrator perspective 400 of the same display descriptions 420-435. As introduced herein, the term “perspective” refers to a user's view of shared data, including the level or type of information viewable by the user, the layout of the information, and/or the interfaces available to the user. In general, the level of granularity refers to the specificity of the shared data and/or the display descriptions presented to a user. That is, the more granular a perspective of a display description is, the more specific the shared data, layout, and/or interfaces are to the user.

The teacher perspective 405 of profile management display descriptions 420 has a high level of granularity than that of the administrator perspective 400. For example, while administrators typically can create, view, edit, archive, and/or delete user profiles of various types of users associated with a member school, teachers typically have access to their personal profile and possibly may view profiles of their students and/or their students' parents. In some embodiments, the profile management display descriptions 420 include a directory display description that may be used to search for profiles of users associated with the member school. For example, a teacher may use the directory display description to lookup other teachers' profiles, administrators' profiles, students' profiles, and/or parents' profiles. In some embodiments, the directory display description is available at the same or a similar level of granularity to other types of users associated with the member school (e.g., a parent may use the directory display description to lookup other parents' profiles, and so on). In some embodiments, the teacher perspective 405 includes display descriptions that differ from those available to administrators, parents, and/or students.

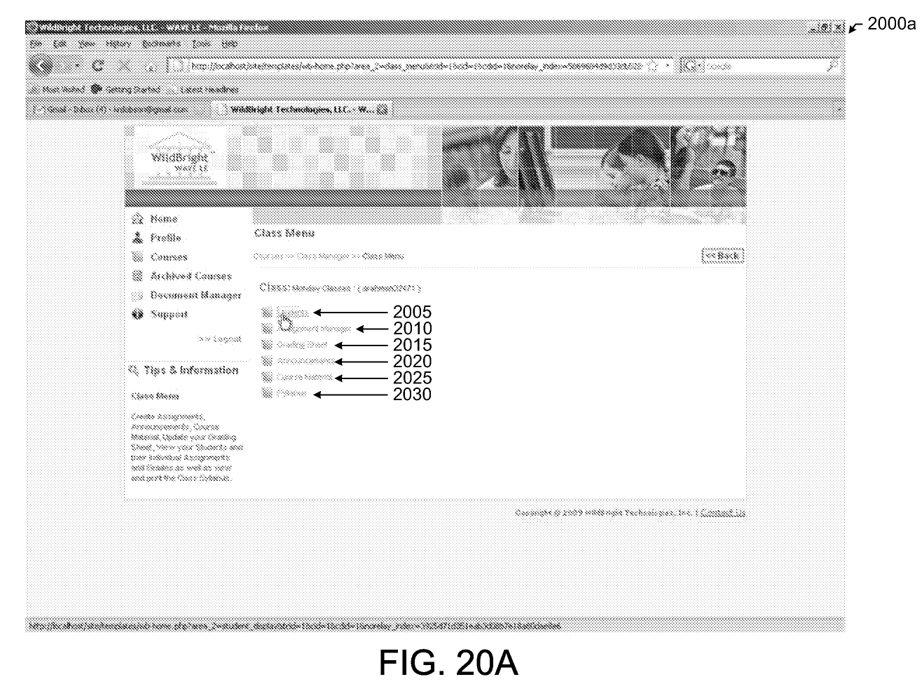

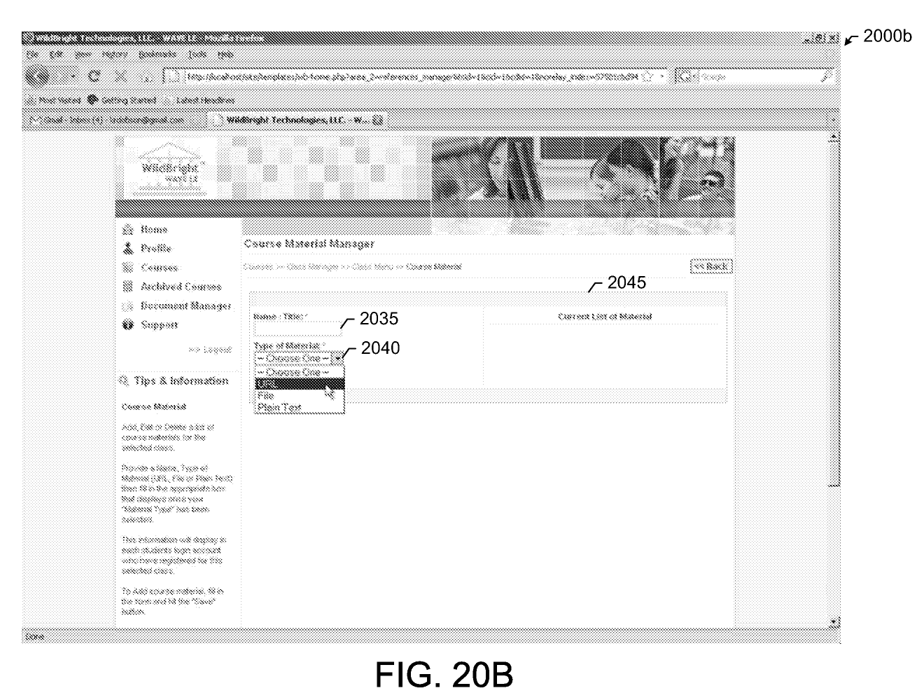

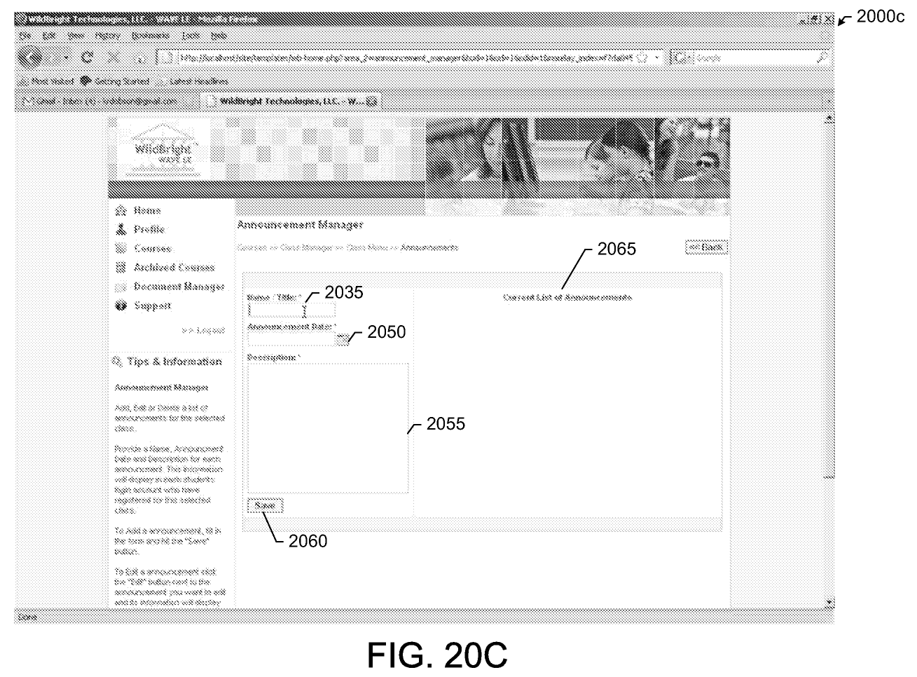

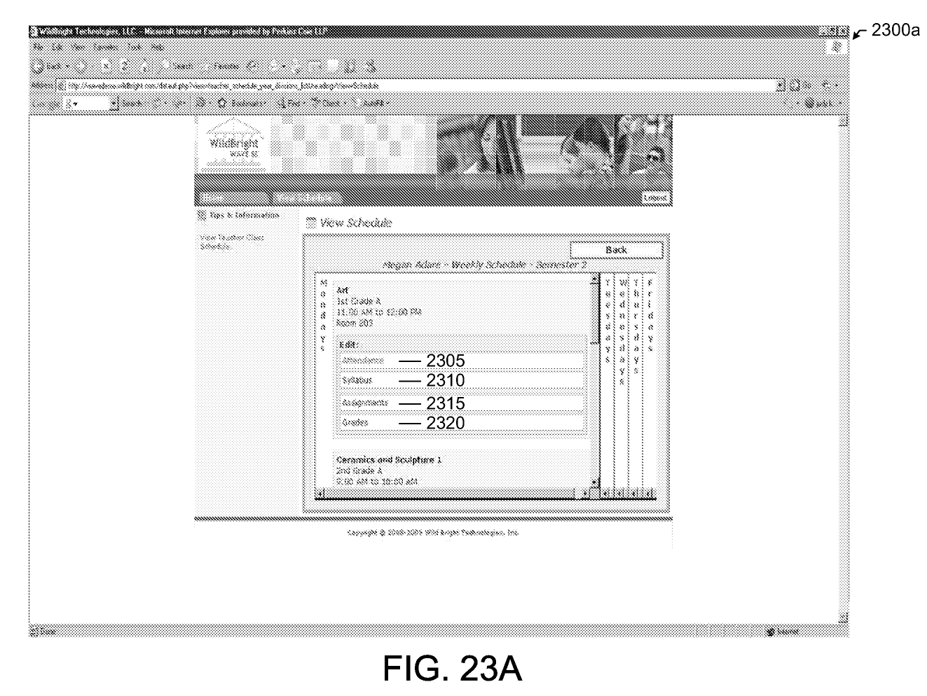

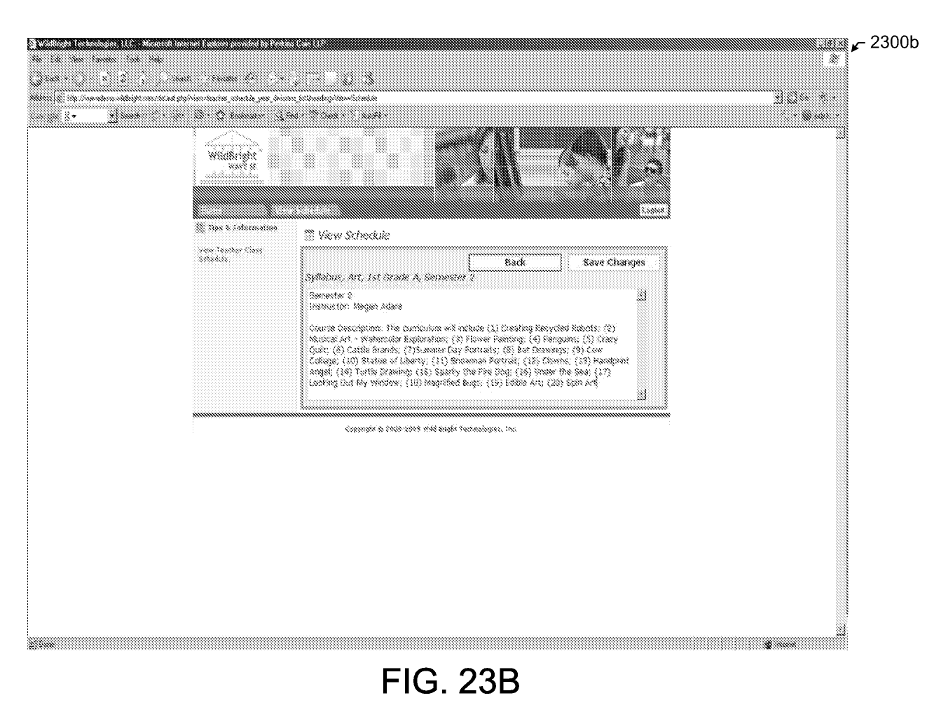

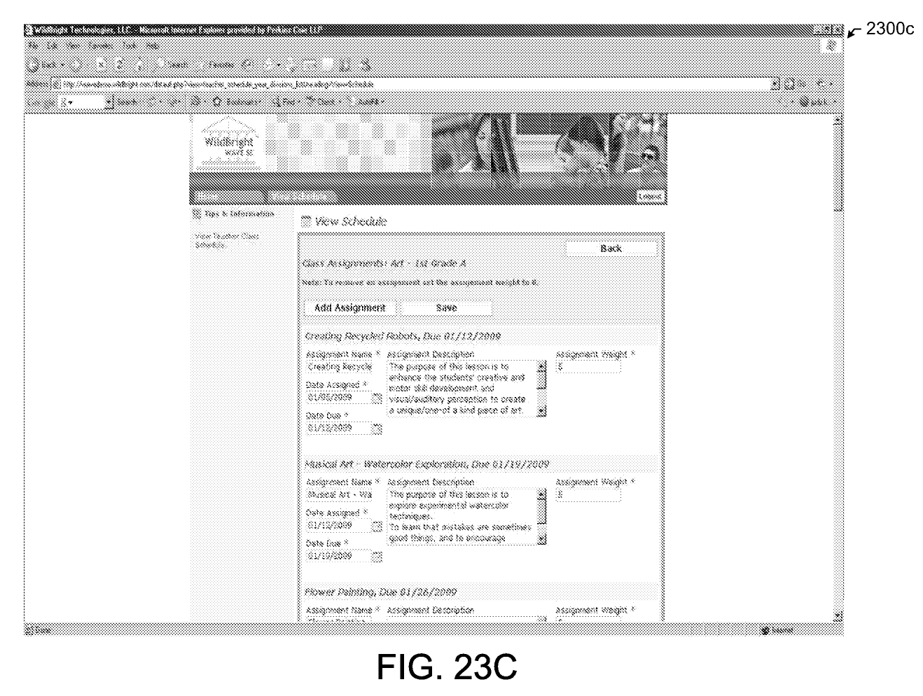

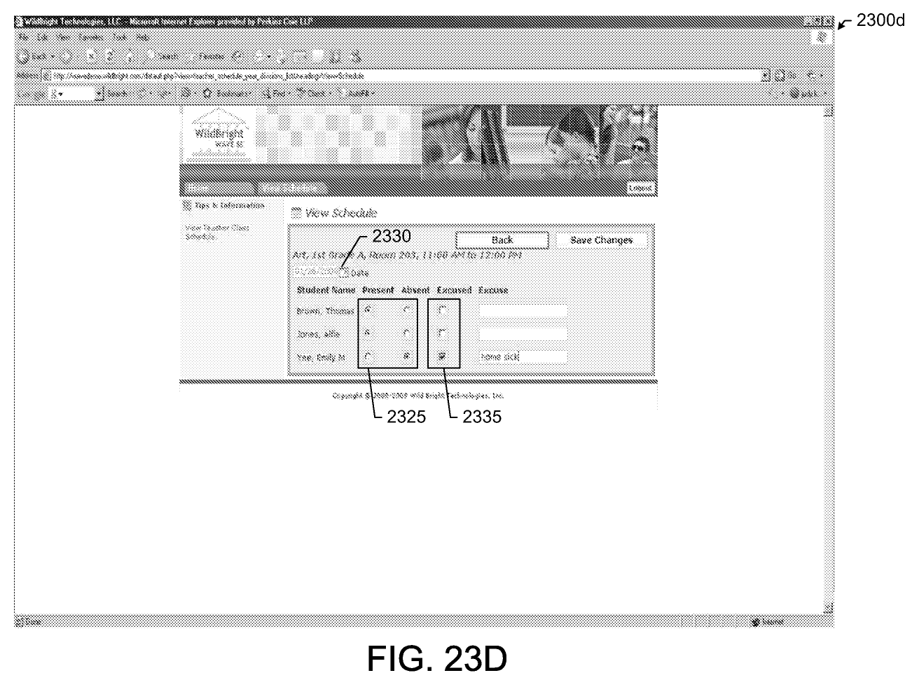

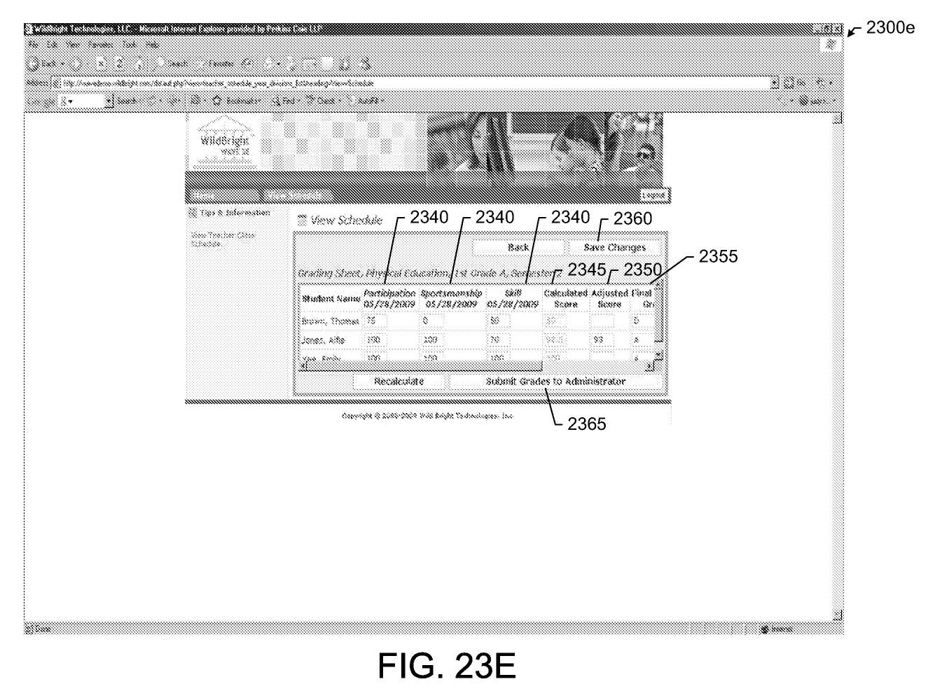

Typically, if a user operating a client computer 120 is authenticated as a teacher, the holistic academic server 110 sends a default teacher display description or a user-specified display description to the client computer 120 for display to the user. For example, the default display description may include a number of interfaces to access display descriptions 420-435 and 445-450. For example, FIG. 20A is a screenshot of a default display description 2000a that includes a number of controls (e.g., links, buttons, tabs, etc.) available to a teacher to access course management display descriptions 445, in one or more embodiments. As another example, FIG. 23A is a screenshot of a default display description 2300a that includes a number of controls available to a teacher to access schedule display descriptions 430, in one or more embodiments.

In the embodiment illustrated in FIG. 20A, a teacher operating a client computer 120 manages shared data associated with a teacher's classes by selecting, for example, one or more of controls 2005-2030 and/or other displayed controls. For example, a teacher operating a client computer 120 may select the “Course Material” control 2025 to manage course materials associated with a class. FIG. 20B is a screenshot of a display description 2000b that is presented to a teacher in response to the selection of the Course Material control 2025, in one or more embodiments. The display description 2000b includes a number of controls to enable a teacher to manage course materials associated with a class. For example, in the embodiment illustrated in FIG. 20B, the display description 2000b includes a “Name/Title” control 2035 that a teacher selects to name newly added course material. As another example, in the embodiment illustrated in FIG. 20B, the display description 2000b includes a “Type of Material” control 2040 that the teacher selects to designate the type of newly added course material. As yet another example, in the embodiment illustrated in FIG. 20B, the display description 2000b includes a “Current List of Material” display description 2045 that identifies the course materials, if any, provided by the teacher for the class. In some embodiments, the display description 2000b and/or the Current List of Material display description 2045 includes a number of controls (not shown) to view, edit, archive, and/or delete course materials identified in the Current List of Material display description 2045.

In the embodiment illustrated in FIG. 20A, a teacher operating a client computer 120 may select the “Announcement Manager” control 2010 to manage announcements associated with a class. FIG. 20C is a screenshot of a display description 2000c that is presented to a teacher in response to the selection of the Announcement Manager control 2010, in one or more embodiments. The display description 2000c includes a number of controls to enable a teacher to manage announcements associated with a class. For example, in the embodiment illustrated in FIG. 20C, the display description 2000c includes a “Name/Title” control 2035 that a teacher selects to enter a name for name an announcement. As another example, the display description 2000c includes a “Announcement Date” control 2050 that a teacher selects to indicate the date on which an announcement was posted. As yet another example, the display description 2000c includes a “Description” control 2055 in which a teacher enters an announcement. In the embodiment illustrated in FIG. 20C, the display description 2000c includes a “Save” control 2060 that a teacher selects to add an announcement to the “Current List of Announcements” display description 2065. In some embodiments, the display description 2000c and/or the Current List of Announcements display description 2065 includes a number of controls (not shown) to view, edit, archive, and/or delete announcements listed in the Current List of Announcements display description 2065.

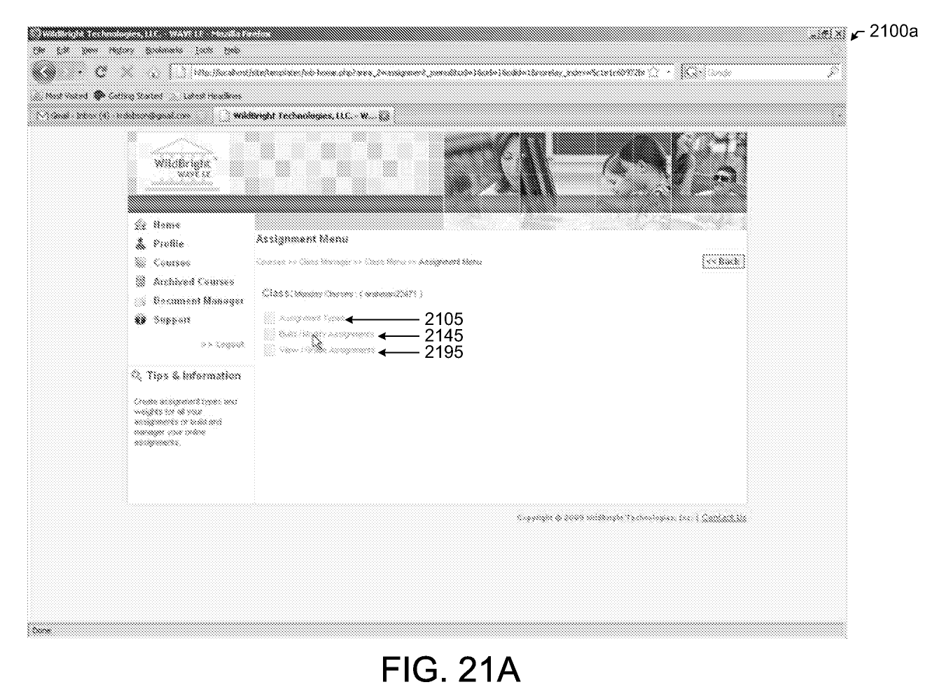

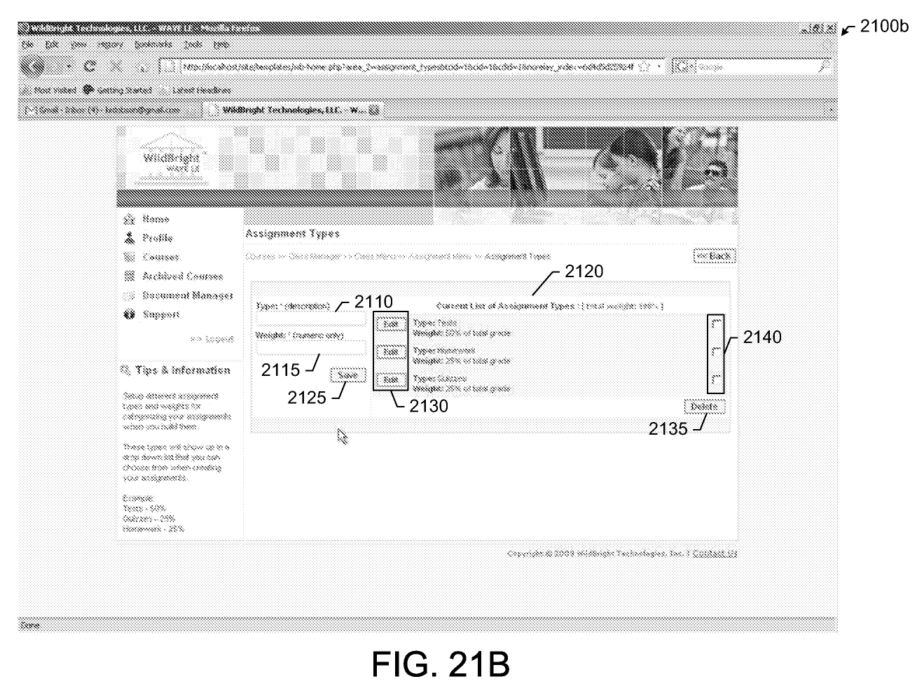

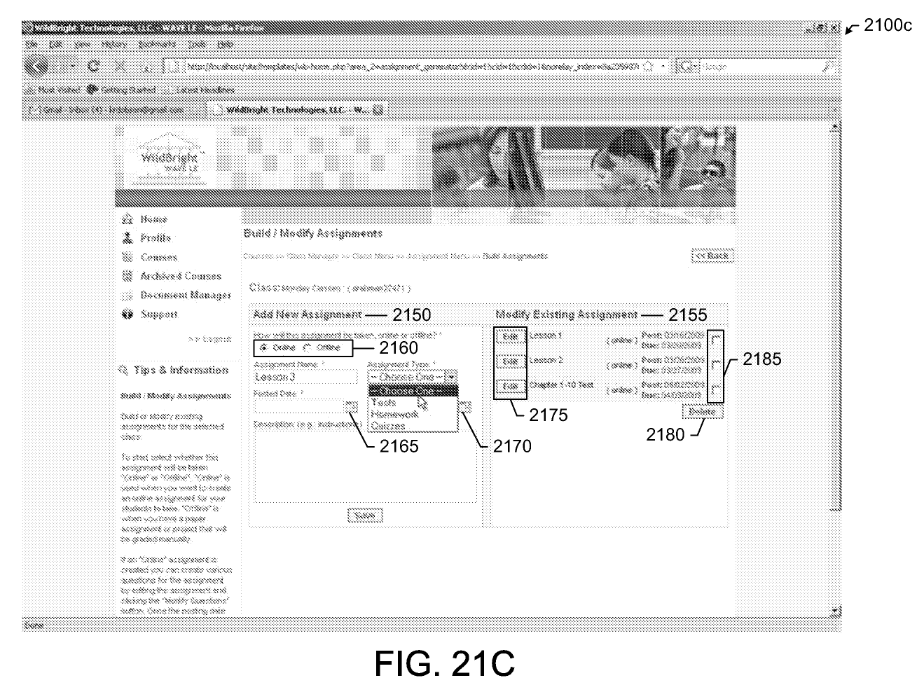

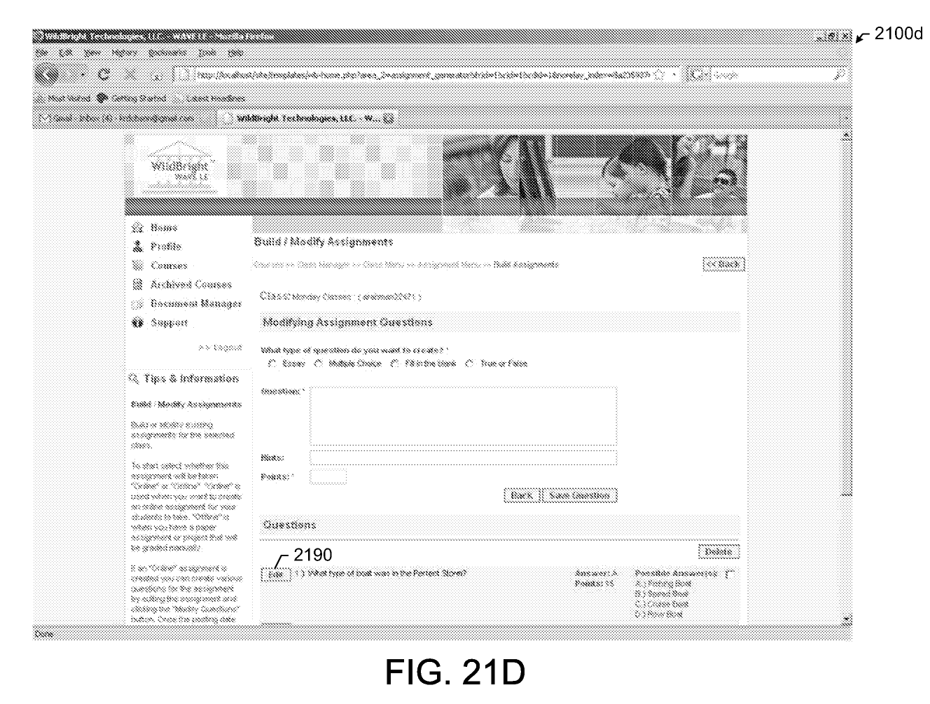

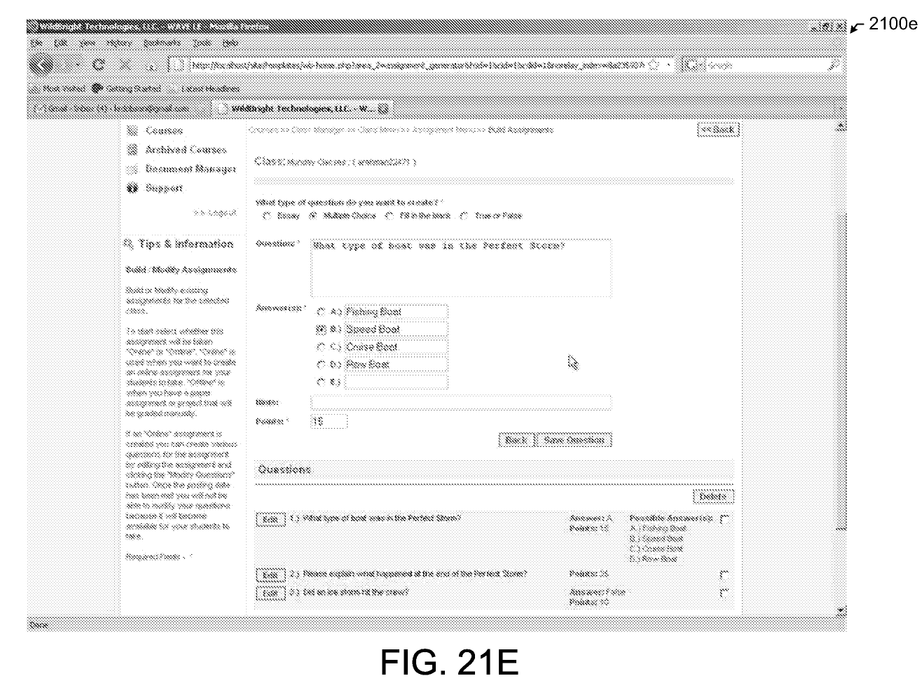

In the embodiment illustrated in FIG. 20A, a teacher operating a client computer 120 may select the “Assignment Manager” control 2010 to manage assignments associated with a class. FIG. 21A is a screenshot of a display description 2100a that is presented to a teacher in response to the selection of the Assignment Manager control 2010, in one or more embodiments. The display description 2100a includes a number of controls to enable a teacher to manage assignments associated with a class. For example, in the embodiment illustrated in FIG. 21A, the display description 2100a an “Assignment Types” control 2105 to enable a teacher to define one or more types of assignments for a class. FIG. 21B is a screenshot of a display description 2100b that is presented to a teacher in response to the selection of the Assignment Types control 2105, in one or more embodiments. The display description 2100b includes a number of controls to enable a teacher to define one or more types of assignments for a class. For example, in the embodiment illustrated in FIG. 21B, the display description 2100b includes a “Types” control 2110 to define a new type of assignment and a “Weight” control 2115 to assign a weight to the new type of assignment. In the embodiment illustrated in FIG. 21B, a display description 2100b includes a “Current List of Assignment Types” display description 2120 to which a new type of assignment is added if a teacher selects the “Save” control 2125. In the embodiment illustrated in FIG. 21B, the Current List of Assignment Types display description 2120 includes three defined types of assignments: “Tests” (assigned 50% of the total weight), “Homework” (assigned 25% of the total weight), and “Quizzes” (assigned 25% of the total weight). In some embodiments, if a teacher at a new assignment type that causes the total weight to exceed 100%, an error a message and/or display description is displayed to the teacher so that the teacher may adjust the weightings assigned to each type of assignment. In the embodiment illustrated in FIG. 21B, the Current List of Assignment Types display description 2120 includes “Edit” controls 2130, each corresponding to a defined assignment type, which a teacher may select to edit one or more of the defined assignment types (e.g., the type and/or weight assigned to an assignment type). In the embodiment illustrated in FIG. 21B, the Current List of Assignment Types display description 2120 includes a “Delete” control 2135 and controls 2140, each corresponding to a defined assignment type, which a teacher may select to delete one or more of the defined assignment types.

In the embodiment illustrated in FIG. 21A, the display description 2100a includes a “Build/Modify Assignments” control 2145 to enable a teacher operating a client computer 120 to manage assignments for a class. FIG. 21C is a screenshot of a display description 2100c that is presented to a teacher in response to the selection of the Build/Modify Assignments control 2145, in one or more embodiments. The display description 2100c includes a “Add New Assignment” display description 2150 and a “Modify Existing Assignment” display description 2155. In the embodiment illustrated in FIG. 21C, the display description 2150 includes a control 2160 that a teacher selects to indicate whether a newly added assignment is to be taken online or off-line. In some embodiments, assignments taken online may include a timer. The display description 2150 includes an “Assignment Type” control 2165 that a teacher selects to indicate the assignment type of a newly added assignment. By indicating an assignment type for an assignment, the assignment may be automatically weighted as defined by the teacher. A teacher may select the date on which a new assignment becomes available to students by selecting the “Posted Date” control 2165. A teacher may select a date on which a new assignment is due by selecting the “Due Date” control 2170.

In the embodiment illustrated in FIG. 21C, the display description 2155 includes “Edit” controls 2175 corresponding to each existing assignment associated with a class, and includes a “Delete” control 2180 and controls 2185, each corresponding to an existing assignment, which a teacher may select to delete one or more of the existing assignment. FIG. 21D is a screenshot of a display description 2100d that is presented to a teacher in response to the selection of an Edit control 2175, in one or more embodiments. The display description 2100d includes a number of controls to edit an existing assignment, for example by adding new questions and/or editing or deleting existing questions. For example, a teacher may select “Edit” control 2190 to edit “Question 1” of the existing assignment. FIG. 21E is a display description 2100e that is presented to a teacher in response to the selection of Edit control 2190. A display description 2100e includes a number of controls to edit the selected question. For example, a teacher may edit the type of the question (e.g., essay, multiple choice, fill the blank, true or false, etc.), the text of the question, the answer, whether or not hints are provided, the points allotted to the question, and so on.

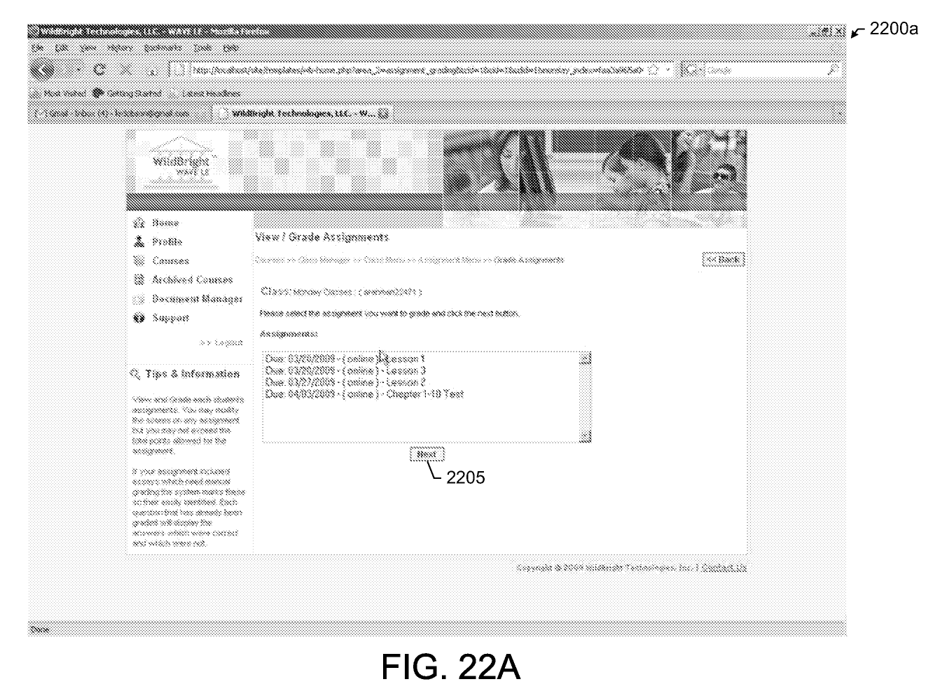

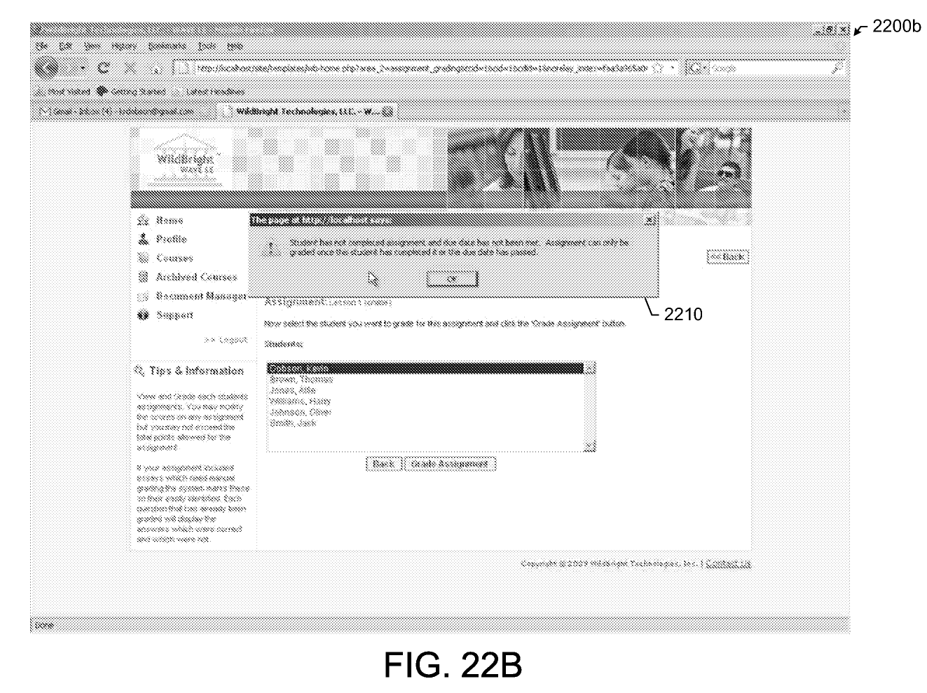

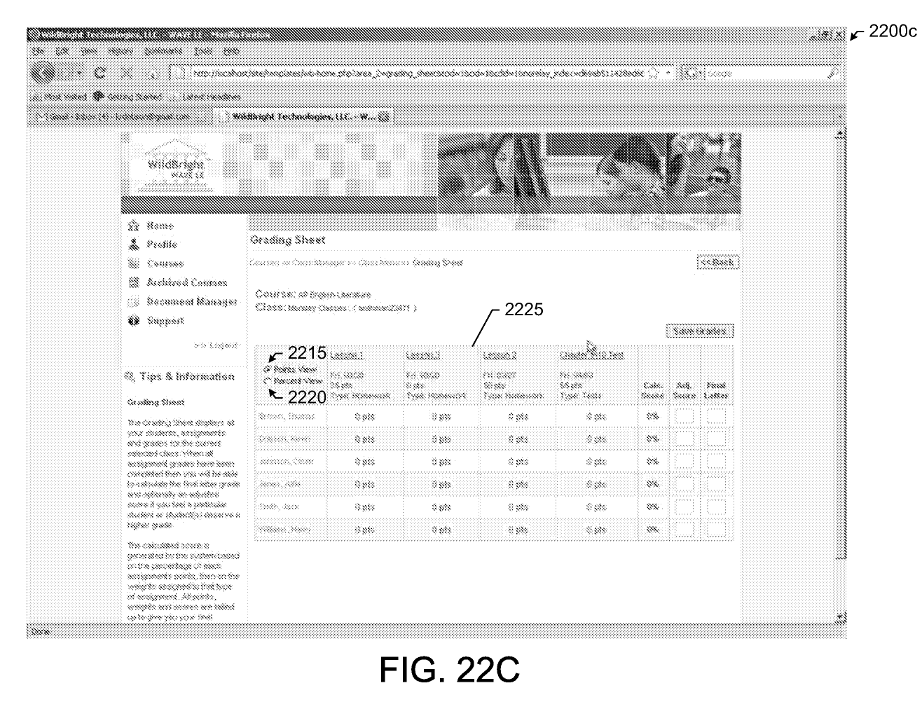

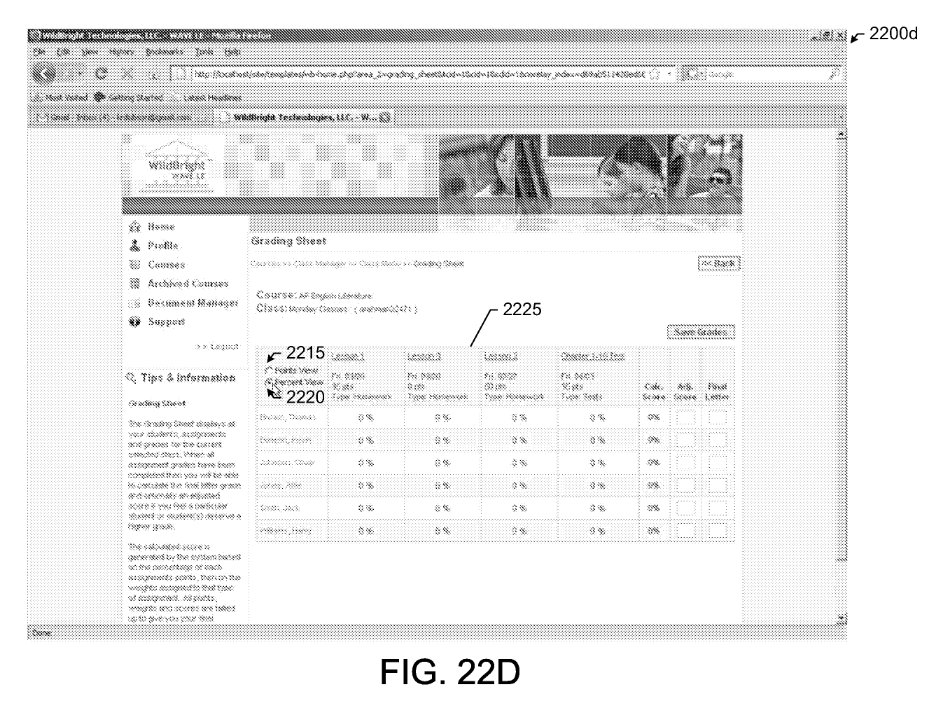

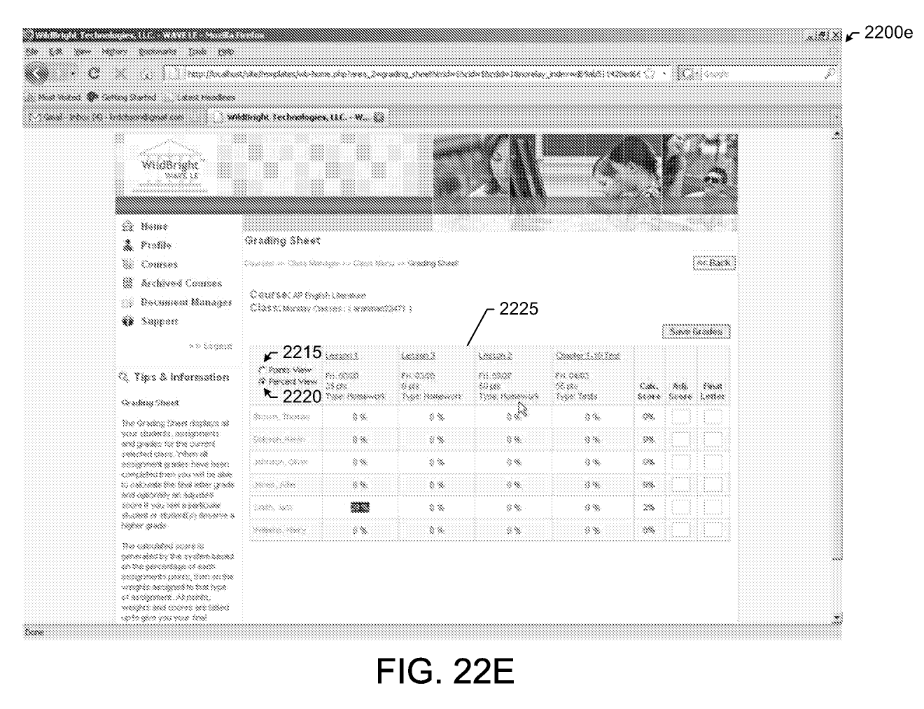

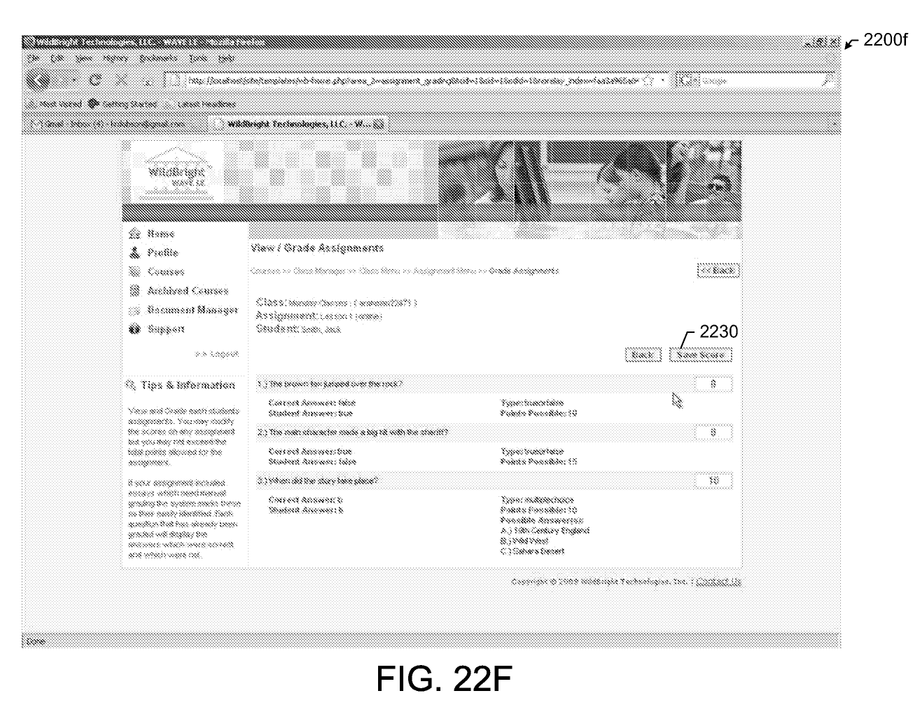

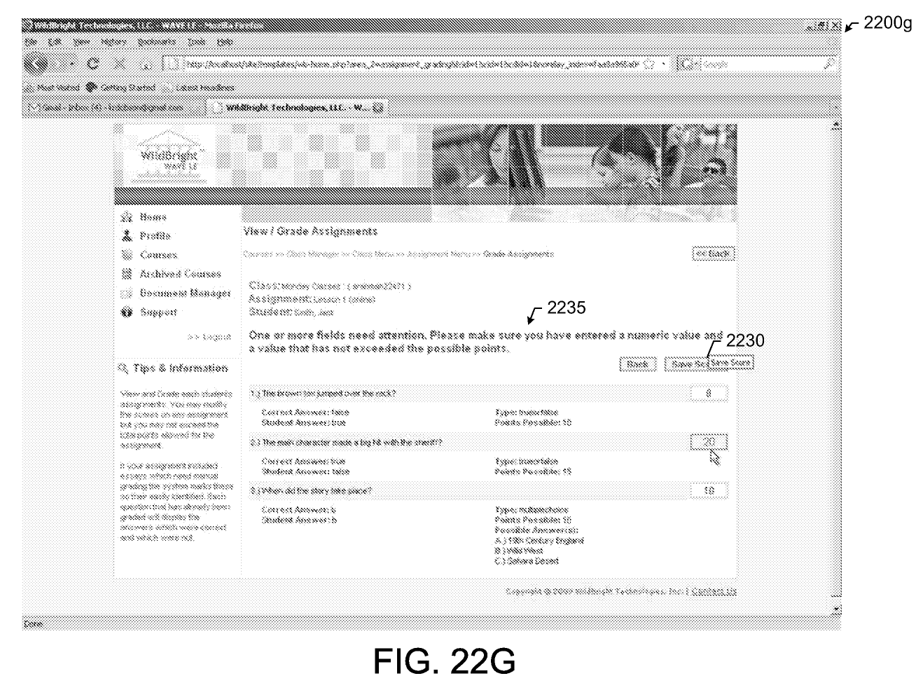

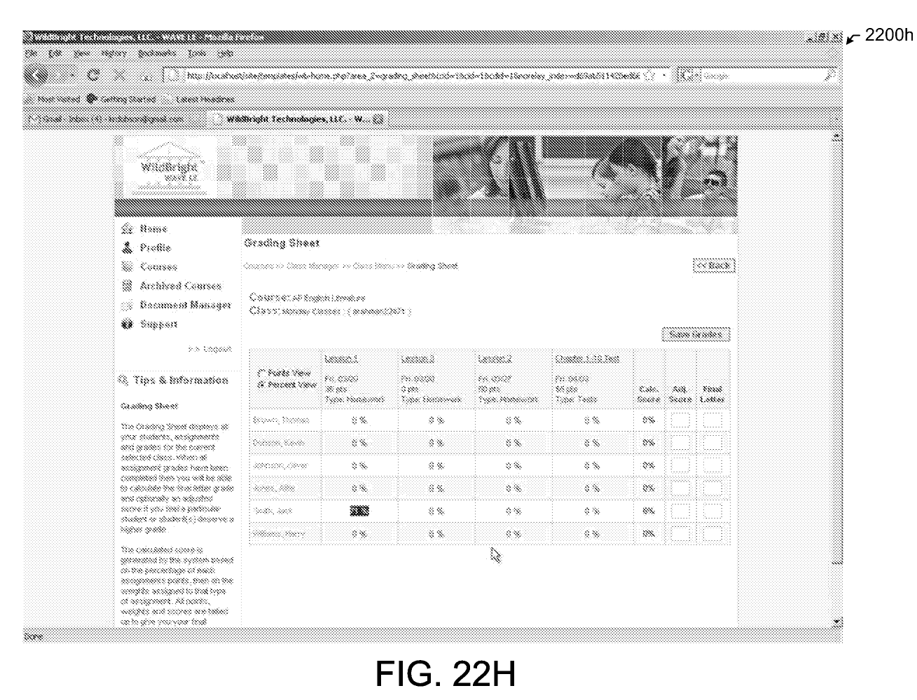

In the embodiment illustrated in FIG. 21A, the display description 2100a includes a “View/Grade Assignments” control 2195 that a teacher selects to manage completed assignments. In the embodiment illustrated in FIG. 20A, the display description 2000a includes a “Grading Sheet” control 2015 that a teacher selects to manage completed assignments. In some embodiments, the View/Grade Assignments control 2195 and the Grading Sheet control 2015 present the same grade display descriptions 435 when selected by a teacher. While in other embodiments, the View/Grade Assignments control 2195 and the Grading Sheet control 2015 present different grade display descriptions 435 when selected by a teacher. For example, FIG. 22A is a screenshot of a display description 2200a that is presented to a teacher in response to these selection of the View/Grade Assignments control 2195, in one or more embodiments. The display description 2200a includes one or more controls that a teacher selects to view and/or a grade completed assignments. For example, in the embodiment illustrated in FIG. 22A, a teacher may select one or more assignments and then select the “Next” control 2205 to view and/or grade completed assignments corresponding to the one or more selected assignments. FIG. 22B is a screenshot of a display description 2200b displaying an error message 2210 that is presented to a teacher in response to a request to view and/or grade an assignment that has not yet been completed by a selected student and for which the due date has not yet elapsed.

FIG. 22C is a screenshot of a display description 2200c that is presented to a teacher in response to the selection of the Grading Sheet control 2015, in one or more embodiments. The display description 2200c includes one or more controls to enable a teacher to view, adjust, submit, and/or finalize students' grades for a selected class. In the embodiment illustrated in FIG. 22C, the display description 2200c includes a “Points View” control 2215 and a “Percent View” control 2220 that a teacher selects to modify the view of the grade display description 2225. In the embodiment illustrated in FIG. 22C, the Points View control 2215 is selected. As a result, the display description 2200c displays, for each student, the points achieved by the student for each corresponding assignment. While in the embodiment illustrated in FIG. 22D, the Percent View control 2220 is selected. As a result, the display description 2200d displays, for each student, the percentage score achieved by the student for each corresponding assignment.

FIG. 22E is a screenshot of a display description 2200e that indicates a student has completed an assignment, in one or more embodiments. For example, in the embodiment illustrated in FIG. 22E, student Jack Smith has completed Lesson 1 and has achieved a score of 29%. In the embodiment illustrated in FIG. 22E, a teacher views and/or grades a student's completed assignment by selecting the assignment from the grade display description 2225. FIG. 22F is a screenshot of a display description 2200f that is presented to a teacher in response to a request to view and/or grade a assignment completed by a student (i.e., “Jack Smith”), in one or more embodiments. The display description 2200f includes a number of controls to adjust the points and/or score achieved by a student. For example, in the embodiment illustrated in FIG. 22F, if the teacher determines that an answer assigned to a question is incorrect, the teacher may adjust the points achieved by the student for that question and update the student's grade by selecting the “Save Score” control 2230. In some embodiments, the holistic academic system compares the number of adjusted points to the total number of possible points allotted to the question to ensure that the teacher does not inadvertently entered a greater number than the total number of possible points allotted to the question. FIG. 22G is a screenshot of a display description 2200g displaying an error message 2235 indicating that the teacher entered a value that exceeded the possible points. For example, in the embodiment illustrated in FIG. 22G, the error message 2235 is presented to the teacher because the teacher attempted to adjust the students score to 20 points when only 15 points were allotted to the question. In the embodiment illustrated in FIG. 22G, a teacher may correct his or her mistake by entering a number of points that is within the allotted points range, and then selecting the Save Score control 2230. FIG. 22H is a screenshot of a display description 2200h that is presented to a teacher in response to a valid request to adjust a student's score for a completed assignment. In the embodiment illustrated in FIG. 22H, the grade display description 2225 is automatically updated based on the adjusted score (e.g., Jack Smith's score increased from 29% to 71%).

In some embodiments, one or more of profile management display descriptions 420, grade display descriptions 435, course management display descriptions 445, and/or attendance display descriptions 450 are available to a teacher via a schedule display description 430 that provides a common interface perspective to two or more types of users (e.g., teachers, administrators, students, and/or students' parents). FIG. 23A is a screenshot of a display description 2300a that includes the common interface perspective. In the embodiment illustrated in FIG. 23A, a teacher operating a client computer 120 manages shared data associated with the teachers classes by selecting, for example, one or more of controls 2305-2320 to access corresponding grade display descriptions 435, course management display descriptions 445, and attendance display descriptions 450. For example, in the embodiment illustrated in FIG. 23A, a teacher operating a client computer 120 selects the “Syllabus” control 2310 to manage a syllabus corresponding to the selected class (e.g., “Art—1^{st} Grade A”). FIG. 23B is a screenshot of a display description 2300b that is presented to a teacher in response to the selection on of the Syllabus control 2310, in one or more embodiments. As display description 2300b includes a number of controls to enable a teacher to create, view, edit, and/or delete a syllabus.

In the embodiment illustrated in FIG. 23A, a teacher operating a client computer 120 selects the “Assignments” control 2315 to manage one or more assignments corresponding to the selected class. FIG. 23C is a screenshot of a display description 2300c that is presented to a teacher in response to the selection of the Assignments control 2315, in one or more embodiments. The display description 2300c includes a number of controls to enable a teacher to build, view, modify, and/or delete one or more assignments.

In the embodiment illustrated in FIG. 23A, a teacher operating a client computer 120 selects the “Attendance” control 2305 to manage the attendance of one or more students in the selected class. FIG. 23D is a screenshot of a display description 2300d that is presented to a teacher in response to the selection of the Attendance control 2305, in one or more embodiments. The display description 2300d includes a number of controls to enable a teacher to track students' attendance for a selected class. For example, in the embodiment illustrated in FIG. 23D, the display description 2300d includes controls 2325 (e.g., radiobox controls) that a teacher selects to indicate whether or not a corresponding student was absent on a selected date 2330. As another example, in the embodiment illustrated in FIG. 23D, the display description 2300 includes controls 2335 (e.g., checkbox controls) at a teacher selects to indicate when a corresponding student's absence is excused.

In the embodiment illustrated in FIG. 23A, a teacher operating a client computer 120 selects the “Grades” control 2320 to manage the grades of one or more students in the selected class. FIG. 23E is a screenshot of a display description 2300e that is presented to a teacher in response to the selection of the Grades control 2320, in one or more embodiments. The display description 2300e includes a number of controls to enable a teacher to enter students grades for a selected class (e.g., “Physical Education—1^{st} Grade A”). For example, in the embodiment illustrated in FIG. 23E, the display description 2300e includes fields 2340 each corresponding to each of the components of the students' grades (e.g., assignments, participation, etc.), a “Calculated Score” field 2345 that includes a composite score for each student across each field 2340, an “Adjusted Score” field 2350 in which a teacher may enter an adjusted score for one or more of the students, and a “Final Grade” field 2355 that is automatically calculated and/or edited by the teacher. For example, the holistic academic server 110 may automatically calculate a Final Grade for each student based on the shared data associated with the member school. Such information may include, for example, one or more defined percentile ranges corresponding to various letter grades. In the embodiment illustrated in FIG. 23E, if a teacher enters or modifies a student's grades, the teacher saves the updated shared data by selecting the “Save Changes” control 2360. If a teacher has finalized a student's grades, in the embodiment illustrated in FIG. 23E, the teacher may submit the grades for administrative review by selecting the “Submit Grades to Administrator” control 2365. For example, as discussed herein in connection with FIG. 18F, an administrator typically cannot finalize grades until they have been submitted for administrative review by the teacher.

It is noted that the granularity of a teacher's perspective is typically dependent on the teacher's role within the member school. For example, in some embodiments, the same grade display description 435 is available to teachers and administrators; however, the user's perspective of the display description defines the level of granularity and/or type of information, the layout, and/or the interfaces available to the user. FIG. 23E and FIG. 18D illustrate the same grade display description for 435 from different perspectives. That is, FIG. 23E illustrates the grade display description from the perspective of a teacher, while FIG. 18D illustrates the grade display description from the perspective of an administrator. As a result, in the illustrated embodiments, different controls are available to the users. For example, the teacher can view and edit each of fields 2340, 2350, and 2355, while the same fields are presented to the administrator in a view-only state. As another example, the teacher's perspective includes a Submit Grades to Administrator control 2365 that is not provided by the administrator's perspective, and the administrator's perspective includes a Commit Grades control 1835 that is not provided by the teacher's perspective.

Returning to FIG. 4, in some embodiments, one or more of the display descriptions 420-450 are available to users of a member school whose perspectives differ from those of an administrator and/or teacher. For example, in the embodiment illustrated in FIG. 4, the parent perspective 410 includes profile management display descriptions 420, schedule display descriptions 430, grade display descriptions 435, course management display descriptions 445, and attendance display descriptions 450. Typically, the level of granularity of the parent perspective 410 of display descriptions 420, 430-435, and 445-450 is increased from that of the administrator perspective 400 and/or the teacher perspective 405 for the same display descriptions. That is, the parent perspective 410 provides a much more specific viewpoint of the shared data associated with the member school.

In some embodiments, a parent perspective 410 includes a common schedule display description 430 through which display descriptions 420, 430-435, and 445-450 are made available to the parent, as discussed above in connection with FIGS. 23A-E. It is noted that, in some embodiments a student perspective 415 includes the common schedule display description 433 which display descriptions 420, 430-435, and 445 are made available to the student. By providing a common schedule display description 430, the holistic academic server 110 enhances the usability of the system. For example, students who may be more technically savvy than their parents may teach their parents how to use the holistic academic system from their own perspective (i.e., the student perspective).

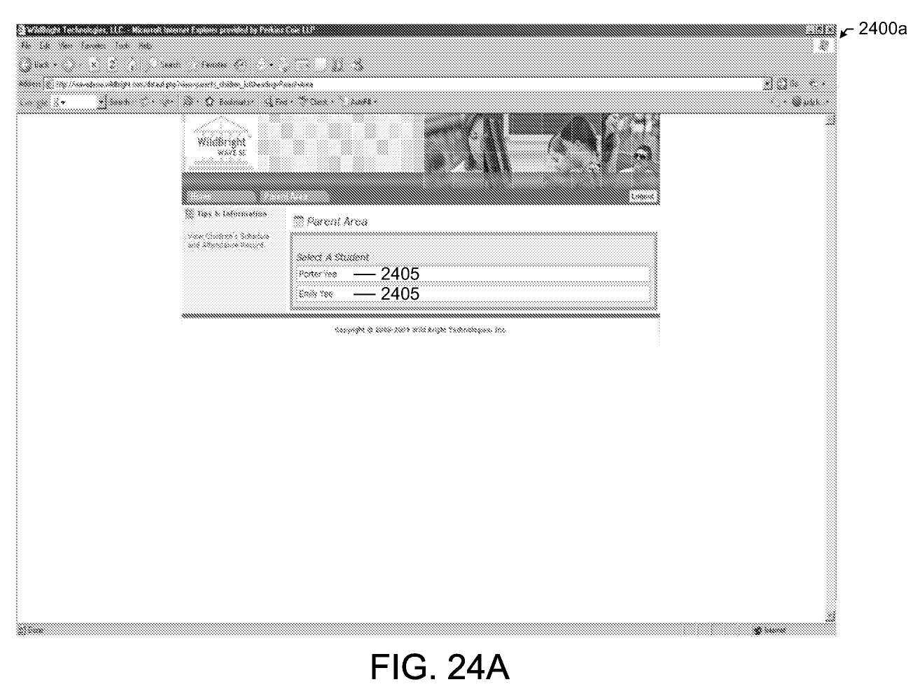

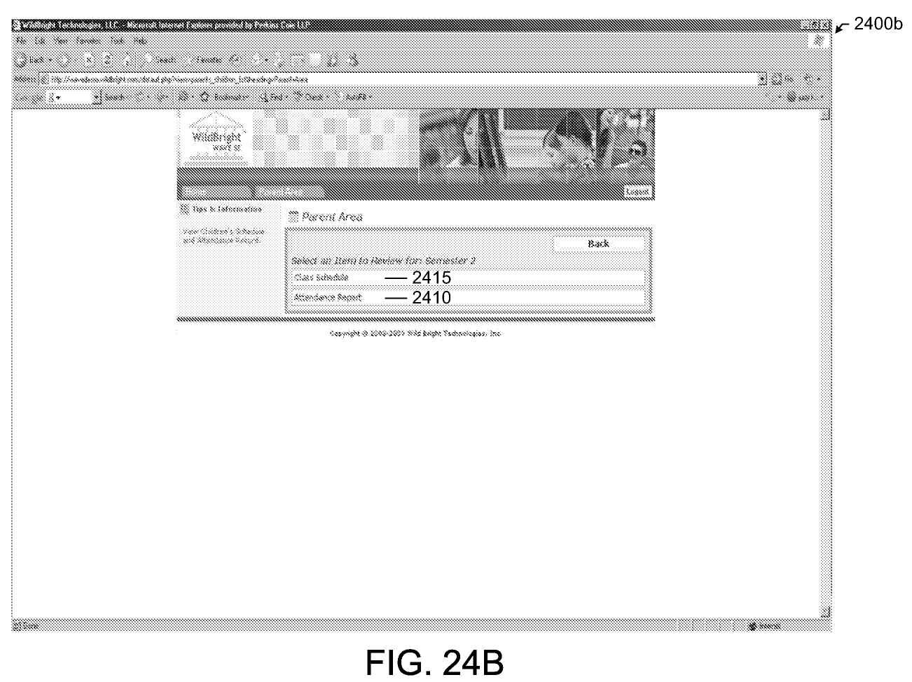

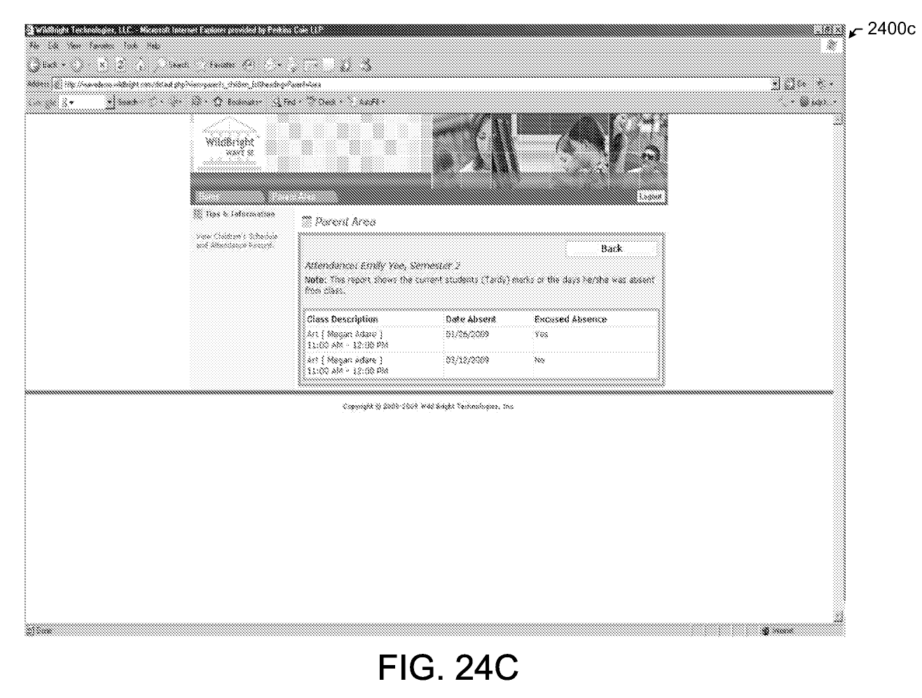

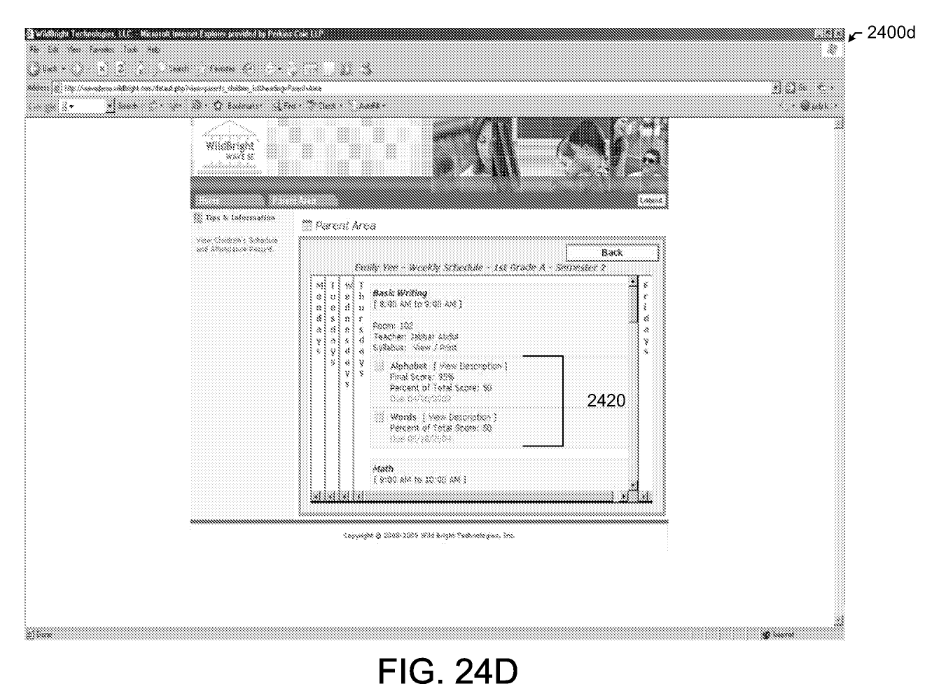

Typically, if a user operating client computer 120 is authenticated as a parent, the holistic academic server 110 sends a default parent display description or a user-specified display description to the client computer 120 for display to the user. FIG. 24A is a screenshot of a display description 2400a that includes a number of controls available to a parent to manage shared data associated with the parent's profile, a child classes, and so on. The display description 2400a includes a control 2405 for each child that is a student of the member school. For example, in the embodiment illustrated in FIG. 24A, the authenticated user (i.e., “Jeff Yee”) is a parent of two students associated with a member school (i.e., “Porter Yee” and “Emily Yee”). The parent perspective 410 simplifies the process of monitoring a child's performance and/or participating in their education, by focusing the parent's viewpoint and attention on a child (or children).

FIG. 24B is a screenshot of a display description 2400b presented in response to the selection of a controlled 2405 corresponding to a child of that parent (e.g., “Emily Yee”), in one or more embodiments. The display description 2400b includes one or more controls to enable a parent to manage shared data associated with the selected child. For example, in the embodiment illustrated in FIG. 24B, the display description 2400b includes an “Attendance Report” control 2410 that enables a parent to view the selected child's attendance for one or more classes. FIG. 24C is a screenshot of a display description 2400c that is presented in response to the selection of the Attendance Report control 2410, in one or more embodiments. In some embodiments, the display description 2400c and the display description 2300d correspond to the same attendance display description 450. The display descriptions 2400c and 2300d are simply viewed from different perspectives. For example, the teacher perspective 405 illustrated in FIG. 23D of display description 2300d, provides a teacher (e.g., “Megan Adare”) with an interface to enter attendance data for multiple students, while the parent perspective 410 illustrated in FIG. 24C, provides a parent (e.g., “Jeff Yee”) with a focused interface to consume attendance data associated with a particular student: a parent's child (e.g., “Emily Yee”).

Returning to FIG. 24B, a display description 2400b includes a “Class Schedule” control 2415 that enables a parent to view the selected child's schedule and monitor their performance. FIG. 24D is a screenshot of a display description 2400d that is presented in response to the selection of the Class Schedule control 2415, in one or more embodiments. In some embodiments, the parent perspective 410 of a child's schedule includes a grade display description 435. For example, in the embodiment illustrated in FIG. 24D includes a grade display description 2420 that identifies one or more grades received by the student for a selected class (e.g., “Basic Writing”). In some embodiments, the display description 2400d may be customized by the parent to present more or less information. For example, in some embodiments, a parent is enabled to modify their view of their child's weekly schedule to include other information, such as a child's cumulative grade for a class, a child standing within their class relative to other students, and so on. By providing a customizable perspective, parents are provided with the opportunity to select their desired level of participation in their child's education.

In some embodiments, one or more of the display descriptions 420-450 are available to users of a member school whose perspectives differ from those of an administrator, teacher, and/or parent. For example, in the embodiment illustrated in FIG. 4, the student perspective 415 includes profile management display descriptions 420, schedule display descriptions 430, grade display descriptions 435, and course management display descriptions 445. Typically, the level of granularity of the student perspective 415 of display descriptions 420, 430-435, and 445 is increased from that of the administrator perspective 400, teacher perspective 405, and/or parent perspective 410 for the same display descriptions. That is, the parent perspective 410 provides a student-focused viewpoint of the shared data associated with the member school.

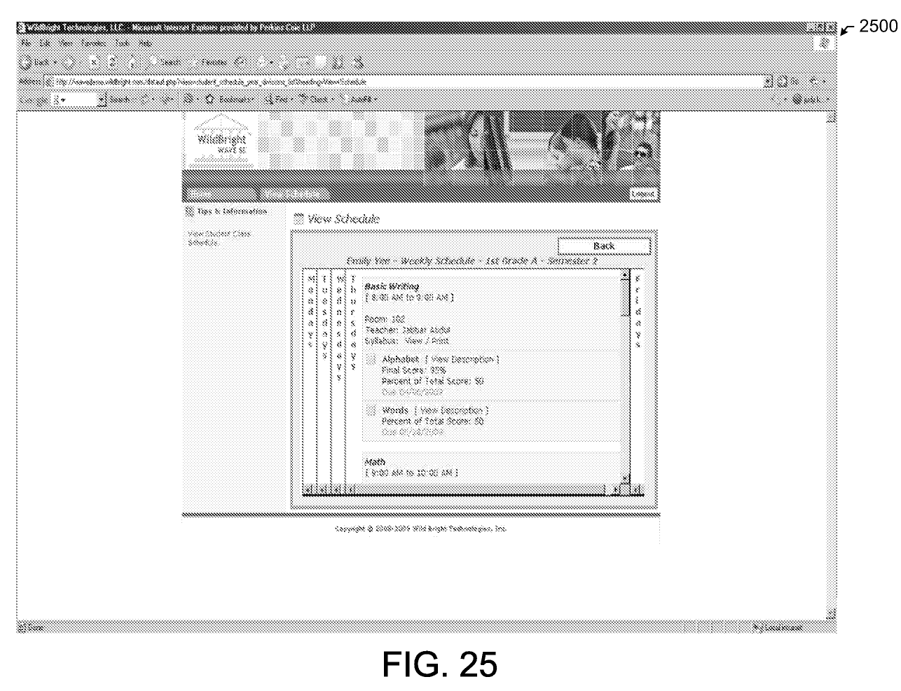

In some embodiments, a student perspective 415 includes a common schedule display description 430 through which display descriptions 420, 430-435, and 445 are made available to the student, as discussed above in connection with FIGS. 23A-E and 24A-D. Typically, if a user operating client computer 120 is authenticated as a student, the holistic academic server 110 sends a default student display description or a user-specified display description to the client computer 120 for display to the user. In some embodiments, the default student display description may vary based on the age of the student. For example, younger students may find the common schedule display description 430 easier to navigate then display descriptions made available to older students. That is, like their parents, they are still learning. For example, FIG. 25 is a screenshot of a display description 2500 that may be presented to a younger student, such as Emily Yee, in one or more embodiments. Much like her father's perspective, the common schedule display description format enables Emily to quickly and efficiently view her classes and assignments.

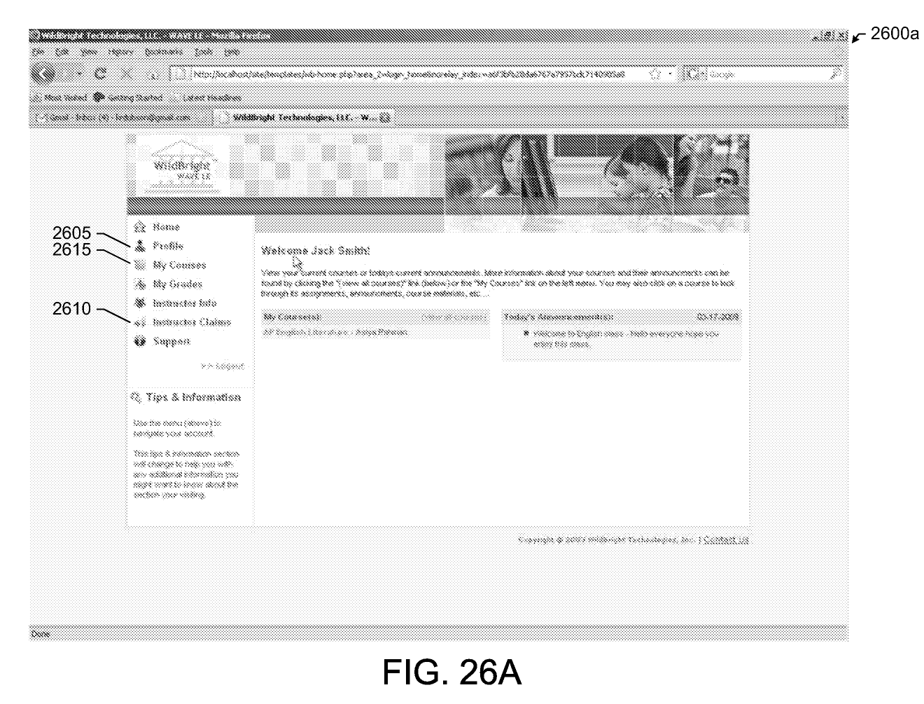

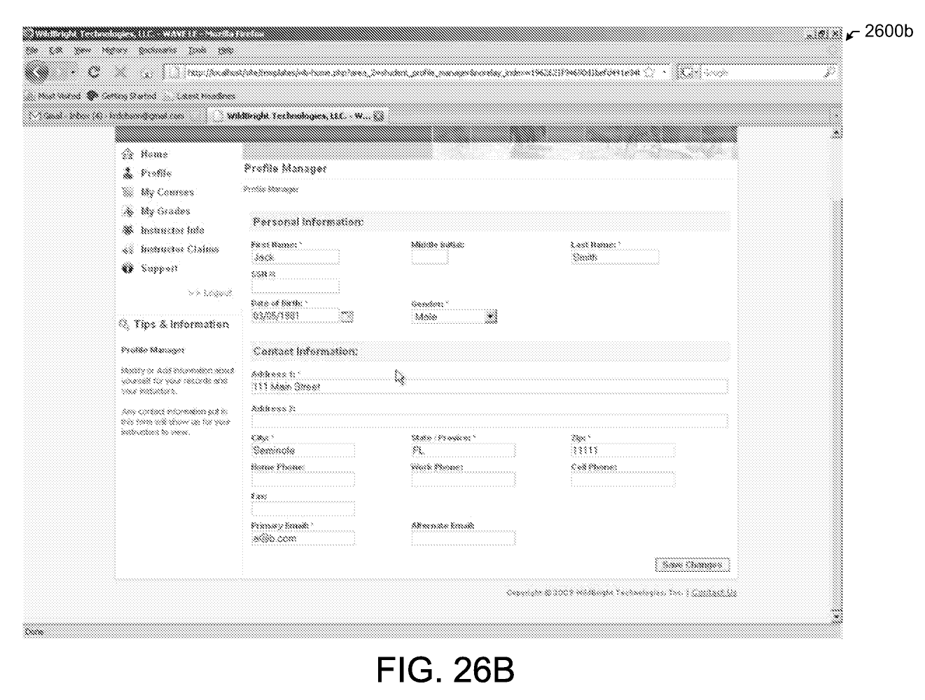

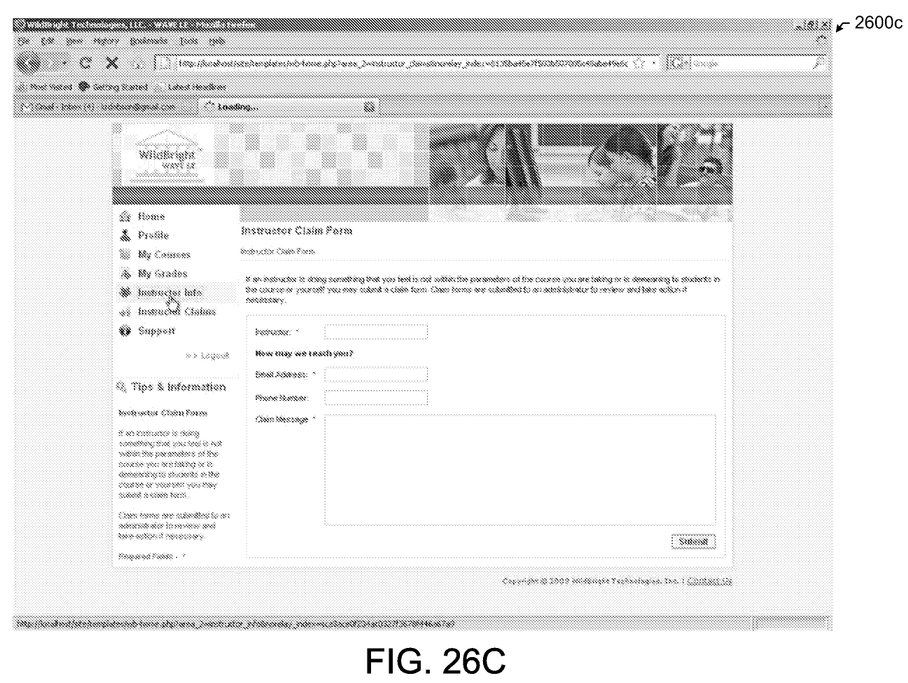

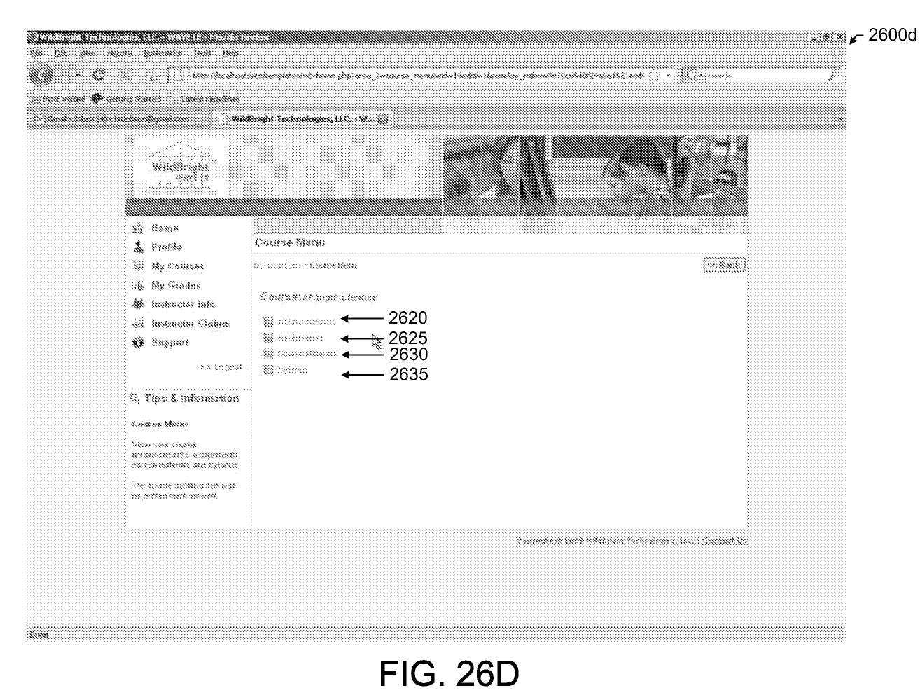

In some embodiments, a student perspective is customizable. For example, a student may add information and/or interfaces to their default or user-specific display description. FIG. 26A is a screenshot of a display description 2600a that includes a number of controls available to a student to manage shared data associated with the student's profile, classes, and so on. For example, the display description 2600a includes a “Profile” control 2605 that enables a student to manage one or more portions of their profile. FIG. 26B is a screenshot of a display description 2600b that is presented in response to the selection of the Profile control 2605, in one or more embodiments. As another example, in the embodiment illustrated in FIG. 26A, a display description 2600a includes a “Instructor Claims” control 2610 that enables a student to anonymously and/or confidentially report misconduct by a teacher. FIG. 26C is a screenshot of a display description 2600c that is presented to a student in response to selection on of the Instructor Claims control 2610, in one or more embodiments. As yet another example, in the embodiment illustrated in FIG. 26A, the display description 2600a includes a “My Courses” control 2615 to manage one or more selected courses of the student.

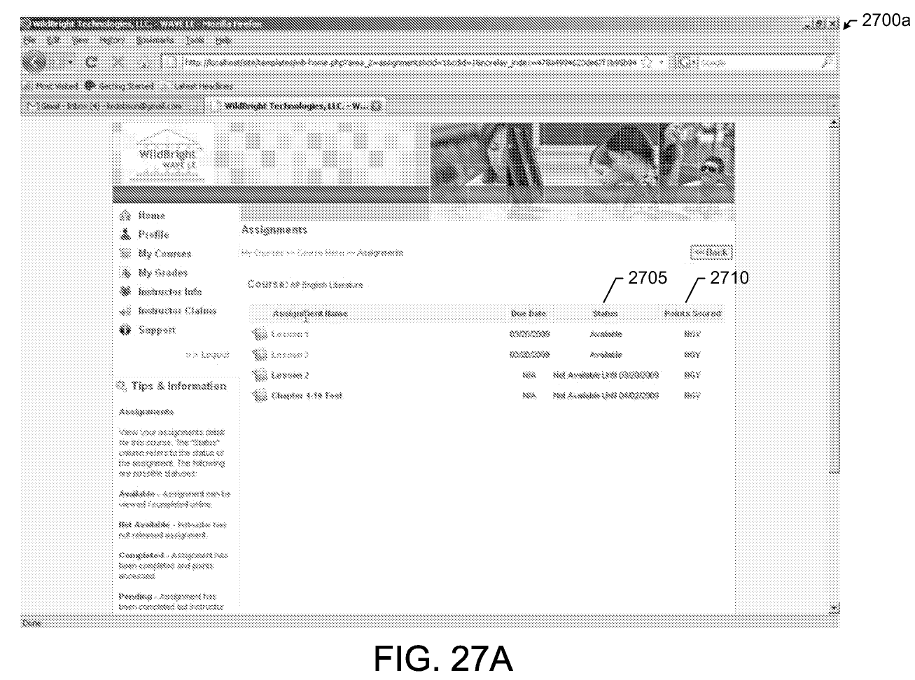

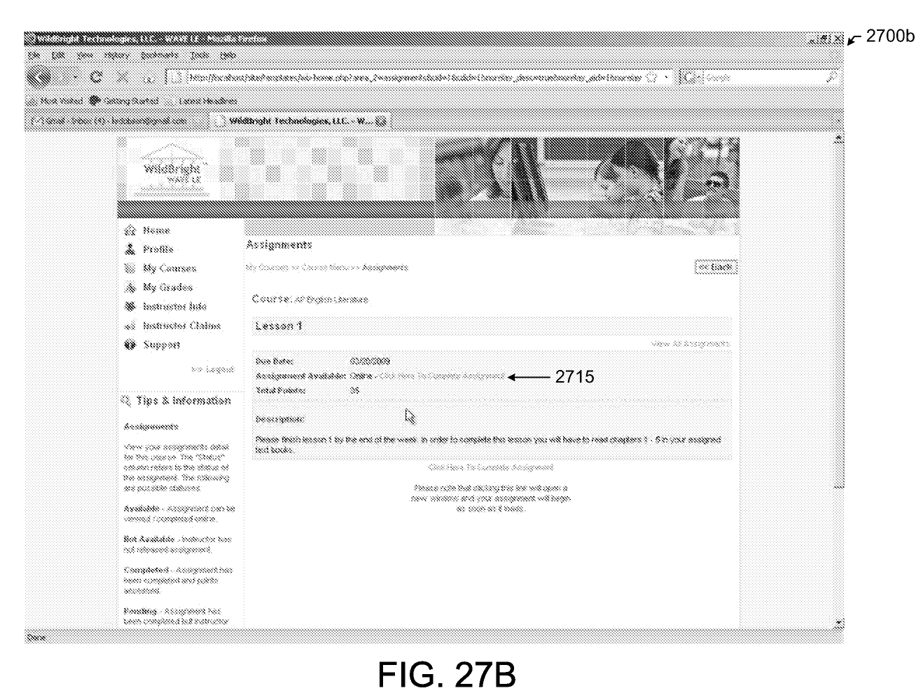

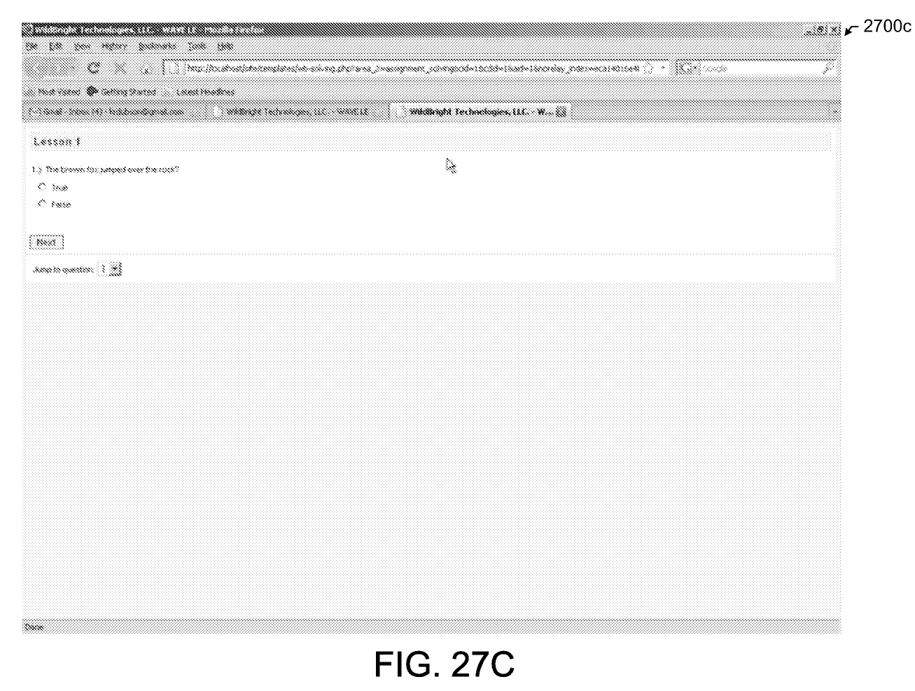

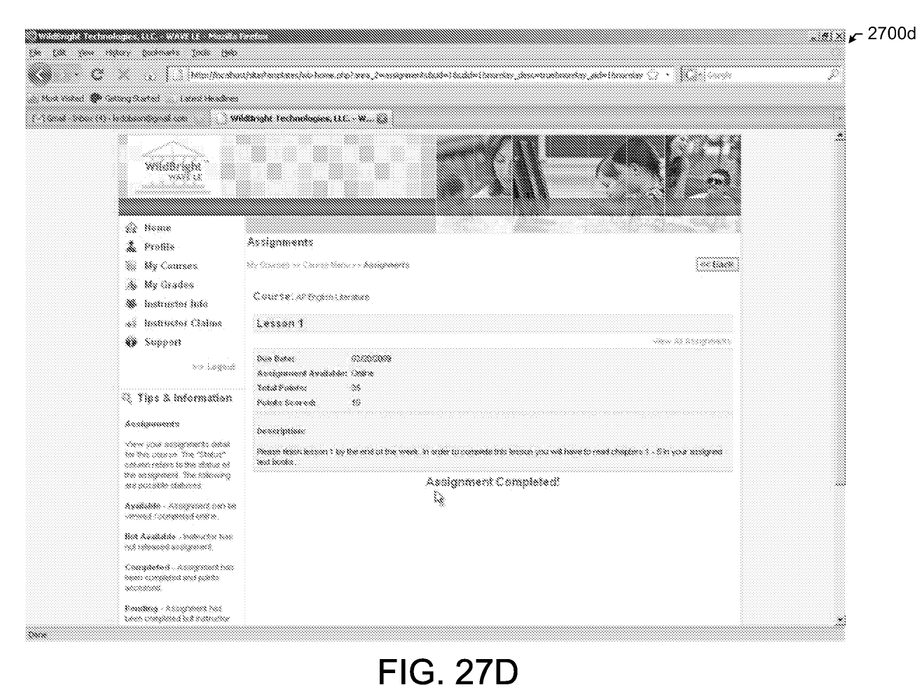

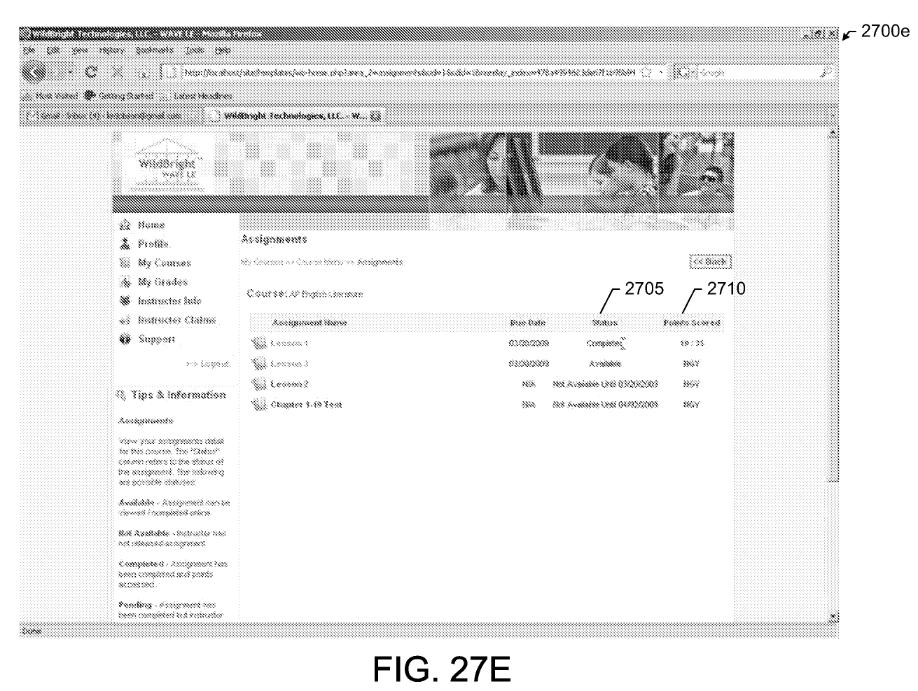

FIG. 26D is a screenshot of a display description 2600d that is presented in response to the selection of the My Courses control 2615. The display description 2600d includes a number of controls that enable a student to manage the selected courses. For example, in the embodiment illustrated in FIG. 26D, the display description 2600d includes an “Announcements” control 2620, an “Assignments” control 2625, a “Course Materials” control 2630, and a “syllabus” control 2635. Typically, each of controls 2620-2635 enables a student to consume and/or interact with information provided by the teacher of the selected course. For example, FIG. 27A is a screenshot of a display description 2700a that is presented to a student in response to the selection of the Assignments control 2625, in one or more embodiments. The display description 2700a includes a number of controls to enable a student to manage the assignments of the selected course. For example, in the embodiment illustrated in FIG. 27A, the display description 2700a includes a “Status” field 2705 that indicates whether an assignment has been posted in a way such that it is currently available to the student. As discussed herein in connection with FIG. 21C, a teacher may build/modify assignments via a display description 2100c, including specifying a “Posted Date” 2165 on which the assignment is made available to students. In the embodiment illustrated in FIG. 27A, the display description 2700a includes a “Points Scored” field 2710 that indicates the number of points achieved by the student for a completed assignment.

FIG. 27B is a screenshot of a display description 2700b that is presented to a student in response to a selection of an assignment from the display description 2700a (e.g., “Lesson 1”), in one or more embodiments. The display description 2700b includes a number of controls and information about the selected assignment. For example, a display description 2700b includes a control 2715 to complete the selected assignment. FIG. 27C is a screenshot of a display description 2700c that is presented in response to the selection of a control 2715, in one or more embodiments. The display description 2700c illustrates a type of online question from the selected assignment. FIG. 27D is a screenshot of a display description 2700d that is presented in response to completion of the selected assignment, in one or more embodiments. In some embodiments, if a student completes an assignment, the Points Scored field 2710 is updated to reflect the students score for the completed assignment. FIG. 27E is a screenshot of a display description 2700e displaying the student's score for the completed assignment.

Returning to FIG. 4, those skilled in the art will appreciate that the organization subscription service 335 may be altered in a variety ways. For example, certain perspectives and/or display descriptions may be merged together or divided; certain perspectives and/or display descriptions may be omitted; certain perspectives and/or display descriptions may be added; and so on. As such, the combinations of perspectives and/or display descriptions illustrated in FIG. 4 should not be taken as restrictive.

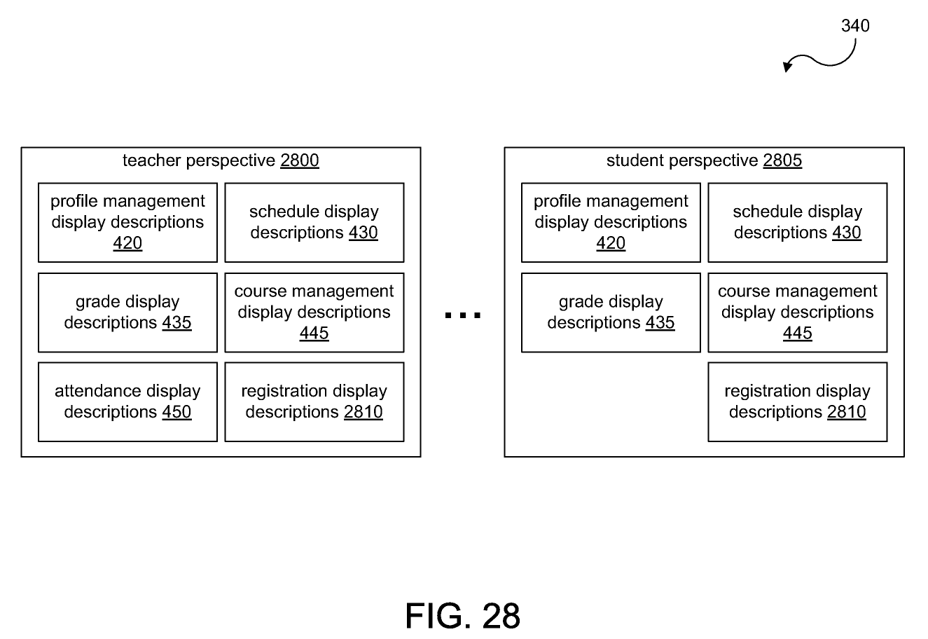

FIG. 28 is a block diagram showing perspectives provided by an independent subscription service 340, in one or more embodiments. In the embodiment illustrated in FIG. 28, the independent subscription service 340 includes a teacher perspective 2800 and a student perspective 2805. Typically, the profile of a user determines the perspective of the user and the display descriptions available to the user, and the determined perspective controls how the display descriptions are viewed by the user (e.g., the level and/or type of information, the layout, the interface is available, etc.).

In the embodiment illustrated in FIG. 28, the teacher perspective 2800 includes a number of display descriptions to enable an independent teacher to manage one or more classes. For example, a teacher perspective 2800 includes profile management display descriptions 420, schedule display descriptions 430, grade display descriptions 435, course management display descriptions 445, attendance display descriptions 450, and registration display descriptions 2810. In the embodiment illustrated in FIG. 28, the student perspective 2805 includes a number of display descriptions to enable an independent student to manage one or more classes for which they have registered. For example, the student perspective 2805 includes profile management display descriptions 420, schedule display descriptions 430, grade display descriptions 435, course management display descriptions 445, and registration display descriptions 2810.

It is noted that the display descriptions 420, 430-435, and 445-450 may be similar to, or different from, those described in connection with FIG. 4. However, in the context of the independent subscription service 340, the display descriptions are typically not associated with a school. The holistic academic system provides those who subscribe to the independent subscription service 340 (e.g., independent teachers, independent students, etc.) with one or more perspectives corresponding to the profile type of the subscriber. In the context of independent subscription service 340, “shared data” refers to one or more portions of information associated with corresponding independently organized classes. The perspective of a subscriber to the independent subscription service 340 refers to the granularity at which a subscriber may view and/or interact with shared data. For example, in the context of a grading sheet, an independent teacher typically can narrow or expand the level of information presented in the grading sheet. That is, the independent teacher has a view of the students grades within the class, whereas an independent student's perspective of the same grading sheet is typically limited to the independent student's personal grades. By providing a service that connects teachers and students independent from the direction or control of a school, the holistic academic environment changes the bounds of how society defines a school. Any person may be both a student and a teacher.

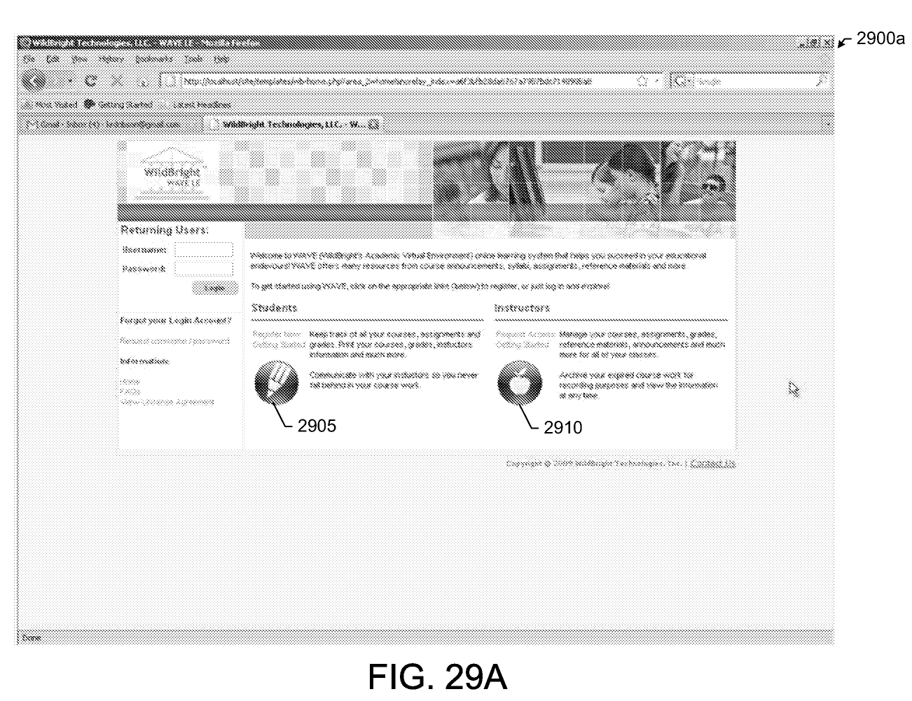

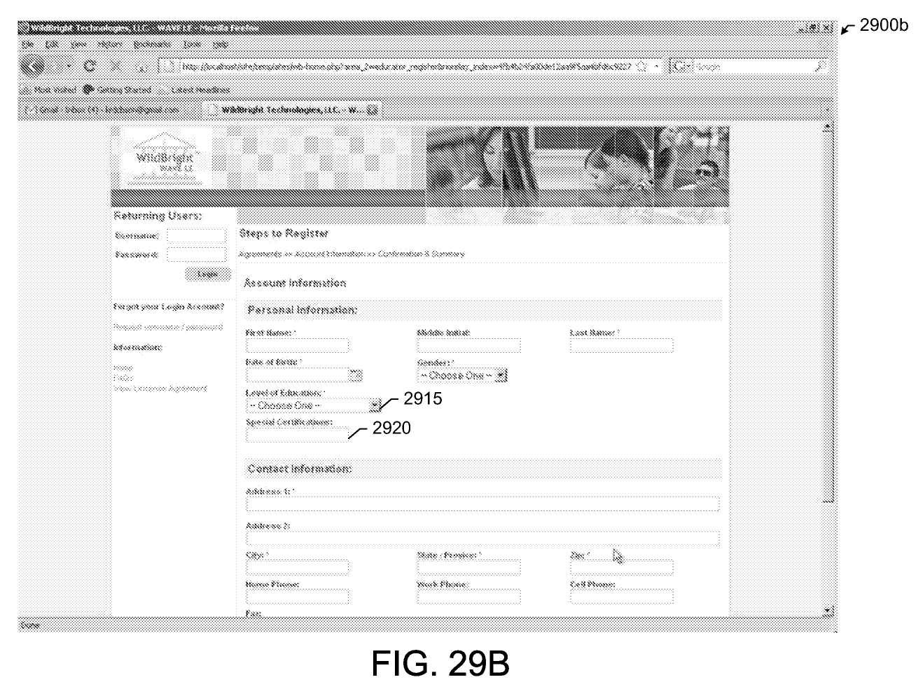

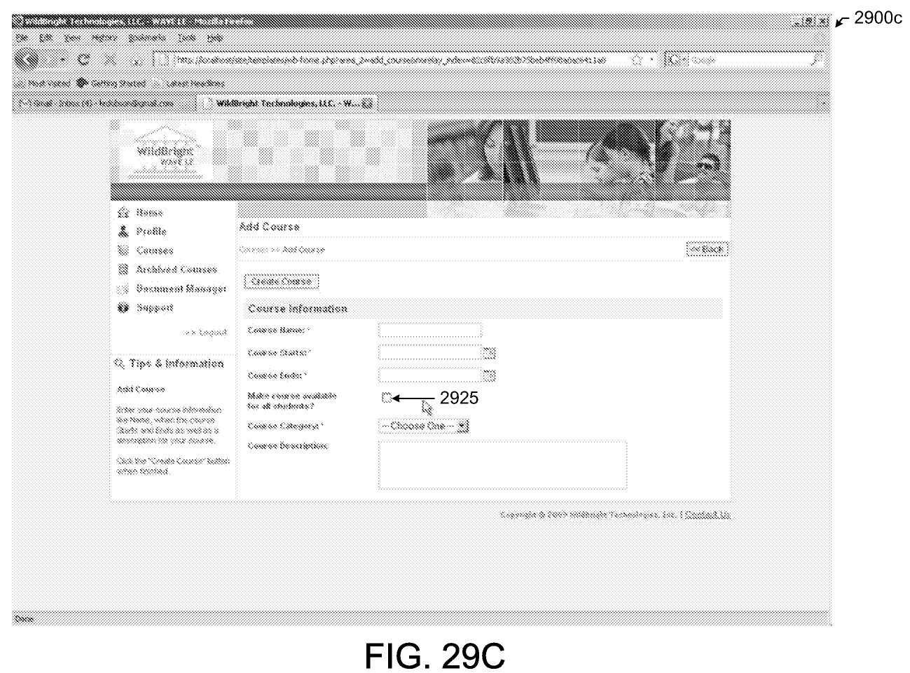

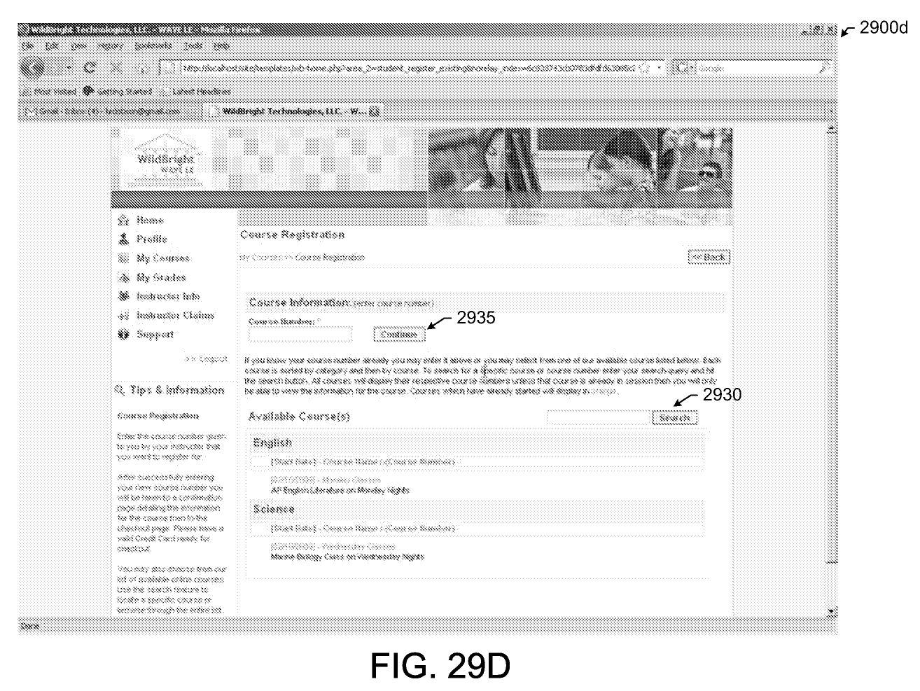

FIG. 29A is a screenshot of a display description 2900a that includes controls that enable users to subscribe to the independent subscription service 340 as independent teachers and/or independent students. For example, in the embodiment illustrated in FIG. 29A, the display description 2900a includes a control 2905 that a user operating a client computer 120 selects to subscribe to the independent subscription service 340 as an independent student. As another example, the display description 2900a includes a control 2910 that a user operating a client computer 120 selects to subscribe to the independent subscription service 340 as an independent teacher. In some embodiments, the registration process and/or display descriptions 2805 presented to a user vary based on whether or not the user subscribes as an independent teacher and/or an independent student. While in other embodiments, the initial registration display descriptions presented to a user are the same regardless of whether the user subscribes as independent teacher, and independent student, and/or another type of user. FIG. 29B is a screenshot of a display description 2900b is presented to a subscribing user in response to the selection of control 2905 or control 2910, in one or more embodiments. In the embodiment illustrated in FIG. 29B, a display description 2900b includes one or more fields for user data. For example, in some embodiments, a user subscribing as an independent teacher supplies one or more portions of information identifying the subscribers credentials and/or qualifications to teach a class by selecting the “Level of Education” control 2915 and/or the “Special Certifications” control 2920. In some embodiments, if a user subscribes as an independent teacher, the holistic academic system verifies that the user is qualified and/or certified to teach a particular class. The holistic academic system may verify the subscriber's qualifications one time, each time the subscriber offers to teach a new class, and/or if a subscriber offers to teach a class outside of the subscriber's verified area of expertise. For example, FIG. 29C is a screenshot of a display description 2900c that is presented in response to a request from an independent teacher to create a new course. In the embodiment illustrated in FIG. 29C, a display description includes a control 2925 that allows an independent teacher to decide whether or not their class will be made publicly available by the independent subscription service. In some embodiments, if an independent teacher creates a course that is not publicly available, the independent subscription service provides the independent teacher with a course number that the independent teacher may provide to independent students. For example, FIG. 29D is a screenshot of a display description 2900d that provides a number of controls to enable independent students to register classes provided by independent teachers through the independent subscription service 340. In some embodiments, if a class is publicly available, an independent student may search for the class using “Search” control 2930. If a class is not publicly available, the class is typically not searchable by selecting the Search control 2930. In some embodiments, if a class is not publicly available an independent student receives a course number from the independent teacher of the class, the independent student may register for the class using the “Course Number” control 2935.

Returning to FIG. 28, those skilled in the art will appreciate that the independent subscription service 340 may be altered in a variety ways. For example, certain perspectives and/or display descriptions may be merged together or divided; certain perspectives and/or display descriptions may be omitted; certain perspectives and/or display descriptions may be added; and so on. As such, the combinations of perspectives 2800-2805 and/or display descriptions should not be taken as restrictive.

Thus, a holistic academic system has been described. The holistic academic system described herein determines the perspective of a user and the display descriptions available to that user to control how the display descriptions are viewed by the user, including the granularity of the information displayed, the layout of the information displayed, and/or the interfaces available to interact with the displayed information, and so on. Although the holistic academic system has been referred to at times herein in the singular, it will be appreciated that many holistic academic systems may be in operation at one time. Each holistic academic system may be directed to a particular school or each holistic academic system may be configured to have a certain number of participating member schools, independent teachers, and/or independent students in each network. Although the invention has been described with reference to specific embodiments, it will be recognized that the invention is not limited to the embodiments described, but can be practiced with modification and alteration within the spirit and scope of the appended claims. For example, in some embodiments, the holistic academic system provides a reporting system for users to log problems, request features, and/or provide feedback. Accordingly, the specification and drawings are to be regarded in an illustrative sense rather than a restrictive sense.

I claim:

1. A system that provides a network-based academic service to which users may subscribe as teachers and students independent of a school, the system comprising:
a processor;
an independent teacher subscription service to which a user may subscribe as an independent teacher, wherein, when a user subscribes as an independent teacher, the user assigned a teacher profile and is enabled to offer a course that is not under the control or direction of a school;
an independent student subscription service to which a user may subscribe as an independent student, wherein, when a user subscribes as an independent student, the user is assigned a student profile and is enabled to register for courses taught by independent teachers that are not under the control or direction of a school;
a memory that stores information associated with a course offered by an independent teacher, including course data, a profile of the independent teacher, and profiles of independent students registered to take the course; and
an interface generation service that attributes a perspective of the stored information to each user is based on the profile of the user and, in response to a request to access the course data, determines the view of, and interaction with, the course data available to the user based on the attributed perspective of the user.

2. The system of claim 1 further comprising a payment service that, in response to a user subscribing as an independent teacher, charges the user a subscription fee.

3. The system of claim 2 wherein the subscription fee is usage-based.

4. The system of claim 3 wherein the usage-based subscription fee is based on the number of courses offered by the user.

5. The system of claim 3 wherein the usage-based subscription fee is based on the number of independent students registered to take a course offered by the user.

6. The system of claim 2 wherein the subscription fee is charged on a periodic basis.

7. The system of claim 1 further comprising a payment service that enables users registered as independent teachers to charge tuition to independent students that register to take a course offered by the independent teacher.

8. The system of claim 7 wherein a portion of the charged tuition is retained by an operator of the system.

9. The system of claim 1 further comprising a payment service that, in response to a user subscribing as an independent student, charges the user a subscription fee.

10. The system of claim 9 wherein the subscription fee is based on the number of course registered for by the user.

11. The system of claim 9 wherein the subjection fee is charged on a periodic basis irrespective of the number of courses registered for by the user.

12. The system of claim 9 wherein the payment service pays users subscribed as independent teachers a portion of the subscription fee charged to users registered as independent students.

13. The system of claim 12 wherein the portion is based on the number independent students registered to take a course offered by the independent teacher.

14. The system of claim 12 wherein the portion is based on the number of courses offered by the independent teacher.

15. The system of claim 1 further comprising a background service that, in response to a request from an independent teacher to teach a course, verifies that the independent teacher is qualified to teach the course.

16. The system of claim 15 wherein the verification is performed each time the independent teacher offers to teach a new course outside a verified area of expertise.

17. The system of claim 1 further comprising a course suggestion service that enables users registered as independent students to request that an unavailable course be offered by the system.

18. The system of claim 17 further comprising an advertising service that, when an unavailable course is requested a threshold number of times, generates an advertisement offering to pay an independent teacher to teach the requested unavailable course.

19. A method in a computer system to provide a network-based academic service to which users may subscribe as teachers and students independent of any educational institution, the method comprising:
providing a first subscription service to which a user may subscribe as an independent teacher, wherein, when a user subscribes as an independent teacher, the user assigned a teacher profile and is enabled to request to teach a course that is not under the control or direction of any educational institution, and wherein the first subscription service verifies that the user is qualified to teach the course prior to enabling the user to offer the course for registration by independent students;
providing a second subscription service to which a user may subscribe as an independent student, wherein, when a user subscribes as an independent student, the user is assigned a student profile and is enabled to register for courses taught by independent teachers that are not under the control or direction of any educational institution;
maintaining course data associated with a plurality of courses offered by independent teachers;
attributing a perspective of the course data to each user based on the profile of the user; and
in response to a request to access the course data, generating a display of the course data available to the user based on the attributed perspective of the user,
wherein code implementing the method is stored in memory of the computer system for execution by a processor of the computer system.

20. A computer-readable storage medium encoded with instructions that, when executed by a processor of a computing system, causes the computing system to provide a network-based academic service to which users may subscribe as teachers and students independent of a school, the computer-readable storage medium comprising:
course data associated with a plurality of courses offered by independent teachers;
instructions to provide an independent teacher subscription service to which a user may subscribe as an independent teacher, wherein, when a user subscribes as an independent teacher, the user assigned a teacher profile and is enabled to offer a course that is not under the control or direction of a school;
instructions to provide an independent student subscription service to which a user may subscribe as an independent student, wherein, when a user subscribes as an independent student, the user is assigned a student profile and is enabled to register for courses taught by independent teachers that are not under the control or direction of a school;
instructions to attribute a perspective of the course data to each user based on the profile of the user; and
instructions to generate a display of course data available to a user in response to a request to access the course data, wherein the perspective of the generated display is based on the attributed perspective of the user.
